(19) United States
(12) Patent Application Publication
(10) Pub. No.: US 2025/0016721 A1
(43) Pub. Date: Jan. 9, 2025

(54) SUPPORT OF COVERAGE GAPS FOR SATELLITE ACCESS

(71) Applicant: QUALCOMM INCORPORATED, San Diego, CA (US)

(72) Inventors: Stephen William Edge, Escondido, CA (US); Amer Catovic, San Diego, CA (US); Haris Zisimopoulos, London (GB)

(21) Appl. No.: 18/711,835

(22) PCT Filed: Dec. 13, 2022
(86) PCT No.: PCT/US2022/081458

§ 371 Date: May 20, 2024

(30) Foreign Application Priority Data
Jan. 5, 2022 (GR) 20220100003

(51) Int. Cl. H04W 64/00; H04B 7/185; H04W 84/04

(52) U.S. Cl. CPC H04W 64/00; H04B 7/1851; H04W 84/042

(57) ABSTRACT

A user equipment (UE) may access a public land mobile network (PLMN) via a communication satellite. The UE may receive satellite coverage data from the serving PLMN via the communication satellite indicating at which locations and/or at which times satellite coverage is available. The UE may determine, based on the satellite coverage data, a first time of satellite unavailability for a location of the UE and a second time of satellite availability. The UE may enter a no coverage state following the first time. The UE may inhibit mobile originating requests and/or reduce a frequency of satellite cell searching while in the no coverage state. The UE may leave the no coverage state at the second time. The satellite coverage data may comprise a coverage map for a grid of locations. Extra coverage data may be provided for satellite availability for other PLMNs and/or for terrestrial cells.

### CROSS REFERENCES

The present application is a 371 national stage filing of International PCT Application No. PCT/US2022/081458 by Edge et al. entitled “SUPPORT OF COVERAGE GAPS FOR SATELLITE ACCESS,” filed Dec. 13, 2022; and claims priority to Greek Patent Application No. 20220100003 by Edge et al. entitled “SUPPORT OF COVERAGE GAPS FOR SATELLITE ACCESS,” filed Jan. 5, 2022, each of which is assigned to the assignee hereof, and each of which is expressly incorporated by reference in its entirety herein.

### FIELD OF TECHNOLOGY

The following relates to wireless communication, including support of coverage gaps for satellite access to a wireless network.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Access to a wireless network may be provided using communication satellites which may support 5G NR, 4G LTE or other types of radio access technology (RAT) radio interfaces to UEs. In such cases, communication satellites may not always be visible to a UE, resulting in a coverage gap (also referred to as “discontinuous satellite coverage”) whenever no communication satellites are visible or whenever visible communication satellites are not able to provide wireless coverage to the UE. A coverage gap may last anywhere from around a few minutes to several hours, during which time a UE may unsuccessfully expend power attempting to find a communication satellite and a wireless network may expend network resources attempting to page the UE. This may be detrimental to UE battery lifetime and detrimental to network resource availability. Means to more efficiently support coverage gaps may therefore be desirable.

### SUMMARY

The described techniques relate to improved methods, systems, devices, and apparatuses that support coverage gaps for satellite access. Generally, the described techniques provide for signaling coverage information to a user equipment (UE) for the satellite-based coverage areas. For example, the UE may access its serving public land mobility network (PLMN) (e.g., core network) via a communication satellite (e.g., one or more satellites providing service coverage for the UE). The UE may receive an indication of satellite coverage data for the satellite coverage area(s). Broadly, the satellite coverage data may indicate the discontinuous service coverage pattern of the UE (e.g., the coverage area(s) of the satellite(s) with respect to the UE). The UE may identify or otherwise determine a first time (T1) of satellite unavailability (e.g., a time period when the UE is not able to communicate with the serving PLMN wirelessly via the satellite) and a second time (T2) of satellite available (e.g., a time period when the UE is able to communicate with the serving PLMN wirelessly via the satellite). The UE may identify, calculate, or otherwise determine T1/T2 based on the satellite coverage data, the location of the UE, etc., in some examples. Accordingly, the UE may transition to, or otherwise enter, a no coverage state following the first time (e.g., T1, the time period when the UE is not able to communicate with the serving PLMN wirelessly via the satellite). The no coverage state may include, but is not limited to, the UE inhibiting mobile originating (MO) request(s), reducing the frequency of satellite cell searching (e.g., how often the UE performs a cell search for the satellite) from a first frequency (e.g., while in the coverage state) to a second frequency (e.g., while in the no coverage state), and the like. The UE may transition from, or otherwise leave, the no coverage state at the second time (e.g., T2, the time period when the UE is able to communicate with the serving PLMN wirelessly via the satellite). Aspects of these techniques may be performed at the access stratum (AS) layer of the UE and/or at the non-access stratum (NAS) layer of the UE.

Certain aspects relate to a method for supporting satellite wireless access by a user equipment (UE) to a serving public land mobile network (PLMN) with discontinuous satellite coverage. In some examples, the method includes: accessing the serving PLMN via a communication satellite; receiving or otherwise obtaining satellite coverage data from an entity in the serving PLMN via the communication satellite; determining, based at least in part on the satellite coverage data, a first time of satellite unavailability for a location of the UE and a second time of satellite availability for the location of the UE; entering a no coverage state following the first time; inhibiting one or more mobile originating requests in the UE while in the no coverage state; reducing a frequency of satellite cell searching from a first frequency in a coverage state to a second frequency while in the no coverage state; and leaving the no coverage state at the second time.

Certain aspects relate to an apparatus for supporting satellite wireless access by a user equipment (UE) to a serving public land mobile network (PLMN) with discontinuous satellite coverage. In some examples, the apparatus includes a memory comprising instructions; and one or more processors configured to execute the instructions to cause the apparatus to: obtain signaling to access the serving PLMN via a communication satellite; obtain satellite coverage data from an entity in the serving PLMN via the communication satellite; determine, based at least in part on the satellite coverage data, a first time of satellite unavailability for a location of the UE and a second time of satellite availability for the location of the UE; enter a no coverage state at or after the first time and at least one of inhibit one or more mobile originating requests in the UE while in the no coverage state or reduce a frequency of satellite cell searching from a first frequency in a coverage state to a second frequency while in the no coverage state; and leave the no coverage state at or after the second time.

Certain aspects relate to a user equipment (UE). In some examples, the UE includes a transceiver; a memory comprising instructions; and one or more processors configured to execute the instructions to cause the apparatus to: obtain signaling to access the serving PLMN via a communication satellite; obtain satellite coverage data from an entity in the serving PLMN via the communication satellite; determine, based at least in part on the satellite coverage data, a first time of satellite unavailability for a location of the UE and a second time of satellite availability for the location of the UE; enter a no coverage state at or after the first time and at least one of inhibit one or more mobile originating requests in the UE while in the no coverage state or reduce a frequency of satellite cell searching from a first frequency in a coverage state to a second frequency while in the no coverage state; and leave the no coverage state at or after the second time.

Certain aspects relate to an apparatus for wireless communications. In some examples, the apparatus includes means for accessing the serving PLMN via a communication satellite; receiving or otherwise obtaining satellite coverage data from an entity in the serving PLMN via the communication satellite; means for determining, based at least in part on the satellite coverage data, a first time of satellite unavailability for a location of the UE and a second time of satellite availability for the location of the UE; means for entering a no coverage state at or after the first time and at least one of means for inhibiting one or more mobile originating requests in the UE while in the no coverage state or means for reducing a frequency of satellite cell searching from a first frequency in a coverage state to a second frequency while in the no coverage state; and means for leaving the no coverage state at or after the second time.

Certain aspects relate to a non-transitory computer-readable medium having instructions stored thereon that, when executed by an apparatus, cause the apparatus to perform operations. In some examples, the operations include accessing the serving PLMN via a communication satellite; receiving or otherwise obtaining satellite coverage data from an entity in the serving PLMN via the communication satellite; determining, based at least in part on the satellite coverage data, a first time of satellite unavailability for a location of the UE and a second time of satellite availability for the location of the UE; entering a no coverage state at or after the first time and at least one of inhibiting one or more mobile originating requests in the UE while in the no coverage state or reducing a frequency of satellite cell searching from a first frequency in a coverage state to a second frequency while in the no coverage state; and leaving the no coverage state at or after the second time.

Certain aspects relate to a method performed at an entity in a serving public land mobile network (PLMN) for supporting satellite wireless access by a user equipment (UE) to the serving PLMN with discontinuous satellite coverage. In some examples, the method includes: obtaining satellite coverage data for the UE; and sending the satellite coverage data to the UE via a communication satellite, wherein the satellite coverage data enables a determination of a first time of satellite cell unavailability for a location of the UE and a second time of satellite cell availability for the location of the UE, wherein the UE is not reachable by the serving PLMN following the first time and prior to the second time, wherein the satellite coverage data is configured to enable the UE to reduce power consumption between the first and the second time.

Certain aspects relate to an apparatus for supporting satellite wireless access by a user equipment (UE) to a serving public land mobile network (PLMN) with discontinuous satellite coverage. In some examples, the apparatus includes a memory comprising instructions; and one or more processors configured to execute the instructions to cause the apparatus to: obtain satellite coverage data for the UE; and output the satellite coverage data for transmission to the UE via a communication satellite, wherein the satellite coverage data enables a determination of a first time of satellite cell unavailability for a location of the UE and a second time of satellite cell availability for the location of the UE, wherein the UE is not reachable by the serving PLMN at or after the first time and prior to the second time, wherein the satellite coverage data is configured to enable the UE to reduce power consumption between the first time and the second time.

Certain aspects relate to a network entity in a serving public land mobile network (PLMN). In some examples, the network entity includes at least one transceiver; a memory comprising instructions; and one or more processors configured to execute the instructions to cause the apparatus to: obtain satellite coverage data for the UE; and output the satellite coverage data for transmission to the UE via a communication satellite, wherein the satellite coverage data enables a determination of a first time of satellite cell unavailability for a location of the UE and a second time of satellite cell availability for the location of the UE, wherein the UE is not reachable by the serving PLMN at or after the first time and prior to the second time, wherein the satellite coverage data is configured to enable the UE to reduce power consumption between the first time and the second time.

Certain aspects relate to an apparatus for wireless communications. In some examples, the apparatus includes: means for obtaining satellite coverage data for the UE; and means for sending the satellite coverage data to the UE via a communication satellite, wherein the satellite coverage data enables a determination of a first time of satellite cell unavailability for a location of the UE and a second time of satellite cell availability for the location of the UE, wherein the UE is not reachable by the serving PLMN at or after the first time and prior to the second time, wherein the satellite coverage data is configured to enable the UE to reduce power consumption between the first time and the second time.

Certain aspects relate to a non-transitory computer-readable medium having instructions stored thereon that, when executed by an apparatus, cause the apparatus to perform operations. In some examples, the operations include obtaining satellite coverage data for the UE; and sending the satellite coverage data to the UE via a communication satellite, wherein the satellite coverage data enables a determination of a first time of satellite cell unavailability for a location of the UE and a second time of satellite cell availability for the location of the UE, wherein the UE is not reachable by the serving PLMN at or after the first time and prior to the second time, wherein the satellite coverage data is configured to enable the UE to reduce power consumption between the first time and the second time.

### BRIEF DESCRIPTION OF THE DRAWINGS

FIG. 1 illustrates an example of a diagram of a communication system with a network architecture having transparent space vehicles (SVs) that is capable of supporting satellite access to a wireless network.

FIG. 2 illustrates an example of a diagram of a communication system with a network architecture having regenerative SVs that is capable of supporting satellite access to a wireless network.

FIG. 3 illustrates an example of a diagram of a communication system with a network architecture having regenerative SVs and a split satellite Node B (gNB) architecture that is capable of supporting satellite access to a wireless network.

FIG. 4 illustrates an example of an SV generating multiple beams over an area that includes multiple countries.

FIG. 5 illustrates an example of satellite cells produced by an SV over an area that includes a number of fixed cells.

FIG. 6 illustrates an example of an assignment of satellite cells produced by an SV to fixed tracking areas (TAs).

FIG. 7A illustrates an example of UEs that are in or out of coverage of an SV at different times and at different locations.

FIG. 7B illustrates a coverage map and coverage bit map for a UE.

FIG. 8 illustrates an example of a process that supports coverage gaps for satellite access in accordance with aspects of the present disclosure.

FIG. 9 illustrates an example of a process that supports coverage gaps for satellite access in accordance with aspects of the present disclosure.

FIG. 10 illustrates an example of a process that supports coverage gaps for satellite access in accordance with aspects of the present disclosure.

FIGS. 11 and 12 show block diagrams of devices that support coverage gaps for satellite access in accordance with aspects of the present disclosure.

FIG. 13 shows a block diagram of a communications manager that supports coverage gaps for satellite access in accordance with aspects of the present disclosure.

FIG. 14 shows a diagram of a system including a device that supports coverage gaps for satellite access in accordance with aspects of the present disclosure.

FIGS. 15 and 16 show block diagrams of devices that support coverage gaps for satellite access in accordance with aspects of the present disclosure.

FIG. 17 shows a block diagram of a communications manager that supports coverage gaps for satellite access in accordance with aspects of the present disclosure.

FIG. 18 shows a diagram of a system including a device that supports coverage gaps for satellite access in accordance with aspects of the present disclosure.

FIGS. 19 and 20 show flowcharts illustrating methods that support coverage gaps for satellite access in accordance with aspects of the present disclosure.

Like reference symbols in the various drawings indicate like elements, in accordance with certain example implementations. In addition, multiple instances of an element may be indicated by following a first number for the element with a letter or a hyphen and a second number. For example, multiple instances of an element 102 may be indicated as 102-1, 102-2, 102-3 etc. When referring to such an element using only the first number, any instance of the element is to be understood (e.g. element 102 in the previous example would refer to elements 102-1, 102-2, 102-3).

### DETAILED DESCRIPTION

Wireless communications may be performed between a user equipment (UE) and satellite(s) in some deployment scenarios. For example, satellite(s) may be deployed such that the UE is within a coverage area of a satellite to support such communications. However, during initial deployment and/or in some coverage areas, the UE may be located outside of a satellite coverage area, which may disrupt such satellite-based communications. For example, due to orbital motion of satellites, a UE may traverse coverage area(s) and non-coverage area(s) of the satellite(s), which may impact various operations of the UE, such as cell search, mobile originating services, power-saving modes, and the like. Accordingly, improvements in support for coverage area(s) and non-coverage area(s) of the satellite(s) by a UE may be desirable to improve UE operation with satellite-based communications. Similarly, a wireless communication network may benefit from improved support for coverage area(s) and non-coverage area(s) of the satellite(s) which may enable more efficient use of network resources and better communication service to UEs.

Satellites, also referred to as space vehicles (SVs) or communication satellites, may be used in communication systems, for example, using gateways and one or more satellites to relay communication signals between the gateways and one or more UEs. A UE, for example, may access a satellite (instead of a terrestrial base station) which may be connected to an earth station (ES), which is also referred to as a ground station or Non-Terrestrial Network (NTN) Gateway. The earth station in turn would connect to an element in a 5G Network such as a modified base station (without a terrestrial antenna) or a network node in a 5G Core Network (5GCN). This element would in turn provide access to other elements in the 5G Network and ultimately to entities external to the 5G Network such as Internet web servers and other user devices.

A rationale for 5G (or other cellular network) satellite access for UEs may include ubiquitous outdoor coverage for both users and Mobile Network Operators (MNOs). For example, in many countries, including the United States, unavailable or poor cellular coverage is a common problem. Moreover, cellular access is not always possible even when there is normally good cellular coverage. For example, cellular access may be hampered due to congestion, physical obstacles, a local cellular outage caused by weather (e.g., a hurricane or tornado), or a local power outage. Satellite access to cellular networks could provide a new independent access potentially available everywhere outdoors. Current satellite capable phones for low Earth orbit (LEO) SVs may be of similar size to a cellular smartphone and, thus, mobile NR support with satellite capable phones need not produce a significant increase in the size of phones. Moreover, satellite capable smartphones may help drive handset sales, and may add revenue for carriers. Potential users, for example, may include anyone with limited or no cellular access, anyone wanting a backup to a lack of cellular access, and anyone involved in public safety or who otherwise needs (nearly) 100% reliable mobile communication. Additionally, some users may desire an improved or more reliable E911 service, e.g., for a medical emergency or vehicle trouble in remote areas. Additional user cases can include providing wireless communication access to UEs located outdoors and associated with automated or Internet of Things (IOT) devices such as a UEs enabling communication with and possibly control of unmanned Aerial Vehicles (UAVs), driverless vehicles, automated machinery used in farming, forestry or mining, smart meters, and monitoring devices (e.g., for monitoring of weather, traffic, crowds, hazardous conditions).

The use of 5G satellite access may provide other benefits. For example, 5G satellite access may reduce Mobile Network Operator (MNO) infrastructure cost. For example, an MNO may use satellite access to reduce the number of terrestrial base stations that need to be deployed, such as NR NodeBs, also referred to as gNBs, and backhaul deployment in sparsely populated areas. Further, 5G satellite access may be used to overcome internet blockage, e.g., in certain countries. Additionally, 5G satellite access may provide diversification to Space Vehicle Operators (SVOs). For example, 5G NR satellite access could provide another revenue stream to SVOs who might otherwise only provide fixed Internet access.

As a point of terminology, wireless cells supported by satellites (or SVs) are referred to herein as “satellite cells”, as “radio cells”, as “NTN cells” or simply as “cells” when there is prior context information that a “cell” is a “satellite cell”. Satellite cells would be distinct from wireless cells supported by terrestrial base stations and access points which are referred to herein as terrestrial cells or terrestrial network (TN) cells.

It is noted that the terms space vehicle (SV), communication satellite and satellite can be synonymous and are accordingly used here interchangeably. In some cases, an SV (or satellite) can be a navigation SV (or satellite) such as an SV for GPS, Galileo, GLONASS or Beidou. An SV which functions as a navigation SV but possibly not as a communication SV is labelled and referred to explicitly herein to avoid confusion with a communication SV that may not support navigation.

Generally, the techniques described herein provide for sending (e.g. signaling) coverage information to a UE for satellite-based coverage areas, which are also referred to herein as satellite coverage areas and as NTN coverage areas. For example, the UE may access its serving public land mobility network (PLMN) (e.g., core network) via a communication satellite (e.g., one or more satellites providing service coverage, also referred to as NTN coverage and satellite coverage, for the UE). The UE may receive an indication of satellite coverage data for the satellite coverage area(s). Broadly, the satellite coverage data may indicate a discontinuous service coverage pattern of the UE (e.g., may indicate coverage area(s) of the satellite(s) with respect to the UE). The UE may identify or otherwise determine a first time (T1) of satellite unavailability (e.g., a time when the UE is initially not able to communicate with the serving PLMN wirelessly via a satellite) and a second time (T2) of satellite availability (e.g., a time when the UE is able to resume communication with the serving PLMN wirelessly via a satellite). The UE may identify, calculate, or otherwise determine T1/T2 based on the satellite coverage data, the location of the UE, etc., in some examples. Accordingly, the UE may transition to, or otherwise enter, a no coverage state following the first time (e.g., T1, the time when the UE is initially not able to communicate with the serving PLMN wirelessly via a satellite). The no coverage state may include, but is not limited to, the UE inhibiting mobile originating (MO) request(s), reducing a frequency of satellite cell searching (e.g., how often the UE performs a cell search for a satellite) from a first frequency (e.g., while in the coverage state) to a second frequency (e.g., while in the no coverage state), and the like. The UE may transition from, or otherwise leave, the no coverage state at the second time (e.g., T2, the time when the UE is able to resume communication with the serving PLMN wirelessly via a satellite). Aspects of these techniques may be performed at an access stratum (AS) layer of the UE and/or at an non-access stratum (NAS) layer of the UE.

Aspects of the disclosure are initially described in the context of communications systems, including wireless communications systems. Aspects of the disclosure are further illustrated by and described with reference to apparatus diagrams, system diagrams, and flowcharts that relate to support of coverage gaps for satellite access.

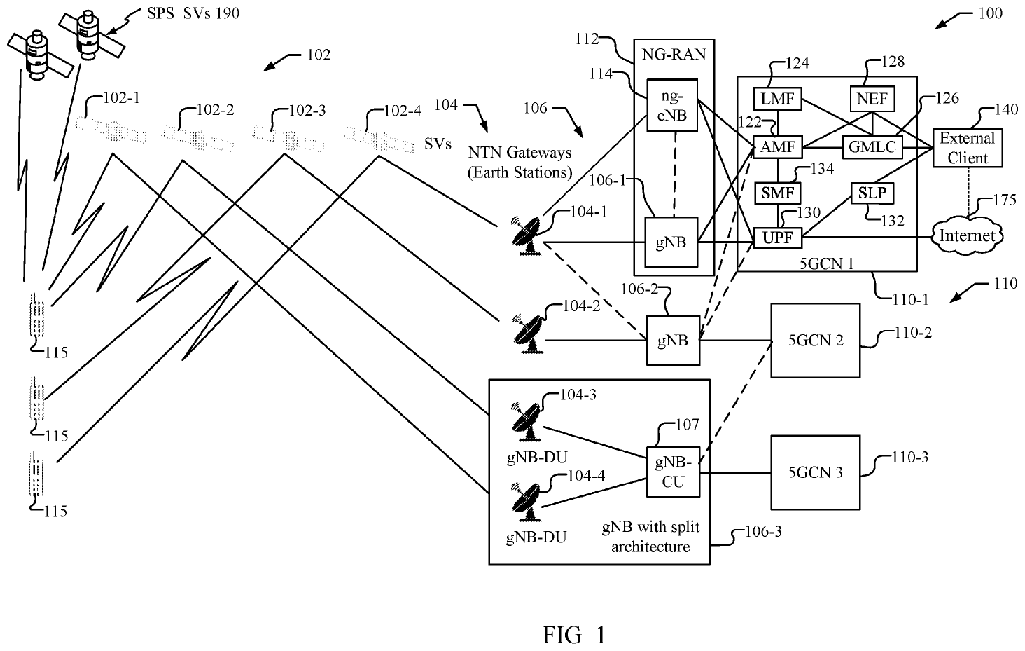

FIG. 1 illustrates an example of a communication system 100 that may be capable of supporting satellite access using 5G NR or some other wireless access type such as CDMA, according to some examples. FIG. 1 illustrates a network architecture with transparent SVs. A transparent SV may implement frequency conversion and a radio frequency (RF) amplifier in both uplink (UL) and downlink (DL) directions and may correspond to an analog RF repeater. A transparent SV, for example, may receive UL signals from all served UEs and may redirect the combined signals DL to an earth station without demodulating or decoding the signals. Similarly, a transparent SV may receive an UL signal from an earth station and redirect the signal DL to served UEs without demodulating or decoding the signal. However, the SV may frequency convert received signals and may amplify and/or filter received signals before transmitting the signals.

The communication system 100 comprises a number of UEs 115, a number of SVs 102 (e.g., SV 102-1, 102-2, 102-3, and 102-4), a number of Non-Terrestrial Network (NTN) gateways 104-1 to 104-4 (collectively referred to herein as NTN gateways 104) (and sometimes referred to herein simply as gateways 104, earth stations 104, or ground stations 104), a number of satellite NodeBs (gNBs) 106-1 to 106-3 (collectively referred to herein as gNBs 106) capable of communication with UEs 115 via SVs 102 and that are part of a Next Generation (NG) Radio Access Network (RAN) (NG-RAN) 112.

It is noted that the term “gNB” (or “gNodeB”) traditionally refers to an NR NodeB base station used for terrestrial access with an NR radio interface. The same term (gNB) may also be used to refer to a base station supporting satellite access with an NR radio interface. The two variants of gNB (satellite and terrestrial) may support many of the same functions, protocols and interfaces, but are also distinct in other ways. To distinguish gNBs supporting terrestrial access from gNBs supporting satellite access, different labels are used herein. A gNB could also support both terrestrial and satellite NR access, though, for simplification, this is not further discussed here.

The communication system 100 is illustrated as further including components of a number of Fifth Generation (5G) networks including 5G Core Networks (5GCNs) 110-1 to 110-3 (collectively referred to herein as 5GCNs 110). The 5GCNs 110 may be public land mobile networks (PLMN) that may be located in the same or in different countries. FIG. 1 illustrates various components within 5GCN1 110-1 that may operate with the NG-RAN 112. It should be understood that 5GCN2 110-2 and 5GCN3 110-3 may include identical, similar or different components and associated NG-RANs, which are not illustrated in FIG. 1 in order to avoid unnecessary obfuscation. A 5G network may also be referred to as a NR network; NG-RAN 112 may be referred to as a 5G RAN or as an NR RAN; and 5GCN 110 may be referred to as an NG Core network (NGC). The communication system 100 may further utilize information from navigation space vehicles (SVs) 190 for a Satellite Positioning System (SPS) including Global Navigation Satellite Systems (GNSS) like Global Positioning System (GPS), GLObal NAvigation Satellite System (GLONASS), Galileo or Beidou or some other local or regional SPS, such as Indian Regional Navigation Satellite System (IRNSS), European Geostationary Navigation Overlay Service (EGNOS), or Wide Area Augmentation System (WAAS), all of which are sometimes referred to herein as GNSS. It is noted that SVs 190 act as navigation SVs and are separate and distinct from SVs 102, which act as communication SVs. However, it is not precluded that some of SVs 190 may also act as some of SVs 102 and/or that some of SVs 102 may also act as some of SVs 190. In some implementations, for example, the SVs 102 may be used for both communication and positioning. Additional components of the communication system 100 are described below. The communication system 100 may include additional or alternative components.

Permitted connections in the communication system 100 having the network architecture with transparent SVs illustrated in FIG. 1, allow a gNB 106 to access multiple Earth stations 104 and/or multiple SVs 102. A gNB 106, e.g., illustrated by gNB 106-2, may also be shared by multiple PLMNs (5GCNs 110), which may all be in the same country or possibly in different countries, and an NTN Gateway 104, e.g., illustrated by NTN Gateway 104-1, may be shared by more than one gNB 106.

It should be noted that FIG. 1 provides only a generalized illustration of various components, any or all of which may be utilized as appropriate, and each of which may be duplicated or omitted, as necessary. Specifically, although only three UEs 115 are illustrated, it will be understood that many UEs (e.g., hundreds, thousands, millions, etc.) may utilize the communication system 100. Similarly, the communication system 100 may include a larger (or smaller) number of SVs 190, SVs 102, earth stations 104, gNBs 106, NG-RAN 112, ng-eNBs 114, 5GCNs 110, external clients 140, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, 4G LTE, etc.

The UE 115 may comprise and/or be referred to as a device, a mobile device, a wireless device, a mobile terminal, a terminal, a mobile station (MS), a Secure User Plane Location (SUPL) Enabled Terminal (SET), or by some other name. Moreover, UE 115 may correspond to a cellphone, smartphone, laptop, tablet, PDA, tracking device, navigation device, Internet of Things (IOT) device, or some other portable or moveable device. Typically, though not necessarily, the UE 115 may support wireless communication using one or more Radio Access Technologies (RATs) such as using GSM, CDMA, Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G New Radio (NR) (e.g., using the NG-RAN 112 and 5GCN 110), etc. The UE 115 may also support wireless communication using a Wireless Local Area Network (WLAN) which may connect to other networks (e.g., the Internet) using a Digital Subscriber Line (DSL) or packet cable for example. The UE 115 further supports wireless communications using space vehicles, such as SVs 102. The use of one or more of these RATs may allow the UE 115 to communicate with an external client 140 (e.g. via a User Plane Function (UPF) 130 or possibly via a Gateway Mobile Location Center (GMLC) 126).

The UE 115 may include a single entity or may include multiple entities such as in a personal area network where a user may employ audio, video and/or data I/O devices and/or body sensors and a separate wireline or wireless modem.

The UE 115 may support position determination, e.g., using signals and information from space vehicles 190 in an SPS, such as GPS, GLONASS, Galileo or Beidou or some other local or regional SPS such as IRNSS, EGNOS or WAAS, all of which may be generally referred to herein as GNSS. Position measurements using SPS are based on measurements of propagation delay times of SPS signals broadcast from a number of orbiting satellites to a SPS receiver in the UE 115. Once the SPS receiver has measured the signal propagation delays for each satellite, the range to each satellite can be determined and precise navigation information including 3-dimensional position, velocity and time of day of the SPS receiver can then be determined using the measured ranges and the known locations of the satellites. Positioning methods which may be supported using SVs 190 may include Assisted GNSS (A-GNSS), Real Time Kinematic (RTK), Precise Point Positioning (PPP) and Differential GNSS (DGNSS). Information and signals from SVs 102 may also be used to support positioning. The UE 115 may further support positioning using terrestrial positioning methods, such as Downlink (DL) Time Difference of Arrival (DL-TDOA), Enhanced Cell ID (ECID), Round Trip signal propagation Time (RTT), multi-cell RTT, angle of arrival (AOA), angle of departure (AOD), time of arrival (TOA), receive-time transmission-time difference (RxTx) and/or other positioning methods.

An estimate of a location of the UE 115 may be referred to as a geodetic location, location, location estimate, location fix, fix, position, position estimate or position fix, and may be geodetic, thus providing location coordinates for the UE 115 (e.g., latitude and longitude) which may or may not include an altitude/elevation component (e.g., height above sea level, height above or depth below ground level, floor level or basement level). Alternatively, a location of the UE 115 may be expressed as a civic location (e.g., as a postal address or the designation of some point or small area in a building such as a particular room or floor). A location of the UE 115 may also be expressed as an area or volume (defined either geodetically or in civic form) within which the UE 115 is expected to be located with some probability or confidence level (e.g., 67%, 95%, etc.) A location of the UE 115 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local x, y, and possibly z coordinates and then, if needed, convert the local coordinates into absolute ones (e.g., for latitude, longitude and altitude above or below mean sea level).

The UEs 115 are configured to communicate with 5GCNs 110 via the SVs 102, earth stations 104, and gNBs 106. As illustrated by NG-RAN 112, the NG-RANs associated with the 5GCNs 110 may include one or more gNBs 106. The NG-RAN 112 may further include a number of terrestrial gNBs (not shown in FIG. 1), that are not capable of communication with UEs via SVs 102. Pairs of terrestrial and/or satellite base stations, e.g., a terrestrial gNB and gNB 106-1 in NG-RAN 112, may be connected to one another using terrestrial links—e.g., directly or indirectly via other terrestrial gNBs or gNBs 106 and communicate using an Xn interface. Access to the 5G network is provided to UEs 115 via wireless communication between each UE 115 and a serving gNB 106, via an SV 102 and an NTN Gateway 104. The gNBs 106 may provide wireless communications access to the 5GCN 110 on behalf of each UE 115 using 5G NR. 5G NR radio access may also be referred to as NR radio access or as 5G radio access and may be as defined by the Third Generation Partnership Project (3GPP).

Base stations (BSs) in the NG-RAN 112 shown in FIG. 1 may also or instead include a next generation evolved Node B 114, also referred to as an ng-eNB 114. An ng-eNB 114 may be connected to one or more gNBs 106 and/or terrestrial gNBs in NG-RAN 112—e.g., directly or indirectly via other gNBs 106, terrestrial gNBs and/or other ng-eNBs 114. An ng-eNB 114 may provide LTE wireless access and/or evolved LTE (eLTE) wireless access to a UE 115. An ng-eNB 114 may be connected to an NTN gateway 104 and support satellite wireless access for UEs 115 (e.g., IOT UEs) using enhanced Machine Type Communication (eMTC), also referred to as LTE-M, or Narrowband IOT (NB-IOT). EMTC and NB-IOT are variants of LTE in which lower bandwidth is provided to, and supported by, UEs 115 and which enable support of UEs 115 with low resource capability (e.g., lower processing and memory availability) and limited power availability (e.g., a UE 115 with a battery which should provide power to the UE 115 for 2 to 10 years before being replaced or recharged). NB-IOT and eMTC may be preferred to NR for support of IOT UEs with very limited resources and power availability.

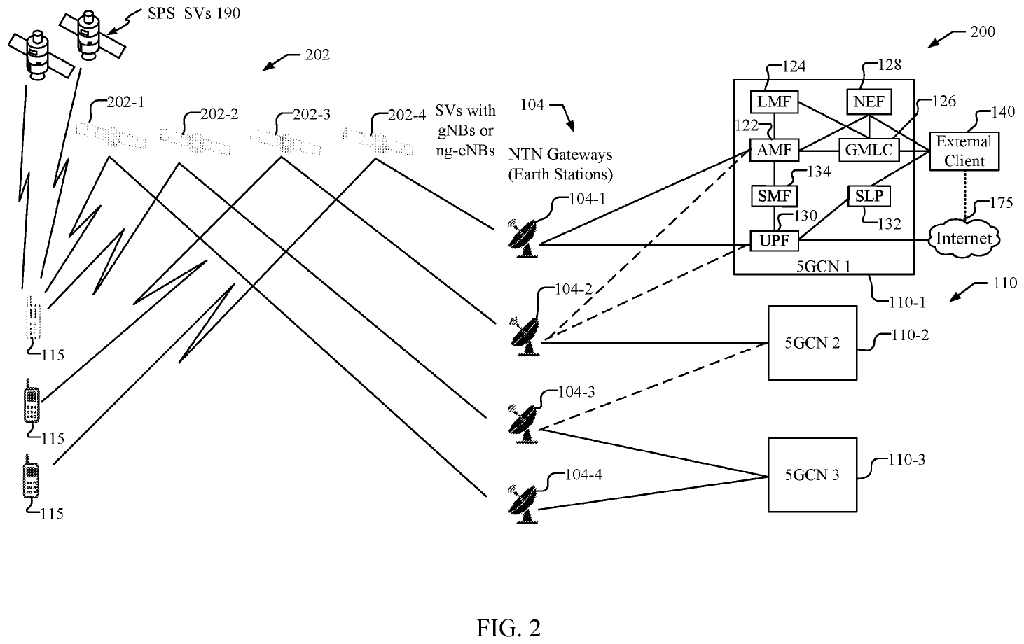

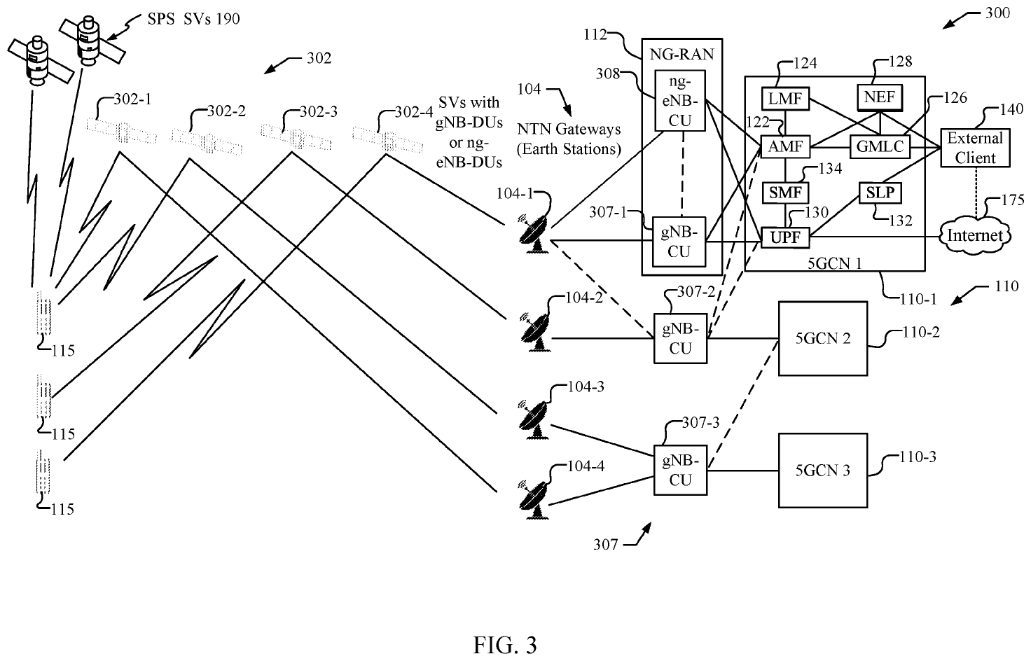

The term “satellite NodeB” is used herein to refer to a gNB (e.g., gNB 106) or ng-eNB (e.g., ng-eNB 114) that provides satellite wireless access, e.g., as exemplified in FIG. 1. A satellite Node B may be regenerative, as described later for FIGS. 2 and 3, and/or may in some embodiments correspond to an evolved Node B (eNB) that provides satellite wireless access (e.g., using LTE, eMTC or NB-IOT) to a core network that is an EPC. A satellite NodeB may be referred to by other names or terms such as an sNB or a “satellite node” or “satellite access node.” Satellite NodeBs corresponding to gNBs 106 are not the same as terrestrial gNBs, but may be based on a terrestrial gNB with additional capability. For example, a gNB 106 may terminate the radio interface and associated radio interface protocols to UEs 115 and may transmit DL signals to UEs 115 and receive UL signals from UEs 115 via SVs 102 and earth stations 104. A gNB 106 may also support signaling connections and voice and data bearers to UEs 115 and may support handover of UEs 115 between different satellite cells for the same SV 102, between different SVs 102 and/or between different gNBs 106. In some systems, a gNB 106 may be referred to as a gNB or as an enhanced gNB. The gNBs 106 may be configured to manage moving satellite beams (for LEO SVs) and associated mobility of UEs 115. The gNBs 106 may assist in the handover (or transfer) of SVs 102 between different Earth stations 104, different gNBs 106, and between different countries. The gNBs 106 may hide or obscure specific aspects of connected SVs 102 from the 5GCN 110, e.g., by interfacing to a 5GCN 110 in the same way as, or in a similar way to, a terrestrial gNB, and may avoid a 5GCN 110 from having to maintain configuration information for SVs 102 or perform mobility management related to SVs 102. The gNBs 106 may further assist in sharing of SVs 102 over multiple countries. The gNBs 106 may communicate with one or more earth stations 104, e.g., as illustrated by gNB 106-2 communicating with earth stations 104-2 and 104-1. The gNBs 106 may be separate from earth stations 104, e.g., as illustrated by gNBs 106-1 and 106-2, and earth stations 104-1 and 104-2. The gNBs 106 may include or may be combined with one or more earth stations 104, e.g., using a split architecture. For example, gNB 106-3 is illustrated with a split architecture, with a gNB central unit (gNB-CU) 107 and the earth stations 104-3 and 104-4 acting as Distributed Units (DUs). A gNB 106 may typically be fixed on the ground with transparent SV operation. In one implementation, one gNB 106 may be physically combined with, or physically connected to, one NTN Gateway 104 to reduce overall complexity and cost.

Satellite NodeBs corresponding to ng-eNBs 114 are not the same as terrestrial ng-eNBs, but may be based on a terrestrial ng-eNB with additional capability. The differences between ng-eNBs 114 and terrestrial ng-eNBs and the additional satellite related functions, capabilities and uses of an ng-eNB 114 may be similar to that described above for gNBs 106.

The earth stations 104 may be shared by more than one gNB 106 and/or more than one ng-eNB 114 and may communicate with UE 115 via the SVs 102. An NTN Gateway 104 may be dedicated to just one SVO and to one associated constellation of SVs 102 and hence may be owned and managed by the SVO. While earth stations 104 may be included within an ng-eNB 114 or gNB 106, e.g., as a gNB-DU within gNB 106-3, this may only occur when the same SVO or the same MNO owns both the ng-eNB 114 or gNB 106 and the included earth stations 104. Earth stations 104 may communicate with SVs 102 using control and user plane protocols that may be proprietary to an SVO. The control and user plane protocols between earth stations 104 and SVs 102 may: (i) establish and release NTN Gateway 104 to SV 102 communication links, including authentication and ciphering; (ii) update SV software and firmware; (iii) perform SV Operations and Maintenance (O&M); (iv) control satellite beams (e.g., direction, power, on/off status) and mapping between satellite beams and earth station UL and DL payload; and (v) assist with handoff of an SV 102 or satellite cell to another NTN Gateway 104.

As noted, while FIG. 1 depicts nodes configured to communicate according to 5G NR and LTE communication protocols for an NG-RAN 112, nodes configured to communicate according to other communication protocols may be used, such as, for example, an LTE protocol (e.g., supporting UE 115 satellite access using eMTC or NB-IOT) for an Evolved Universal Mobile Telecommunications System (UMTS) Terrestrial Radio Access Network (E-UTRAN) or an IEEE 802.11x protocol for a WLAN. For example, in a 4G Evolved Packet System (EPS) providing LTE wireless access to UE 115, a RAN may comprise an E-UTRAN, which may comprise base stations comprising evolved Node Bs (eNBs) supporting LTE wireless access. A core network for EPS may comprise an Evolved Packet Core (EPC). An EPS may then comprise an E-UTRAN plus EPC, where the E-UTRAN corresponds to NG-RAN 112 and the EPC corresponds to 5GCN 110 in FIG. 1. In such a case, satellite NodeBs may comprise eNBs in an E-UTRAN connecting to NTN gateways 104 and to an EPC. The methods and techniques described herein for support of satellite acquisition assistance may be applicable to such other networks.

The gNBs 106, ng-eNB 114 and terrestrial gNBs may communicate with an Access and Mobility Management Function (AMF) 122 in a 5GCN 110, which, for positioning functionality, may communicate with a Location Management Function (LMF) 124. For example, the gNBs 106 and ng-eNB 114 may provide an N2 interface to the AMF 122. An N2 interface between a gNB 106 or ng-eNB 114 and a 5GCN 110 may be the same as an N2 interface supported between a terrestrial gNB or terrestrial ng-eNB and a 5GCN 110 for terrestrial NR or terrestrial LTE access by a UE 115 and may use the Next Generation Application Protocol (NGAP) defined in 3GPP Technical Specification (TS) 38.413 between a gNB 106 or ng-eNB 114 and the AMF 122. The AMF 122 may support mobility of the UE 115, including satellite cell change and handover and may participate in supporting a signaling connection to the UE 115 and possibly data and voice bearers for the UE 115. The LMF 124 may support positioning of the UE 115 when UE accesses the NG-RAN 112 and may support position procedures/methods such as A-GNSS, DL-TDOA, RTK, PPP, DGNSS, ECID, AOA, AOD, multi-cell RTT and/or other positioning procedures including positioning procedures based on communication signals from one or more SVs 102. The LMF 124 may also process location services requests for the UE 115, e.g., received from the AMF 122 or from a Gateway Mobile Location Center (GMLC) 126. The LMF 124 may be connected to AMF 122 and/or to GMLC 126. In some embodiments, a node/system that implements the LMF 124 may additionally or alternatively implement other types of location-support modules, such as an Enhanced Serving Mobile Location Center (E-SMLC). It is noted that in some embodiments, at least part of the positioning functionality (including derivation of a UE 115's location) may be performed at the UE 115 (e.g., using signal measurements obtained by UE 115 for signals transmitted by SVs 102, SVs 190, terrestrial gNBs and assistance data provided to the UE 115, e.g., by LMF 124).

The GMLC 126 may support a location request for the UE 115 received from an external client 140 and may forward such a location request to the AMF 122 for forwarding by the AMF 122 to the LMF 124 or may forward the location request directly to the LMF 124. A location response from the LMF 124 (e.g., containing a location estimate for the UE 115) may be similarly returned to the GMLC 126 either directly or via the AMF 122, and the GMLC 126 may then return the location response (e.g., containing the location estimate) to the external client 140. The GMLC 126 is shown connected to both the AMF 122 and LMF 124 in FIG. 2 though only one of these connections may be supported by 5GCN 110 in some implementations.

A Network Exposure Function (NEF) 128 may be included in 5GCN 110, e.g., connected to the GMLC 126 and the AMF 122. In some implementations, the NEF 128 may be connected to communicate directly with the external client 140. The NEF 128 may support secure exposure of capabilities and events concerning 5GCN 110 and UE 115 to an external client 140 and may enable secure provision of information from external client 140 to 5GCN 110.

A User Plane Function (UPF) 130 may support voice and data bearers for UE 115 and may enable UE 115 voice and data access to other networks such as the Internet 175. The UPF 130 may be connected to gNBs 106 and ng-eNBs 114. UPF 130 functions may include: external Protocol Data Unit (PDU) session point of interconnect to a Data Network, packet (e.g., IP) routing and forwarding, packet inspection and user plane part of policy rule enforcement, Quality of Service (QoS) handling for user plane, downlink packet buffering and downlink data notification triggering. UPF 130 may be connected to a Secure User Plane Location (SUPL) Location Platform (SLP) 132 to enable support of positioning of UE 115 using SUPL. SLP 132 may be further connected to or accessible from external client 140.

As illustrated, a Session Management Function (SMF) 134 connects to the AMF 122 and the UPF 130. The SMF 134 may have the capability to control both a local and a central UPF within a PDU session. SMF 134 may manage the establishment, modification and release of PDU sessions for UE 115, perform IP address allocation and management for UE 115, act as a Dynamic Host Configuration Protocol (DHCP) server for UE 115, and select and control a UPF 130 on behalf of UE 115.

The external client 140 may be connected to the 5GCN 110 via the GMLC 126 and/or the SLP 132, and/or NEF 128. The external client 140 may optionally be connected to the 5GCN 110 and/or to a location server, which may be, e.g., an SLP, that is external to 5GCN 110, via the Internet 175. The external client 140 may be connected to the UPF 130 directly (not shown in FIG. 1) or through the Internet 175. The external client 140 may be a server, a web server, or a user device, such as a personal computer, a UE, etc.

As noted, while the communication system 100 is described in relation to 5G technology, the communication system 100 may be implemented to support other communication technologies, such as GSM, WCDMA, LTE, etc., that are used for supporting and interacting with mobile devices such as the UE 115 (e.g., to implement voice, data, positioning, and other functionalities). In some such embodiments, the 5GCN 110 may be configured to control different air interfaces. For example, in some embodiments, 5GCN 110 may be connected to a WLAN, either directly or using a Non-3GPP InterWorking Function (N3IWF, not shown FIG. 1) in the 5GCN 110. For example, the WLAN may support IEEE 802.11 WiFi access for UE 115 and may comprise one or more WiFi APs. Here, the N3IWF may connect to the WLAN and to other elements in the 5GCN 110 such as AMF 122.

Support of transparent SVs 102 with the network architecture shown in FIG. 1 may impact the communication system as follows. The 5GCN 110 may treat a satellite RAT as a new type of terrestrial RAT with longer delay, reduced bandwidth and higher error rate. Consequently, while there may be some impact to PDU session establishment and mobility management (MM) and connection management (CM) procedures, impacts to an AMF 122 (or LMF 124) may be small—e.g., such as providing pre-configured data for fixed tracking areas (TAs) and cells to a UE 115 during Registration. There may be no impact to the SVs 102. The SVs 102 may be shared with other services (e.g., satellite TV, fixed Internet access) with 5G NR mobile access for UEs 115 added in a transparent manner. This may enable legacy SVs 102 to be used and may avoid the need to deploy a new type of SV 102. Further, the gNBs 106 and ng-eNBs 114 may be fixed and may be configured to support one country and one or more PLMNs in that country. The gNBs 106 and ng-eNBs 114 may need to assist assignment and transfer of SVs 102 and satellite cells between gNBs 106 or ng-eNBs 114 and earth stations 104 and support handover of UEs 115 between satellite cells, SVs 102, other gNBs 106 and/or other ng-eNBs 114. Thus, the gNB 106 may differ from a terrestrial gNB and the ng-eNB 114 may differ from a terrestrial ng-eNB. Additionally, a coverage area of a gNB 106 or ng-eNB 114 may be much larger than the coverage area of a terrestrial gNB or terrestrial ng-eNB.

In some implementations, the satellite beam coverage of an SV 102 may be large, e.g., up to or greater than 1000 kilometers (kms) across, and may provide access to more than one country. An NTN Gateway 104 may be shared by multiple gNBs 106 and/or by multiple ng-eNBs 114 (e.g., NTN Gateway 104-1 may be shared by gNBs 106-1 and 106-2 and by ng-eNB 114), and a gNB 106 and/or ng-eNB 114 may be shared by multiple core networks in separate PLMNs located in the same country or in different countries (e.g., gNB 106-2 may be shared by 5GCN1 110-1 and 5GCN2 110-1, which may be in different PLMNs in the same country or in different countries).

To simplify later referencing to a satellite NodeB supporting transparent SV wireless access, any later reference herein to a gNB 106 can also be considered to refer, as an alternative, to an ng-eNB 114 or to a satellite NodeB that comprises an eNB accessing an EPC.

FIG. 2 illustrates an example of a communication system 200 that may be capable of supporting satellite access using 5G NR or some other wireless access type such as CDMA, according to an embodiment. Communication system 200 may implement aspects of communication system 100.

The network architecture shown in FIG. 2 is similar to that shown in FIG. 1, like designated elements being similar or the same. FIG. 2, however, illustrates a network architecture with regenerative SVs 202-1, 202-2, 202-3, and 202-4 (collectively SVs 202), as opposed to transparent SVs 102 shown in FIG. 1. A regenerative SV 202, unlike a transparent SV 102, includes an on-board satellite NodeB, referred to as a gNB 202, which may include the functional capability of a gNB 106, and is sometimes referred to herein as an SV/gNB 202. The NG-RAN 112 is illustrated as including the SV/gNBs 202. Reference to a gNB 202 is used herein when referring to SV/gNB 202 functions related to communication with UEs 115 and 5GCNs 110, whereas reference to an SV 202 is used when referring to SV/gNB 202 functions related to communication with earth stations 104 and with UEs 115 at a physical radio frequency level. However, there may be no precise delimitation of an SV 202 versus a gNB 202.

An onboard gNB 202 may perform some or all of the same functions as a gNB 106 as described previously. For example, a gNB 202 may terminate the radio interface and associated radio interface protocols to UEs 115 and may transmit DL signals to UEs 115 and receive UL signals from UEs 115, which may include encoding and modulation of transmitted signals and demodulation and decoding of received signals. A gNB 202 may also support signaling connections and voice and data bearers to UEs 115 and may support handover of UEs 115 between different satellite cells for the same gNB 202 and between different gNBs 202. The gNBs 202 may assist in the handover (or transfer) of SVs 202 between different Earth stations 104, different 5GCNs 110, and between different countries. The gNBs 202 may hide or obscure specific aspects of SVs 202 from the 5GCN 110, e.g., by interfacing to a 5GCN 110 in the same way as, or in a similar way to, a terrestrial gNB. The gNBs 202 may further assist in sharing of SVs 202 over multiple countries. The gNBs 202 may communicate with one or more earth stations 104 and with one or more 5GCNs 110 via the earth stations 104. In some implementations, gNBs 202 may communicate directly with other gNBs 202 using Inter-Satellite Links (ISLs) (not shown in FIG. 2), which may support an Xn interface between any pair of gNBs 202.

With LEO SVs, an SV/gNB 202 may need to manage moving satellite cells with coverage in different countries at different times. Earth stations 104 may be connected directly to the 5GCN 110, as illustrated. For example, as illustrated, NTN Gateway 104-1 may be connected to AMF 122 and UPF 130 of 5GCN1 110-1, while NTN Gateway 104-2 may be similarly connected to 5GCN2 110-2, and earth stations 104-3 and 104-4 are connected to 5GCN3 110-3. The earth stations 104 may be shared by multiple 5GCNs 110, for example, if Earth stations 104 are limited. For example, in some implementations (illustrated with dotted lines), NTN Gateway 104-2 may be connected to both 5GCN1 110-1 and 5GCN2 110-2, and NTN Gateway 104-3 may be connected to both 5GCN2 110-2 and 5GCN3 110-3. The 5GCN 110 may need to be aware of SV 202 coverage areas in order to page UEs 115 and to manage handover. Thus, as can be seen, the network architecture with regenerative SVs may have more impact and complexity with respect to both gNBs 202 and 5GCNs 110 than the network architecture with transparent SVs 102 shown in FIG. 1.

Support of regenerative SVs with the network architecture shown in FIG. 2 may impact the communication system 200 as follows. The 5GCN 110 may be impacted if fixed TAs and cells are not supported, since core components of mobility management and regulatory services, which are typically based on fixed cells and fixed TAs for terrestrial PLMNs, might have to be replaced by a new system (e.g., based on UE 115 location). If fixed TAs and fixed cells are supported, a 5GCN 110 (e.g., the AMF 122) may need to map any fixed TA to one or more SVs 202 with current radio coverage of the TA when performing paging of a UE 115 that is located in this TA. This could require configuration in the 5GCN 110 of long term orbital data for SVs 202 (e.g., obtained from an SVO for SVs 202) and could add significant new impact to a 5GCN 110.

Legacy SVs might need a substantial software (SW) update to support gNB 202 functions, which may not be feasible. An SV 202 would also need to fully support all UEs 115 accessing the SV 202, which could be problematic with a legacy SV due to limited processing and storage capability. Hence, an SV 202 would probably need to comprise new hardware (HW) and SW rather than being based on a SW upgrade to an existing SV. A new SV/gNB 202 may need to support regulatory and other requirements for multiple countries. A GEO SV 202 coverage area would typically include several or many countries, whereas a LEO or medium earth orbit (MEO) SV 202 would typically orbit over many countries. Support of fixed tracking areas (TAs) and fixed cells may then require that a SV/gNB 202 be configured with fixed TAs and fixed cells for an entire worldwide coverage area. Alternatively, AMFs 122 (or LMFs 124) in individual 5GCNs 110 could support fixed TAs and fixed cells for the associated PLMN to reduce SV/gNB 202 complexity and at the expense of more 5GCN 110 complexity. Additionally, SV/gNB 202 to SV/gNB 202 ISLs would typically change dynamically as relative SV/gNB 202 positions change, making Xn related procedures more complex.

For support of satellite access using LTE, NB-IOT or eMTC, a regenerative SV 202 can include an on-board satellite NodeB which may include the functional capability of either an ng-eNB 114 or an eNB instead of the functional capability of a gNB 106 that supports NR access. The functions of the SV 202 and the on-board satellite NodeB and the impacts to a 5GCN 110 can then be the same as, or similar to, those described above for an SV 202 with an on board satellite NodeB that corresponds to a gNB 106 supporting NR access, but with the difference that any reference to a gNB 202 would then refer to an ng-eNB or an eNB, and any reference to a 5GCN 110 or 5GCN 110 entity (e.g., an AMF 122 or UPF 130) would then refer, respectively, to an EPC or a corresponding EPC entity (e.g., a Mobility Management Entity (MME) or a Serving Gateway (SGW) plus Packet Data Gateway (PDG)) for a gNB 202 that corresponds to an eNB. Accordingly, reference to a gNB 202, an SV/gNB 202 or an SV 202 herein can be considered to allow for the case where the satellite NodeB component of the SV 202 supports the functionality of an ng-eNB 114 or an eNB.

FIG. 3 illustrates an example of a diagram of a communication system 300 that may be capable of supporting satellite access using 5G NR or some other wireless access type such as CDMA, according to an embodiment. Communication system 300 may implement aspects of communication systems 100 and/or 200.

The network architecture shown in FIG. 3 is similar to that shown in FIGS. 1 and 2, like designated elements being similar or the same. FIG. 3, however, illustrates a network architecture with regenerative SVs 302-1, 302-2, 302-3, and 302-4 (collectively referred to as SVs 302), as opposed to transparent SVs 102 shown in FIG. 1, and with a split architecture for the satellite NodeBs. The satellite NodeBs, referred to as gNBs 307 (e.g., gNB 307-1, 307-2, and 307-3), include a central unit and may sometimes be referred as gNB-CU 307, and a regenerative SV 302, unlike a transparent SV 102, includes an on-board gNB Distributed Unit (gNB-DU) 302, and is sometimes referred to herein as an SV/gNB-DU 302. Reference to a gNB-DU 302 is used herein when referring to SV/gNB 302 functions related to communication with UEs 115 and gNB-CUs 307, whereas reference to an SV 302 is used when referring to SV/gNB-DU 302 functions related to communication with earth stations 104 and with UEs 115 at a physical radio frequency level. However, there may be no precise delimitation of an SV 302 versus a gNB-DU 302.

Each gNB-DU 302 communicates with one ground based gNB-CU 307 via one or more earth stations 104. One gNB-CU 307 together with the one or more gNB-DUs 302 which are in communication with the gNB-CU 307 performs functions, and may use internal communication protocols, which are similar to or the same as a gNB with a split architecture as described in 3GPP TS 38.401. Here a gNB-DU 302 corresponds to and performs functions similar to or the same as a gNB Distributed Unit (gNB-DU) defined in TS 38.401, while a gNB-CU 307 corresponds to and performs functions similar to or the same as a gNB Central Unit (gNB-CU) defined in TS 38.401. For example, a gNB-DU 302 and a gNB-CU 307 may communicate with one another using an F1 Application Protocol (F1AP) as defined in 3GPP TS 38.473 and together may perform some or all of the same functions as a gNB 106 or gNB 202 as described previously. To simplify references to different types of gNB is the description below, a gNB-DU 302 may sometimes be referred to a gNB 302 (without the “DU” label), and a gNB-CU 307 may sometimes be referred to a gNB 307 (without the “CU” label).

A gNB-DU 302 may terminate the radio interface and associated lower level radio interface protocols to UEs 115 and may transmit DL signals to UEs 115 and receive UL signals from UEs 115, which may include encoding and modulation of transmitted signals and demodulation and decoding of received signals. A gNB-DU 302 may support and terminate Radio Link Control (RLC), Medium Access Control (MAC) and Physical (PHY) protocol layers for the NR RF interface to UEs 115, as defined in 3GPP TSs 38.201, 38.202, 38.211, 38.212, 38.213, 38.214, 38.215, 38.321 and 38.322. The operation of a gNB-DU 302 is partly controlled by the associated gNB-CU 307. One gNB-DU 302 may support one or more NR satellite cells for UEs 115. A gNB-CU 307 may support and terminate a Radio Resource Control (RRC) protocol, Packet Data Convergence Protocol (PDCP) and Service Data Protocol (SDAP) for the NR RF interface to UEs 115, as defined in 3GPP TSs 38.331, 38.323, and 37.324, respectively. A gNB-CU 307 may also be split into separate control plane (gNB-CU-CP) and user plane (gNB-CU-UP) portions, where a gNB-CU-CP communicates with one or more AMFs 122 in one more 5GCNs 110 using the NGAP protocol and where a gNB-CU-UP communicates with one or more UPFs 130 in one more 5GCNs 110 using a General Packet Radio System (GPRS) tunneling protocol (GTP) user plane protocol (GTP-U) as defined in 3GPP TS 29.281. An gNB-DU 302 and gNB-CU 307 may communicate over an F1 interface to (a) support control plane signaling for a UE 115 using IP, Stream Control Transmission Protocol (SCTP) and F1 Application Protocol (F1AP) protocols, and (b) to support user plane data transfer for a UE using IP, User Datagram Protocol (UDP), PDCP, SDAP, GTP-U and NR User Plane Protocol (NRUPP) protocols.

A gNB-CU 307 may communicate with one or more other gNB-CUs 307 and/or with one more other terrestrial gNBs using terrestrial links to support an Xn interface between any pair of gNB-CUs 307 and/or between any gNB-CU 307 and any terrestrial gNB.

A gNB-DU 302 together with a gNB-CU 307 may: (i) support signaling connections and voice and data bearers to UEs 115; (ii) support handover of UEs 115 between different satellite cells for the same gNB-DU 302 and between different gNB-DUs 302; and (iii) assist in the handover (or transfer) of SVs 302 between different Earth stations 104, different 5GCNs 110, and between different countries. A gNB-CU 307 may hide or obscure specific aspects of SVs 302 from a 5GCN 110, e.g., by interfacing to a 5GCN 110 in the same way or in a similar way to a terrestrial gNB. The gNB-CUs 307 may further assist in sharing of SVs 302 over multiple countries.

In communication system 300, the gNB-DUs 302 that communicate with and are accessible from any gNB-CU 307 will change over time with LEO SVs 302. With the split gNB architecture, a 5GCN 110 may connect to fixed gNB-CUs 307 which do not change over time and which may reduce difficulty with paging of a UE 115. For example, a 5GCN 110 may not need to know which SV/gNB-DUs 302 are needed for paging a UE 115. The network architecture with regenerative SVs 302 with a split gNB architecture may thereby reduce 5GCN 110 impact at the expense of additional impact to a gNB-CU 307.

Support of regenerative SVs 302 with a split gNB architecture as shown in FIG. 3 may impact the communication system 300 as follows. The impact to 5GCN 110 may be limited as for transparent SVs 102 discussed above. For example, the 5GCN 110 may treat a satellite RAT in communication system 300 as a new type of terrestrial RAT with longer delay, reduced bandwidth and higher error rate. The impact on SV/gNB-DUs 302 may be less than the impact on SV/gNBs 202 (with non-split architecture), as discussed above in reference to FIG. 2. The SV/gNB-DU 302 may need to manage changing association with different (fixed) gNB-CUs 307. Further, an SV/gNB-DU 302 may need to manage satellite beams and satellite cells. The gNB-CU 307 impacts may be similar to gNB 106 impacts for a network architecture with transparent SVs 102, as discussed above, except for impacts to support satellite cells and satellite beams which may impact gNB-DUs 302 but not a gNB-CU 307.

For support of satellite access using LTE, NB-IOT or eMTC, regenerative SVs 302 with a split architecture for the satellite NodeBs could also be used. However, unlike the split architecture for a terrestrial gNB that supports 5G NR, no split architecture may be defined for a terrestrial ng-eNB or a terrestrial eNB. However, a split architecture may be possible, in principle, using CUs and DUs that perform analogous functions to gNB-CUs and gNB-DUs for either a terrestrial ng-eNB or a terrestrial eNB. In that case, a gNB-CU 307 shown in FIG. 3 could be replaced by either a CU for an ng-eNB 114, shown as ng-eNB-CU 308 in FIG. 3, or a CU for an eNB (not shown in FIG. 3), and a gNB-DU 302 in an SV 302 could be replaced by a DU for an ng-eNB 114 or an eNB. In this case, a reference to a gNB-DU 302 herein could refer to a DU for an ng-eNB 114 or eNB, a reference to a gNB 307 or a gNB-CU 307 herein could refer to an ng-eNB-CU 308 or a CU for an eNB, and a reference to an SV 302 could refer to an SV with onboard functionality for a DU for an ng-eNB 114 or eNB.

There are several SVOs currently operating and several additional SVOs that are preparing to begin operations that may be capable of supporting satellite access using 5G NR or some other wireless access type such as CDMA. Various SVOs may employ different numbers of LEO SVs and Earth gateways and may use different technologies. For example, currently operating SVOs include SVOs using transparent (“bent pipe”) LEO SVs with CDMA, and regenerative LEO SVs capable of ISL. New SVOs have been recently announced with plans for large constellations of LEO SVs to support fixed Internet access. These various SVOs are widely known to the industry.

While supporting satellite access to a wireless network, an SV 102/202/302 may transmit satellite beams (also referred to as “radio beams” or just as “beams”) over multiple countries. For example, a beam transmitted by an SV 102/202/302 may overlap two or more countries. Sharing a beam over two or more countries, however, may raise complications. For example, if a beam is shared by two or more countries, earth stations 104 and gNBs 106/202/302/307 in one country may need to support UE 115 access from other countries. Sharing a beam over multiple countries may raise security issues for privacy for both data and voice. Further, sharing an SV beam over multiple countries may raise regulatory conflicts. For example, regulatory services including Wireless Emergency Alerts (WEA), Lawful Interception (LI), and emergency services (EM) calls in a first country could need support from gNBs 106/202/307 and earth stations 104 in a second country that shares the same SV beam.

One solution to complications raised by beam sharing amongst multiple countries would be to assign one beam to one country. A possible exception to the assignment of one beam to one country may be made for small nearby countries. The assignment of a beam to a single country additionally implies assigning each satellite cell to one country.

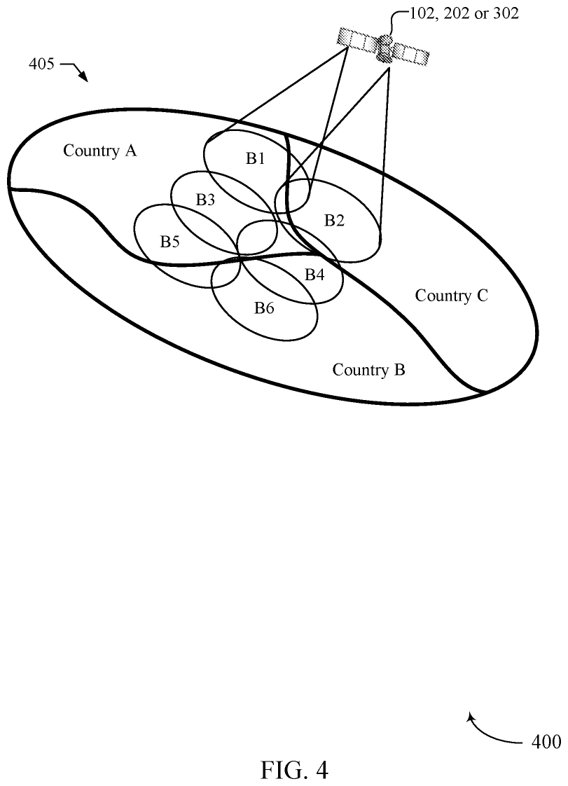

FIG. 4 illustrates an example of a communication system 400 that, by way of example, illustrates an SV 102, 202, 302 generating multiple beams identified as beams B1, B2, B3, B4, B5, and B6 over an area 405 that includes portions of multiple countries, e.g., country A, country B, and country C. Communication system 400 may implement aspects of communication systems 100, 200, and/or 300. With the assignment of each beam to just one country, beams B1, B3, B5 are assigned to country A, beams B4 and B6 are assigned to country B, and beam B2 is assigned to country C.

In one implementation, an individual beam may be assigned to a single country by controlling or steering the beam. While a Non-Geostationary Earth Orbiting (NGEO) SV has a moving coverage area, a relative beam direction may be moved via a controllable antenna array to stay. or mostly stay, within one country, which is sometimes referred to as a “steerable beam”. For example, beam coverage may move slowly within one country and then hop to a new country, e.g., after an SV 102, 202, 302 has transferred to a new NTN Gateway 104 or new gNB 106 or 307.

In another implementation, a satellite cell and satellite beam may be allowed to support access by different UEs 115 in two or more countries at the same time. For example, beam B1 may support access from UEs 115 in countries A and C, and beams B4 and B5 may support access from UEs 115 in countries A and B. In such cases, it may be important for the support of regulatory services if a gNB 106/202/307 and/or an AMF 122 can determine the country in which a UE 115 is located.

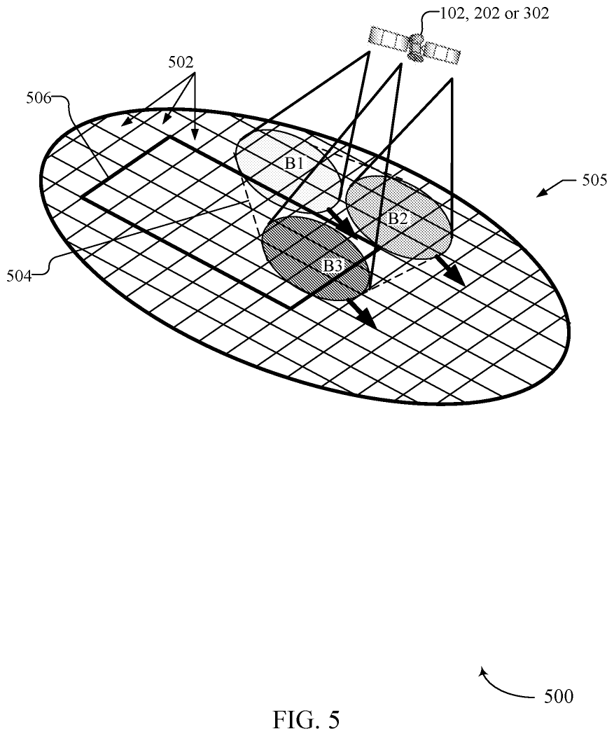

FIG. 5 illustrates an example of a communication system 500 that includes satellite cells produced by an SV 102, 202, 302 over an area 505 that includes a number of Earth fixed cells 502. Communication system 500 may implement aspects of communication systems 100, 200, 300, and/or 400. A satellite cell may comprise a single beam or multiple beams, e.g., all beams in a satellite cell may use the same frequency or a satellite cell may comprise one beam for each frequency in a set of different frequencies. For example, beams B1, B2 and B3 may support three separate satellite cells (one beam per satellite cell) or may collectively support a single satellite cell (e.g., satellite cell 504 shown with dotted lines). Preferably, a satellite cell covers a contiguous area.

Satellite beams and satellite cells produced by an SV 102, 202, 302 may not align with cells used by terrestrial wireless networks, e.g., 5GCN 110 terrestrial cells or LTE terrestrial cells. For example, in an urban area, a satellite beam or satellite cell produced by an SV 102, 202, 302 may overlap with many 5GCN fixed terrestrial cells. When supporting satellite access to a wireless network, information regarding satellite beams and satellite cells produced by an SV 102, 202, 302 may be hidden from (e.g., not configured in or provided to) a 5GCN 110.

As illustrated in FIG. 5, an area 505 may include a number of Earth fixed cells 502, as well as fixed tracking areas (TAs) such as TA 506. Fixed cells are not “real cells,” e.g., as used for terrestrial NR and LTE access, and may be referred to as “virtual cells” or “geographic cells.” A fixed cell, such as fixed cells 502, has a fixed geographic coverage area, which may be defined by a PLMN operator. For example, the coverage area of a fixed cell or a fixed TA may comprise the interior of a circle, ellipse or a polygon. The coverage area is fixed relative to the surface of the Earth and does not change with time, unlike the coverage area of a satellite cell which typically changes with time for a LEO or MEO SV. A fixed cell 502 may be treated by a 5GCN 110 the same as a real cell that supports terrestrial NR access. Groups of fixed cells 502 may define a fixed TA 506, which may be treated by a 5GCN the same as TAs that are defined for terrestrial NR access. Fixed cells and fixed TAs used for 5G satellite wireless access may be used by a 5GCN 110 to support mobility management and regulatory services for UEs 115 with minimal new impact.

With regenerative SVs 202 with a non-split architecture as in communication systems 200, each satellite cell may remain with the same SV 202 and may have a moving coverage area supporting different 5GCNs 110 at different times.

With transparent SVs 102 and regenerative SVs 302 for a split architecture as in communication system 300, each satellite cell may be assigned to and controlled by one gNB 106 or 307 on behalf of one or more PLMNs in one country. For a GEO SV 102/302, the assignment to a gNB 106/307 may be permanent or temporary. For example, the assignment may change on a daily basis to allow for peak traffic occurrence at different times in different parts of the SV 102/302 radio footprint and/or may change over a longer period to accommodate changing regional traffic demands. For a non-geostationary (NGEO) SV 102/302, the assignment might last for a short time, e.g., only 5-15 minutes. A non-permanent satellite cell may then be transferred to a new gNB 106/307 as necessary (e.g., when access to the NGEO SV 102/302 is transferred to the new gNB 106/307). Each gNB 106/307, for example, may have a fixed geographic coverage area, e.g., comprising a plurality of fixed cells 502 and fixed TAs. A satellite cell for a first NGEO SV 102/302 may be transferred from a first gNB 106/307 to a second gNB 106/307 when (or after) moving into the fixed coverage area of the second gNB 106/307. Prior to this transfer, UEs 115 accessing the satellite cell in a connected state may be moved to a new satellite cell for the first gNB 106/307 or could be handed off to the second gNB 106/307 as part of transferring the satellite cell. An SV 102/302 may be accessed from only one gNB 106/307 or from multiple gNBs 106/307, possibly in different countries. In one implementation, an SV 102/302 may be assigned to multiple gNBs 106/307 by partitioning satellite cells produced by the SV 102/302 among the different gNBs 106/307. Satellite cells may then be transferred to new gNBs 106/307 (and to new countries) as the SV 102/302 moves or as traffic demands change. Such an implementation would be a form of a soft handoff in which SV 102/302 transfer from one gNB 106/307 to another gNB 106/307 occurs in increments of satellite cells and not all at once.

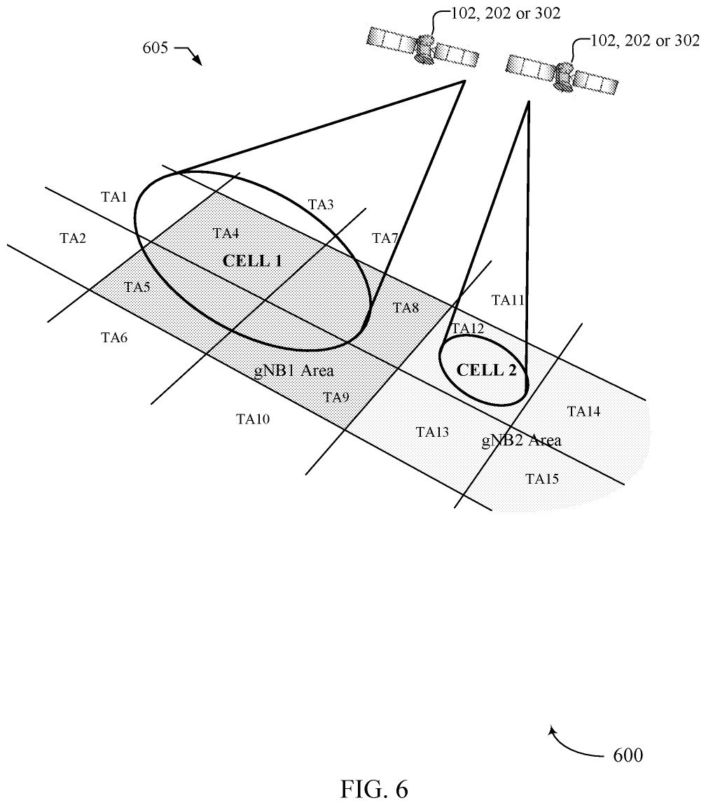

FIG. 6 illustrates an example of an assignment of satellite cells, e.g., cell 1 and cell 2 in a communication system 600, produced by one or more SVs 102, 202, 302 over an area 605. FIG. 6 may implement aspects of communication systems 100, 200, 300, 400, and/or 500.

In communication system 600, and as illustrated, the area 605 includes a number of fixed TAs, e.g., TA1-TA15, wherein TA4, TA5, TA8, and TA9 are assigned to a gNB1 (which may be a gNB 106, gNB 202 or a gNB 307), and TA12, TA13, TA14, and TA15 are assigned to a gNB2 (which may be another gNB 106, 202 or 307). In one implementation, a satellite cell may be considered to support a fixed TA if the satellite cell is wholly within the TA (e.g., Cell 2 within TA 12); if the TA is wholly within the satellite cell (e.g., TA4 within Cell 1); or if the overlap of the coverage area of a satellite cell and a TA exceeds a predetermined threshold fraction of the total coverage area of the satellite cell or the total area of the TA (e.g., Cell 1 overlap with TA1, TA3, TA5, TA8 or TA9). An SV 102, 202, 302 may broadcast, e.g., in a System Information Block type 1 (SIB1) or SIB type 2 (SIB2), the identities (IDs) of supported PLMNs (e.g., where a PLMN ID comprises a Mobile Country Code (MCC) and Mobile Network Code (MNC)) and, for each supported PLMN, the IDs of supported TAs (e.g., where the ID of a TA comprises a Tracking Area Code (TAC)). For an NGEO SV, the supported PLMNs and TAs may change as satellite cell coverage areas change. An gNB 106/202/307 may determine PLMN and TA support (and thus the PLMN IDs and TACs which are broadcast in a SIB for each satellite cell) from known ephemeris data for each SV 102/202/302 and a known directionality and angular range for component satellite beams for each satellite cell (e.g., Cell 1 and Cell 2). A gNB 106/202/307 may then update SIB broadcasting.

Thus, as illustrated in FIG. 6, an SV 102/202/302 may broadcast for Cell 1 a SIB that includes TACs for TA4 and possibly TA1, TA3, TA5, TA8 and/or TA9. Similarly, the SV 102/202/302 or another SV 102/202/302 may broadcast for Cell 2 a SIB that includes a TAC for TA12 only. The Cell 1 may be assigned to gNB1 (which has coverage of TA4, TA5, TA8, and TA9) and Cell 2 may be assigned to gNB2 (which has coverage of TA12, TA13, TA14, and TA15). Cell 1 and Cell 2 may be transferred from gNB1 to gNB2 or from gNB2 to gNB1 if the cell coverage area moves from one gNB area to another.

The coverage area for a fixed TA may be defined in a manner that is simple, precise, flexible and requires minimal signaling for conveyance to a UE 115 or gNB 106/202/307, or an entity in a 5GCN 110. A fixed TA area may be small enough to allow efficient paging by comprising an area supported by just a few satellite cells (e.g., less than 10) and may also be large enough to avoid excessive UE registration (e.g., may extend at least several kilometers in any direction). The shape of a fixed TA area may be arbitrary, e.g., the shape may be defined by a PLMN operator, or may have one or more restrictions. For example, one restriction for the shape of the fixed TA area may be that a fixed TA along the border of a country precisely aligns with the border to avoid serving UEs 115 in another country. Additionally, a fixed TA may be restricted to align with an area of interest, e.g., a Public Safety Answering Point (PSAP) serving area, the area of a large campus, etc. Additionally, a fixed TA may be restricted so that parts of the fixed TA align with a physical obstacle, such as the bank of a river or lake.

The coverage area for fixed cells may likewise be defined in a manner that is simple, precise, flexible and requires minimal signaling for conveyance to a UE 115 or gNB 106/202/307. A fixed cell coverage area may allow for simple and precise association with a fixed TA, e.g., one fixed cell may belong unambiguously to one fixed TA.

It may be beneficial for entities in a communication system (e.g. a UE 115 and/or AMF 122 in communication system 100, 200 or 300) to know when satellite coverage will and will not be available at a particular location (e.g. a current location of a UE 115). Traditional satellite coverage information techniques make use of satellite orbital and ephemeris data to indicate to an entity (e.g. a UE 115) when each of a number of satellites will be visible at a particular location (e.g. a current location of the entity). With these techniques, the entity would need to calculate the position of a satellite (using the orbital or ephemeris data) and determine at what times the satellite will and will not be visible at the particular location, which may be processor intensive, require implementation of complex programming logic and be prone to error. For example, even when a satellite is visible at a location, the location may not be in coverage of a satellite cell supported by the satellite (e.g. if the satellite does not have an antenna directed towards the location and able to transmit and receive signals to and from the location). Additionally, a satellite may not always have a backhaul connection to an NTN Gateway (e.g. an NNT Gateway 104) during the time that the satellite is visible at the location (e.g. if a PLMN is not configured to provide coverage using the satellite while the satellite is visible at the location). Therefore, new techniques may be needed to provide more accurate and reliable satellite coverage information to entities like a UE 115 and AMF 122.

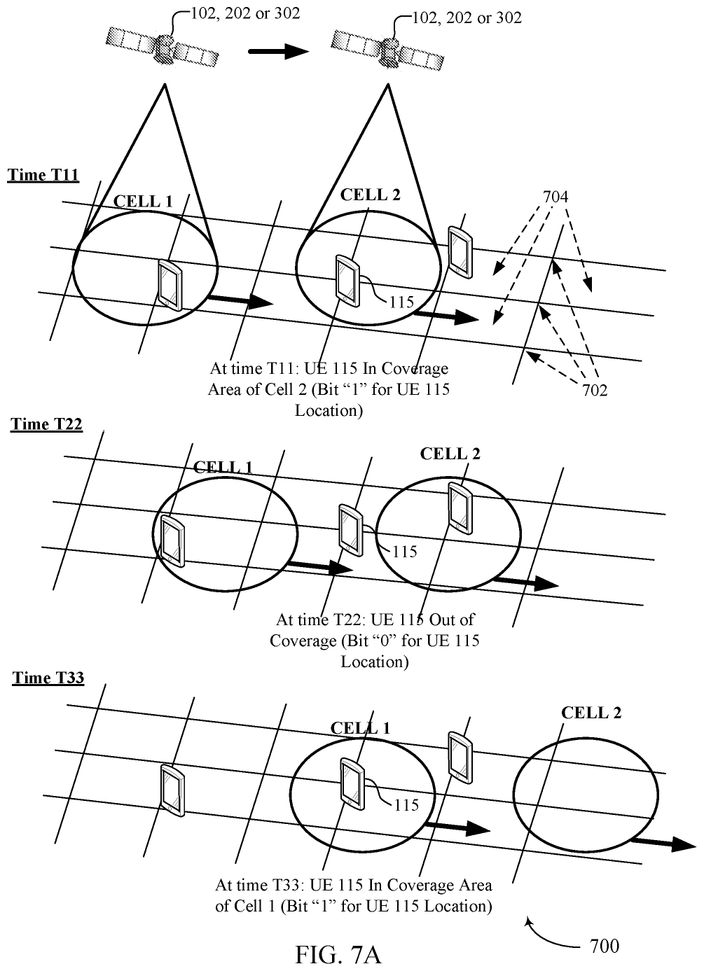

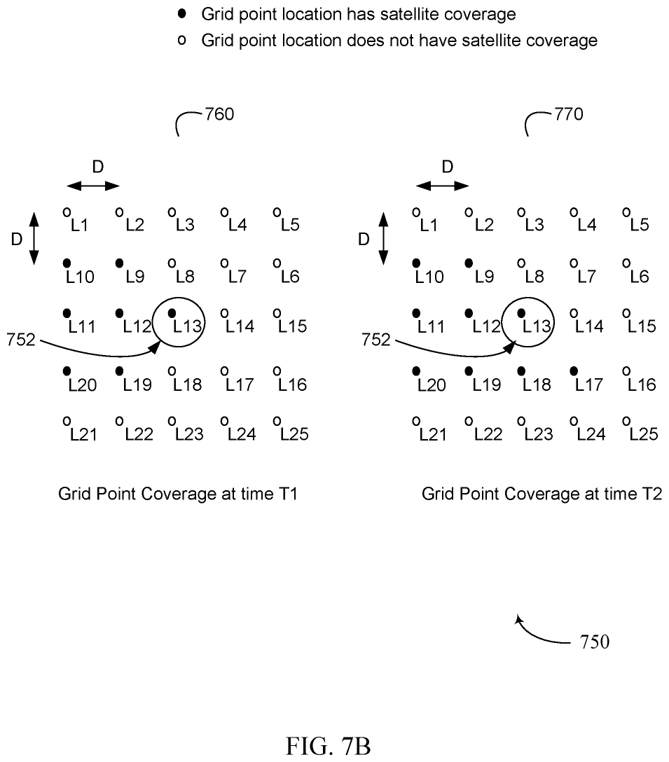

FIG. 7A illustrates an example of an assignment of satellite cells, e.g., cell 1 and cell 2 in a communication system 700, produced by one or more SVs 102, 202, 302 over an area divided into grid squares/points. FIG. 7A may implement aspects of communication systems 100, 200, 300, 400, 500, and/or 600.

Aspects of the techniques described herein may include an operation and maintenance (O&M) manager or server (e.g., of a serving PLMN) determining, pre-configuring and signaling satellite coverage data showing times of satellite cell (NTN) coverage and lack of coverage (e.g., times of no NTN coverage) at different locations and/or at different times. The satellite coverage data may be provided by the O&M manager to a UE 115, an AMF 122, an MME, a gNB 106/202/307 and/or to other entities to show when wireless coverage via one or more satellite cells is and is not available at one or more locations. The satellite coverage data may be determined (e.g. by the O&M manager), in part, using knowledge of SV orbital or ephemeris data, SV support of satellite cells and backhaul connection availability to an NTN Gateway. However, the satellite coverage data itself may exclude all of this original source information and may more directly indicate coverage versus lack of coverage, which may reduce processing complexity and processing load at a recipient entity (e.g. UE 115 or AMF 122) and avoid error.

In one embodiment, the satellite coverage data may be provided in the form of a “coverage map” which may reference, indicate or comprise a number of separate locations, designated L1, L2, L3, . . . Ln here, and/or a sequence of consecutive times, designated T1, T2, T3, . . . Tm here. Each location Li (1≤i≤n) may correspond to a single point on the Earth's surface or to an area on the surface of the Earth (e.g. where each area is between 1 kilometer (km) and 20 kms in length from one side to another or where each point is spaced 1 to 20 kms away from nearest other points). The sequence of consecutive times may occur at intervals, e.g. fixed intervals where each fixed interval is 10 seconds up to 2 minutes. In one implementation, the areas may each correspond to a fixed cell or a fixed tracking area as illustrated and described in FIGS. 5 and 6. The locations Li may further be arranged in a grid pattern as exemplified in FIG. 7A, where the locations Li may be either points 702 corresponding to the intersections of the vertical and horizontal lines in FIG. 7A, or rectangular areas 704 corresponding to the areas bounded by the vertical and horizontal lines in FIG. 7A. While the grid pattern shown in FIG. 7A is rectangular, other grid patterns are possible (e.g. based on triangles or hexagons). In addition, while FIG. 7A shows rectangular areas, locations Li that correspond to areas may have any shape, including (e.g.) circles, ellipses and polygons. Furthermore, locations Li that correspond to areas may be non-overlapping (e.g. as in FIG. 7A) or may be overlapping. For each location Li (1≤i≤n) and time Tj (1≤j≤m), the coverage map can indicate whether satellite coverage is or is not available at that location and at that time. A UE 115 can be assumed to be at a location Li if Li corresponds to an area and the UE 115 is inside the area or if Li corresponds to a point and is the closest point to UE 115.

Satellite coverage being available can correspond to a location Li being either entirely or partially within the coverage area of at least one satellite cell that can provide access to a particular PLMN (e.g. a current serving PLMN for a UE 115, a home PLMN for a UE 115 or any PLMN for which a UE 115 is allowed access). Similarly, satellite coverage not being available can correspond to a location Li not being either entirely or partially within the coverage area of at least one satellite cell that can provide access to a particular PLMN (e.g. a current serving PLMN for a UE 115, a home PLMN for a UE 115 or any PLMN for which a UE 115 is allowed access). For a location Li corresponding to a point (e.g. a point 702 in FIG. 7A), the point would typically be either within or not within a coverage area of a satellite cell with no difference between being partially or entirely within the coverage area. For a location Li corresponding to an area (e.g. an area 704 in FIG. 7A), the location Li may be partially within but not entirely within the coverage area of a satellite cell and hence there may be a difference between a coverage map based on partial inclusion and a coverage map based on total inclusion. A UE 115 or other entity (e.g. an AMF 122 or MME) can then decide (e.g. based on serving PLMN or home PLMN configuration data) whether to base satellite coverage determination for a location Li on partial inclusion or total inclusion.

A coverage map can indicate whether satellite coverage is or is not available at a location Li and a time Tj using a binary one value or a Boolean TRUE value (e.g. corresponding to coverage being available) or a binary zero value or Boolean FALSE value (e.g. corresponding to coverage not being available). A coverage map can then be represented by an array or a string of binary ones and zeros (or Boolean TRUE and FALSE values) and hence as a bit map, which may comprise a bit string or a bit array, and where there is some known correspondence between each bit in the bit map and a particular location Li and time Tj. Additional information may be provided as part of a coverage map, or separately from it, to indicate the locations L1, L2, L3, . . . Ln, and the consecutive times T1, T2, T3, . . . Tm that are represented in the coverage map and (if not implicit) to indicate a method used to encode the bit values. Thus, a coverage map (e.g. a bit map) may include multiple bits, where each bit corresponds to satellite coverage data for a specific location and a specific time.

For example, as shown in FIG. 7A at time T11, a UE 115 may be located within or at a grid point location where UE 115 is within the coverage area of cell 2. Accordingly, a bit map may be encoded to indicate a “1” bit at a bit position corresponding to the current location of UE 115 at time T11. Accordingly, UE 115 may transition to or otherwise enter a coverage state for cell 2 via SV 102/202/302 at time T11.

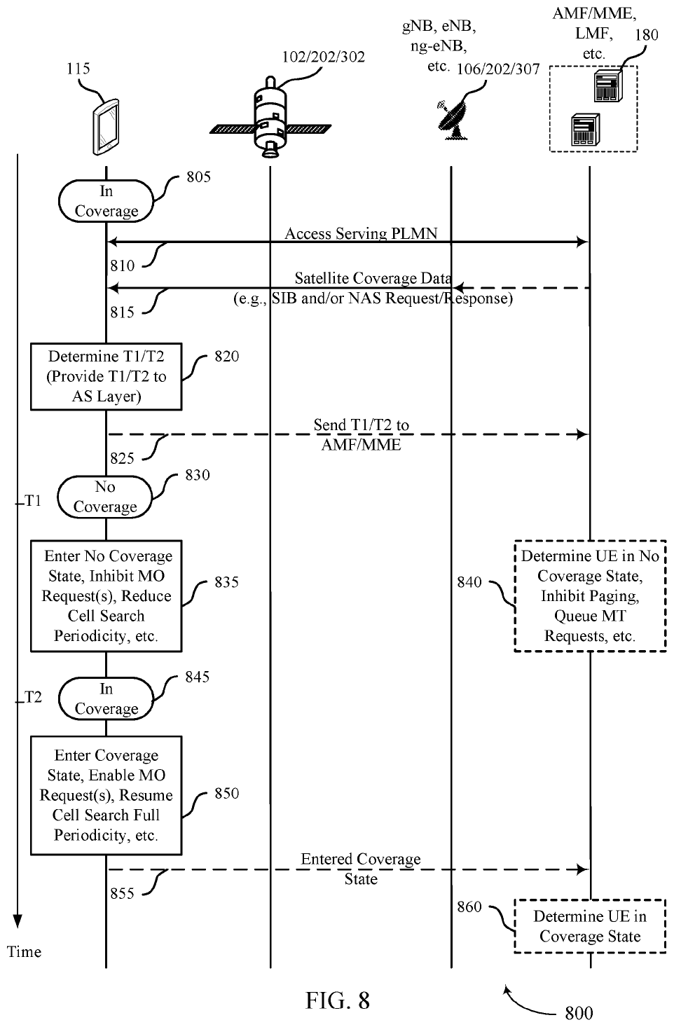

However, movement of SV 102/202/303 may result in the coverage area of cell 2 moving such that, at time T22, UE 115 is no longer within the coverage area of cell 2. UE 115, accessing the coverage map, may determine that its current location is out of coverage at time T22 by finding a “0” bit within the bit map for a bit position corresponding to the current location of UE 115 at time T22. Accordingly, at time T22, UE 115 may transition or otherwise enter a no coverage state. UE 115 may adopt various power saving and resource conservation techniques while operating in the no coverage state, as are described with reference to FIGS. 8-10 below.

At time T33, movement of another SV 102/202/302 may result in the current location of UE 115 being within the coverage area of cell 1. Again, a bit in the bit map corresponding to the current location of UE 115 at time T33 may be encoded as a “1” bit to again indicate that UE 115 has satellite coverage at time T33. Accordingly, UE 115 may transition to or otherwise enter a coverage state and resume communications via the other SV 102/202/302.

The total number of bits in a bit map may depend on the number of locations n and number of times m for which coverage data is provided. For example, for a PLMN with a 2000 by 2000 km coverage area, 24 hours of coverage data, 1 minute intervals between consecutive times, 20 km square grid point spacing, the coverage map may be encoded as a bit map containing (100×100×24×60) bits which equals 1.8 Megabytes (mega octets) of data without compression. However, it is likely that bits in the bit map corresponding to nearby locations and nearby times will typically have the same value (either a “1” or a “0”) due to coverage conditions typically being the same at nearby times and at nearby locations. This may allow compression of the bitmap using one dimensional, two dimensional or three dimensional compression techniques (e.g. a compression algorithm). For example, with a one dimensional technique, runs of consecutive zero or one bit values in the bit map can each be encoded as a different and typically shorter bit sequence that can be distinguished from any other bit sequence encoding (e.g. using the one-dimensional coding scheme defined in the ITU T.4 “Standardization of Group 3 facsimile terminals for document transmission” standard). This may significantly reduce the overall size of the bit map. For example, with a two dimensional technique, a bit map applicable to one time (e.g. T1) may be compressed using a one dimensional technique and then a bit map for a next time (e.g. T2) may be encoded by assigning a “0” bit value to any Location Lj whose coverage did not change since the previous time T1 and a “1” bit value to any location Lk whose coverage did change since the previous time T1. This bit map may then be compressed using the same (or a similar) one dimensional technique used for the bit map at time T1. Additionally or instead, a bit map may be provided to an entity (e.g. a UE 115) for just a single location (e.g. a current location of a UE 115) or for a small number of locations which may substantially reduce the size of the bit map. For example, a small number of locations might comprise: (i) locations nearby to a UE 115; (ii) locations which a UE 115 has recently visited; (iii) locations which a UE 115 habitually visits such as a work place, a home or the location of a friend or relative; (iv) locations which a UE 115 indicates as being of interest; or (v) some combination of these. For the previous example, if a bit map for just one location was provided, the uncompressed bit map size would be reduced to 180 bytes and if a bit map for an area 100×100 kms was provided, the uncompressed bit map size would be 4.5 Kbytes.

FIG. 7B illustrates an example of coverage maps represented by bit maps, where compression may be used, for a communication system 750, produced by one or more SVs 102, 202, 302 over an area overlaid with a square array of grid points. FIG. 7B may implement aspects of communication systems 100, 200, 300, 400, 500, 600 and/or 700. The grid point array in communication system 750 comprises 25 grid points (labelled L1, L2, L3, . . . L25) which are separated by distances D from one another (e.g. where D equals 10 to 50 kms) and arranged around a central grid point 752 (corresponding to location L13), which may correspond to a current or recent location of a UE 115. The grid point array may be used to provide a coverage map to UE 115 for a current or recent location of UE 115 (corresponding to the grid point 752) and for a small number of locations at grid points nearby to the current or recent location. FIG. 7B shows satellite coverage 760 for the grid point array at a time T1 and satellite coverage 770 for the same grid point array at a subsequent time T2 (e.g. where T2 may occur one minute or a few minutes after time T1). A grid point location which has satellite coverage is represented in FIG. 7B by a small solid black disk and a grid point location which does not have satellite coverage is represented in FIG. 7B by a small disk with a white interior. If a bit string is used to represent the coverage at the grid point locations at time T1 with a “1” bit value used to indicate coverage and a “0” bit value used to indicate no coverage, the bit string for the locations in the order L1, L2, L3 etc., would be “0000000011111000001100000”. This bit string contains 25 bits (for the 25 locations), where there are 8 consecutive “0” values, 5 consecutive “1” values, 5 consecutive “0” values, 2 consecutive “1” values and 5 consecutive “0” values. These may be compressed, for example, using the one-dimensional coding scheme defined in the ITU T.4 standard (and using white to represent “0” values and black to represent ‘1” values) as “10011”, “0011”, “1100”, “11” and “1100”, respectively. This allows the bit string to be compressed to “1001100111100111100” which now has 19 bits. A bit string representing the coverage 770 at time T2 can be created using a “0” bit value for any location whose coverage did not change at time T2 and a “1” bit value for any location whose coverage did change at time T2. In the example in FIG. 7B, coverage only changes at locations L17 and L18 at time T2. Hence a bit string showing the coverage 770 for time T2 would be “0000000000000000110000000”. This has 16 consecutive “0” values, 2 consecutive “1” values and 7 consecutive “0” values. These may be compressed, for example, using the ITU T.4 one-dimensional coding scheme as “101010”, “11”, and “1111” respectively. This allows the bit string to be compressed to “101010111111” which now has only 12 bits. Compression may be particularly efficient when a large area comprising many grid point locations is entirely in coverage or entirely not in coverage, and/or when coverage does not change from one time to the next, because there can then be a large number of consecutive bits with the same bit value, which can allow much higher compression than in the two examples above (e.g. using the ITU T.4 standard schemes or other schemes).

In another embodiment, satellite coverage data may be provided in the form of a “time sequence”, which may comprise a sequence of times or time periods indicating when satellite coverage begins and ends at a particular location. For example, a sequence of consecutive times t1, t2, t3, . . . tr may be provided indicating when satellite coverage may start or end at a certain location, where alternate times in the sequence alternately indicate the start or end of satellite coverage. For example, satellite coverage may be indicated to start at t1, end at t2, start again at t3, end again at t4 etc. There may be an implicit convention or an explicit indication that the first time in the sequence indicates a start (or end) of satellite coverage. In a variant of this embodiment, the consecutive times t1, t2, t3, . . . may be comprise time periods and not time instants. There may then also be an implicit starting time T (e.g. which may be a current time at which the consecutive times are received by an entity) or an explicitly provided starting time T. An entity can then determine that satellite coverage will start (or end) at time T+t1, end (or start) at time T+t1+t2, start again (or end again) at time T+t1+t2+t3 etc.

In some embodiments, a coverage map may be combined with a time sequence. For example, a coverage map (e.g. a bit map) may be provided to a UE 115 indicating locations with and without satellite coverage at a time T1. A second time T2 or a duration D2 may also be provided to the UE 115 indicating a time or duration for the coverage map. For example, provision of a time T2 may indicate that the satellite coverage indicated by the coverage map remains the same (for all locations in the coverage map) from time T1 to time T2. Similarly, provision of a duration D2 may indicate that the satellite coverage indicated by the coverage map remains the same for the duration D2, i.e. from time T1 to time T1+D2. In some embodiments, a coverage map and an extra time or duration (e.g. T2 or D2 in the previous example) may be provided when all locations in the coverage map either have satellite coverage or do not have satellite coverage.

Satellite coverage data, e.g. in the form of a coverage map and/or time sequence, can be provided to an AMF 112 and/or a gNB 106/202/307 (e.g. by an O&M server). The AMF 112 or gNB 106/202/307 may then filter, reformat or otherwise modify the satellite coverage data for easier and faster access (e.g. by a UE 115), which may reduce the overall satellite coverage data size (e.g. if the AMF 112 or gNB 106/202/307 removes data for certain locations and/or times in the satellite coverage data). The AMF 112 or gNB 106/202/307 may then provide the satellite coverage data to a UE 115—e.g. for just the current UE 115 location, for all locations nearby to the UE 115 or for an entire serving PLMN coverage area (e.g. as described above). For example, an AMF 122 can provide satellite coverage data to a UE 115 using a Non Access Stratum (NAS) message (e.g. when the UE 115 performs a NAS Registration with the AMF 122). A gNB 106/202/307 may also broadcast satellite coverage data (e.g. in one or more SIB messages) in each satellite cell to all UEs 115 with access to the satellite cell. The broadcast satellite coverage data may be restricted to providing coverage information for just locations within the current coverage area of the satellite cell or could, in one extreme variant, provide satellite coverage data for just a single location comprising the current coverage area of the satellite cell or a central location for this coverage area. Coverage information provided using this extreme variant may be approximate since not all locations within the current coverage area of the satellite cell would necessarily receive identical satellite coverage at future times. However, a convention could be then used whereby coverage is indicated as being available at any future time for the entire current coverage area of the satellite cell if at least part of this area (e.g. a central location) receives satellite coverage at the future time. A UE 115 which makes use of satellite coverage data for this extreme variant can then be aware that coverage may not always be available at its current location at a future time even when that current location is within the location area for which satellite coverage is indicated as being available at the future time.

As described above, a UE 115 can be configured with satellite coverage data, which may comprise one or more coverage maps (e.g. each comprising a bit map) and/or time sequences indicating satellite coverage availability for one or more locations and/or for one or more times. For example, an AMF 122 could send satellite coverage data to a UE 115 (e.g. in the form of a bit map or time sequence) for just a current UE 115 location, which might be based on a current serving fixed cell for the UE 115 or a current TA in which the UE 115 is located (e.g. as indicated to the AMF 122 by a serving gNB 106/202/307 for the UE 115). Alternatively, the UE 115 might send a request (e.g. a NAS Request message) to a serving AMF 122 indicating one or more locations and a time period for which the UE 115 requests satellite coverage data. The AMF 122 can then send satellite coverage data to the UE 115 (e.g. in a NAS Response message) for the indicated locations and time period. For example, the AMF 122 may determine the satellite coverage data based on more complete and comprehensive satellite coverage data (e.g. for an entire PLMN coverage area) which the AMF 122 receives from an O&M server or from a gNB 106/202/307. UE 115 may use the satellite coverage data, its current location, as well as a current time to determine when UE 115 will be in coverage and out of coverage of a satellite cell.

As discussed above, with limited satellite deployment (e.g., initially), there may be times at any given geographic location when no satellite coverage (e.g. no satellite cell) is available to a UE—which may be referred to as a “coverage gap.” For some UEs (e.g., Cellular IOT (CIoT)), the UE may transition to a dormant state during a coverage gap, and may not attempt to find a cell or initiate a mobile originated (MO) service such as the origination of a voice call or a data session or the sending of data or a text message. The network may similarly not attempt to initiate any mobile terminated (MT) service towards the UE when the UE is within a coverage gap, such as not attempting to initiate a voice call or data session to the UE from an external entity and not attempting to send data or a text message from an external entity (e.g. external client 140) to the UE. For a non-IOT UE, the user of the UE may want to minimize out of coverage periods by looking for and using other available terrestrial network (TN) cells or NTN cells for other PLMNs. In this situation, transitioning to a completely dormant state might not be suitable. Moreover, if a UE is moving, a coverage gap at an old location may become irrelevant at a new location where satellites (or satellite cells) are once again available. For MT services and for a moving UE, the network may be able to reach the UE at a new location (where satellites are available), so again transitioning to a completely dormant state (with respect to the UE) on the network side may also be unsuitable. Accordingly, aspects of the techniques described herein provide various solutions to address all of these possibilities.

In certain embodiments, an operation and maintenance (O&M) manager or server (e.g., belonging to a PLMN) may pre-configure and transfer to other entities (e.g. gNBs 106/202/307 and/or AMFs 122) satellite coverage data showing times of NTN coverage and lack of coverage (e.g., times of no NTN coverage) at different locations in a PLMN coverage area. The satellite coverage data may be as described for FIGS. 7A and 7B.

In one embodiment, a gNB 106/202/307 that receives satellite coverage data from an O&M server or that calculates satellite coverage data from other data received from an O&M server (e.g. satellite orbital or ephemeris data and data on satellite cells) may broadcast satellite coverage data in each cell for locations in that cell as discussed for FIGS. 7A and 7B. A UE 115 Access Stratum (AS) layer may then determine periods of satellite unavailability at the UE 115 location based on the broadcast satellite coverage data that is received. The AS layer may report a no cell available state to a NAS layer in the UE 115 during satellite unavailability (e.g., during a no coverage state). The NAS layer may then change a NAS state for the UE 115 to indicate wireless coverage is not available (e.g., may enter a NAS 5GMM-REGISTERED.NO-CELL-AVAILABLE state), which may also be supported for terrestrial wireless access when UE 115 loses wireless coverage. The AS layer may reduce or cease cell search (e.g., reduce a frequency of satellite cell searching or stop cell searching) during a no coverage period/state. The AS layer can be optionally configured to search for an NTN or TN cell periodically before the next satellite cell available time to allow for possible UE 115 movement to a new location.

In some other embodiments, a UE 115 NAS layer may obtain and/or otherwise determine a time/timer T1 when satellite coverage at the UE 115 location will cease (e.g., during a no coverage state) and a time/timer T2 when satellite coverage will resume (e.g., during a coverage state). For example, the network (e.g. a serving AMF 122) may provide satellite coverage data to the UE 115 during a UE Registration and/or in other NAS responses if requested by the UE 115, and the UE 115 may then calculate T1 and T2. In another example, the network (e.g. a serving AMF 122) may determine and then provide the values of T1 and T2 to the UE 115 during UE 115 Registration and/or in other NAS responses. In a further example, a serving gNB 106/202/307 may broadcast satellite coverage data or the values of T1 and T2 in a SIB in a satellite cell. The satellite coverage data or the values of T1 and T2 that are broadcast may then be received by the UE 115 AS layer and provided by the UE 115 AS layer to the UE 115 NAS layer, e.g. when, or soon after, the satellite cell is acquired (e.g., during the coverage state). The UE 115 NAS layer can provide the values of T1 and T2 to applications and/or to a user of UE 115 to indicate a future loss and a later resumption of satellite coverage. At time T1 (e.g., at expiration of a timer for T1 and at the onset of the no coverage state), the NAS layer may enter a no coverage state (e.g., a 5GMM-REGISTERED.NO-COVERAGE state), may deactivate the AS Layer, and may start a timer that will expire at the time T2. At the time T2 (e.g. at expiration of a timer for T2 which may occur at the resumption of a coverage state), the NAS layer may reactivate the AS layer. In some embodiments, a network side NAS layer (e.g. a NAS layer in a serving AMF 122) may also enter a no coverage state with respect to UE 115 at the time T1 and may inhibit mobile terminated (MT) activity for the UE 115 until the time T2.

FIG. 8 illustrates an example of a process 800 that supports coverage gaps for satellite access in accordance with aspects of the present disclosure. Aspects of process 800 may be implemented by or implemented at communication systems 100, 200, 300, 400, 500, 600, and/or 700. Aspects of process 800 may be implemented by or implemented at UE 115, SV 102/202/302, gNB 106/202/307, NTN Gateway104, and/or entity 180, which may be examples of the corresponding devices described herein. For example, entity 180 may include or comprise one or more entities within a core network (e.g. a 5GCN 110), such as an AMF 122, LMF 124 or an MME. FIG. 8 shows a gNB 106/202/307 that is separate from an SV 102/202/302, but as described above, a gNB 202 would be included as part of an SV 202 and a gNB 307 (e.g. a gNB-CU 307) would communicate with a gNB-DU 302 that is part of an SV 302. In addition, the gNB 106/202/307 shown in FIG. 8 could instead be an ng-eNB or eNB as described previously. An NTN Gateway 104 may also be present for process 800 (e.g. as described for communication systems 100, 200, 300), though is not shown in FIG. 8.

Process 800 may start at 805, where UE 115 is in satellite coverage for a serving PLMN. For example, UE 115 may be located inside the coverage area of at least one satellite cell supported by the SV 102/202/302, as described previously. Note that references to a serving PLMN herein may correspond in some cases to a private wireless network (not a public wireless network) and/or to a network that provides Internet access and/or other satellite services.

At 810, UE 115 may transmit signals to, receive signals from and/or otherwise access the serving PLMN (e.g., entity 180) via a communication satellite (e.g., the SV 102/202/302 and an NTN Gateway 104). Accordingly, UE 115 may establish a connection, or may already have a connection, with the serving PLMN at 810 (e.g. with entity 180) for performing wireless communications via the SV 102/202/302. For example, UE 115 may perform an initial Registration procedure with the serving PLMN at 810 (e.g., with entity 180) via the SV 102/202/302, an NTN Gateway 104 and the gNB 106/202/307.

At 815, entity 180 may send, transmit, or otherwise provide satellite coverage data to UE 115 via gNB 106/202/307, NTN Gateway 104 and SV 102/202/302. Entity 180 may identify, obtain, or otherwise determine the satellite coverage data based on a current location of UE 115 and/or receive the satellite coverage data from an operations and maintenance server (e.g., within the core network). A current location of UE 115 may correspond to a current geodetic location of UE 115, a current coverage area of a serving satellite cell for UE 115, an area of a current fixed cell for UE 115 or an area of a current fixed tracking area for UE 115.

Entity 180 may send the satellite coverage data to UE 115 at 815 in a NAS message (e.g. a NAS Registration Accept message or a NAS Service Accept message if entity 180 is an AMF 122, or a NAS Service Accept, NAS Tracking Area Update Accept or NAS Attach Accept if entity 180 is an MME). The satellite coverage data may include a coverage map (e.g. a bit map) and/or a time sequence as described for FIGS. 7A and 7B. The satellite coverage data may provide coverage data for a current location of UE 115 (e.g. as indicated by a current fixed cell or current fixed TA in which UE 115 is currently located), for locations requested by UE 115 (e.g. at 810) and/or for previous locations of UE 115, as described for FIGS. 7A and 7B. In other examples, the satellite coverage data may be sent to UE 115 at 815 by a base station (e.g., by the gNB 106/202/307) broadcasting the satellite coverage data in a broadcast/multicast message (e.g., SIB message(s)) via SV 102/202/302.

In some examples, the satellite coverage data sent at 815 may be for multiple times and for the current location of UE 115 (e.g., may comprise an indication of times or time periods when, at the present location of UE 115, there will and will not be satellite cell availability). In some examples, the satellite coverage data may include indications of multiple locations and multiple times. For example, the satellite coverage data may identify a larger coverage area or a complete coverage area of the serving PLMN. The satellite coverage data may identify, for each included location, the times or time periods when there will and will not be satellite cell availability at this location. For example, the multiple locations may correspond to locations for an array of grid points or an array of areas. The satellite cell availability for the multiple locations for each time of the multiple times may be encoded as an array of Boolean values or as an array of bit values (e.g., 1s and 0s within a bit map). Each Boolean value or bit value in the array (e.g., each bit in the bit map) may correspond to one grid point location in the array of grid points or array of areas and indicate whether or not there is satellite cell availability at the grid point location and at each time. In one example, a set of bit maps may be provided, where each bit map in the set of bit maps indicates satellite availability for the multiple locations at just one time in the multiple times (e.g. where there is one bit in each bit map for each location in the multiple locations). A compression algorithm may also be used to reduce the size of the bit map or set of bit maps.

At 820, the UE 115 (e.g. an AS or NAS layer of UE 115) may identify or otherwise determine a first time T1 when satellite cell coverage will become unavailable for a current location of the UE 115 and a second time T2 when satellite cell coverage will become available again for the current location of the UE 115. That is, the first time T1 may include the earliest time at or after a current time when satellite coverage for the serving PLMN is/becomes unavailable at the current location of UE 115. The second time T2 may include the earliest time after the first time when satellite coverage for the serving PLMN becomes available at the current location of UE 115. Accordingly, the first time T1 may correspond to a time when UE 115 is in or enters a no coverage state and the second time T2 may correspond to a time when UE 115 is in or enters a coverage state. UE 115 may then enter the no coverage state when satellite access is lost at or after the first time.

It is to be understood that a no coverage state and a coverage state may each correspond to an explicit state, or set of states, in the UE 115 such as a NAS state (or set of NAS states) or an AS state (or set of AS states). However, in some embodiments, the coverage state may not correspond to an explicit state (e.g. an explicit NAS state or AS state) and may instead correspond to the running of a timer in UE 115 (e.g. a running timer set to expire at the time T1) or to the absence of the running of a timer (e.g. absence of a running timer set to expire at the time T2). Similarly, the no coverage state may not correspond to an explicit state and may instead correspond to the running of a timer in UE 115 (e.g. a timer that starts at the time T1 and expires, or is set to expire, at the time T2) or to the absence of the running of a certain timer (e.g. absence of a running timer set to expire at the time T1). It is also to be understood that a no coverage state and a coverage state, as referred to herein and without any extra qualification, refer to no satellite coverage and satellite coverage, respectively, for a UE 115 from a serving PLMN. Other types of coverage and no coverage states may also exist and are described later herein

In some embodiments, the entity 180 may determine the times T1 and T2 (e.g. based on satellite coverage data available to the entity 180) and may send the values of time T1 (e.g., the first time) and time T2 (e.g., the second time) to UE 115 as part of the satellite coverage data at 815 (e.g. in a NAS Registration Accept message or in a NAS Service Accept message if entity 180 is an AMF 122, or a NAS Service Accept, NAS Tracking Area Update Accept or NAS Attach Accept if entity 180 is an MME). Similarly, a gNB 106/202/307 may determine the times T1 and T2 (e.g. based on satellite coverage data available to the gNB 106/202/307) and may broadcast the values of time T1 and time T2 to UE 115 as part of the satellite coverage data in a SIB message at 815. In these embodiments, UE 115 may determine the times T1 and T2 at 820 based on times T1 and T2 received at 815.

Accordingly, at 820, UE 115 (e.g. an AS or NAS layer of UE 815) may identify or otherwise determine the first time (e.g., T1, when satellite access is unavailable) and the second time (e.g., T2, when satellite access is available) for the location of UE 115. In some aspects, the satellite coverage data may be received at 815 at a NAS layer of UE 115 (e.g., in NAS signaling sent by entity 180) and the NAS layer may provide an indication of the satellite coverage data or T1/T2 to the AS layer of UE 115. In some other aspects, the satellite coverage data may be received at 815 at an AS layer of UE 115 (e.g., in SIB broadcast messages sent by gNB 106/202/307) and the AS layer may provide the satellite coverage data or an indication of T1/T2 to the NAS layer of UE 115. In some examples, the UE 115 (e.g. the NAS and/or AS layer of UE 115) may initiate timer(s) corresponding to the first and second times (T1 and T2). For example, the UE 115 (e.g. the NAS and/or AS layer of UE 115) may start a timer (e.g. after determining or receiving the times T1 and T2) to expire at the time T1 and may start another timer (e.g. at the time T1) to expire at the time T2.

At 825, UE 115 may optionally transmit or otherwise provide an indication of the determined T1/T2 values to the entity 180. For example, UE 115 may transmit the indication in one or more NAS layer messages to entity 180 via SV 102/202/302 and gNB 106/202/307. The NAS layer message may comprise a NAS Registration Request when entity 180 is an AMF 122 or a NAS Attach Request or NAS Tracking Area Update Request when entity 180 is an MME. For example, 825 may be performed when, the values of T1 and T2 are determined by UE 115 but not by entity 180.

830 generally corresponds to the occurrence of the first time (T1)—e.g. an expiration of a timer at time T1. At or near to time T1, the UE 115 may cease to have satellite coverage for the serving PLMN.

Accordingly, at 835 which may occur at or just after the time T1, UE 115 may implement an event (e.g. a NAS layer event or an AS layer event) where UE 115 enters a no coverage state and reduces power consumption based on satellite cell availability being unavailable at the location of UE 115. An entry trigger into the no coverage state may be based on an occurrence of time T1 (e.g. a timer expiration at time T1) and/or a loss of satellite coverage (e.g. at the AS layer of UE 115) at or following time T1 (e.g., based on the AS layer of UE 115 detecting a loss of wireless signal reception from SV 102/202/302 or a radio link failure (RLF) for the link with SV 102/202/302). For example, UE 115 may wait for the time T1 to occur (e.g. as detected via a timer expiry) and may then continue to access the serving PLMN so long as satellite access remains available to permit this and may enter the no coverage state after satellite access is lost (e.g. as detected at the AS layer via a signal loss or RLF event). UE 115 may enter the no coverage state at the first time (e.g., at or following time T1) and take various actions while in the no coverage state to reduce power consumption, conserve resources, and the like.

For example, as part of 835, UE 115 may inhibit MO request(s) in UE 115 while operating in the no coverage state. That is, UE 115 (e.g. a NAS layer in UE 115) may reject or queue higher layer MO requests and may optionally return a response with a cause indication and possibly the value of time T2 to a requesting higher layer application, when operating in the no coverage state. Accordingly, UE 115 may reject requests by applications in the UE (e.g., higher layer applications of UE 115) to send text and/or data, to establish video/voice calls, to establish sessions to entities outside of UE 115 such as external client 140, and the like. In this situation, the response rejecting the request may carry or otherwise include a cause (e.g., indicating a no coverage state due to satellite cell unavailability) as well as an indication of the second time T2 (e.g., when UE 115 expects to re-enter the coverage state).

In some examples, while in the no coverage state at 835, UE 115 may reduce a frequency of satellite cell searching (e.g., concerning how often cell searching occurs) from a first frequency while in the coverage state to a second frequency while in the no coverage state. That is, the second frequency may include fewer satellite cell searches (e.g. cell searches less often) performed by UE 115. In one example, the second frequency may be zero (i.e. no cell searching). This may include, but is not limited to, UE 115 deactivating support for one or more satellite RAT(s) by/at the AS layer of UE 115, deactivating support for all satellite RATs by/at the AS layer of UE 115, and/or deactivating support for some or all terrestrial RATs by/at the AS layer of UE 115. Other examples may include UE 115 (re)configuring a cell search scan for satellite RAT(s) and/or terrestrial RAT(s) by/at the AS layer of UE 115. The (re)configured cell search scan may include a shorter duration of cell scanning (e.g., cell scanning for shorter periods of time) and/or a longer interval between successive cell scans (e.g., cell scanning less often) than when UE 115 is operating in the coverage state. Another example, while in the no coverage state, includes the NAS layer or AS layer of UE 115 periodically (e.g. at 5 to 30 minute intervals) (re)activating support for some period (e.g. 5 seconds to 1 minute) for satellite RAT(s) and/or terrestrial RAT(s) followed by deactivating the support. This example may support UE 115 reacquiring satellite cell or TN cell availability due to UE 115 movement to a new location where satellite cell or TN cell coverage is available. On entering the no coverage state at 835, UE 115 (e.g. the AS or NAS layer of UE 115) may start a timer associated with the time T2—e.g. such that the timer will expire at time T2.

At 840, the entity 180 in the serving PLMN (e.g., the AMF 122 or an MME) may optionally also adopt various mechanisms to conserve power/resources while UE 115 is operating in the no coverage state. The entity 180 may determine that the UE 115 is in the no coverage state when time T1 occurs (e.g. when a timer in entity 180 associated with time T1 has expired). For example, entity 180 can determine time T1, which can be the same time T1 determined by UE 115, if entity 180 has sent time T1 to the UE 115 at 815 (e.g. in a NAS message), has received time T1 from UE 115 at 825 (e.g. in a NAS message), or has determined time T1 from satellite coverage data (e.g. the same satellite coverage data sent to UE 115 at 815) in the same way that UE 115 determines time T1 at 820. Entity 180 (e.g. a NAS layer in entity 180) may then assume that UE 115 is in the no coverage state following time T1 (e.g. if UE 115 does not have a signaling connection to entity 180 at time T1). Optionally, if UE 115 has a signaling connection to entity 180 at time T1, entity 180 may, following time T1, wait for an indication (e.g. an NGAP message sent by the gNB 106/202/307 to entity 180) that UE 115 is no longer connected to entity 180 and is in an Idle state, after which entity 180 may assume that UE 115 has entered a no coverage state. The entity 180 may implement its own no coverage state (e.g. a NAS no coverage state) with respect to UE 115 while no coverage is assumed for UE 115. Alternatively, entity 180 may determine UE 115 to be in a no coverage state based at least in part on the UE 115 already being in an Idle state following the time T1.

For example, during the no coverage state at 840 or during the no coverage state assumed for UE 115 at 840, the entity 180 may inhibit paging (e.g., disable paging of UE 115) and/or queue MT text/data and MT call and session requests destined for UE 115. Entity 180 may continue to inhibit paging and/or queue MT text/data for UE 115 until the time T2 and/or until an indication is received that UE 115 is no longer in the no coverage state as discussed further down. When entering or determining the no coverage state, entity 180 may also start a timer to expire at the time T2. Entity 180 can determine time T2 in the same way as described above for determining time T1, and with time T2 the same as the time T2 determined by UE 115 at 820. For example, entity 180 may have sent time T2 to the UE 115 at 815, may have received time T2 from UE 115 at 825, or may have determined time T2 from satellite coverage data in the same way that UE 115 determines time T2 at 820.

845 generally corresponds to the occurrence of time T2 at UE 115 (e.g. expiration of a timer for time T2 in the UE 115). At time T2, and at 845, UE 115 (e.g. an AS or NAS layer in UE 115) may determine that an exit trigger with respect to the no coverage state has occurred. The exit trigger may correspond to the occurrence of time T2 in this example (e.g. expiration of a timer in UE 115 associated with time T2).

Based on the exit trigger determined at 845, and at 850 which may occur at or following time T2, UE 115 may leave the no coverage state and enter a coverage state (e.g. a NAS or AS coverage state), reactivate the AS layer for some or all NTN and/or TN RAT(s) (e.g., if deactivated), resume cell searching for the reactivated NTN and/or TN RATs at a normal frequency (e.g. more often than when in the no coverage state), and/or re-enable MO requests from applications in UE 115.

After UE 115 finds an available satellite cell or TN cell, UE 115 may optionally at 855 send an indication to entity 180 that UE 115 is now in coverage. For example, UE 115 may perform a NAS Registration update if entity 180 is an AMF 122 (e.g. UE 115 may send a NAS Registration Request to entity 180) or a NAS Tracking Area Update if entity 180 is an MME (e.g. UE 115 may send a NAS Tracking Area Update Request to entity 180) in order to inform entity 180 that UE is now in coverage of a satellite cell or TN cell.

In the example where entity 180 of the serving PLMN has entered a no coverage state for UE 115 at 840, an exit trigger at entity 180 may correspond to the occurrence of the time T2 at entity 180 (e.g. expiration of a timer in entity 180 at time T2) and/or receipt of a NAS message from UE 115 (e.g. as at 855) indicating that UE 115 is now in coverage. Based on the exit trigger at entity 180, and at 860, the entity 180 may determine that UE 115 has entered the coverage state. Accordingly, the entity 180 may, at 860, re-enable paging for UE 115, and re-enable queued MT requests for UE 115. The queued MT requests for example, may be sent by entity 180 to UE 115 either following receipt of the NAS message received at 855 if 855 occurs, or following paging of UE 115 by entity 180 and after a response is received by entity 180 from UE 115 for the paging.

In some situations, UE 115 may operate in a power saving mode (which may also be referred to as a power savings state) for reasons independent of satellite coverage availability and unavailability. For example, a UE 115 that is an IOT or CIoT UE may be configured to communicate with external entities (e.g. a controller or server for UE 115) only at certain times and to otherwise remain dormant and not accessing a serving PLMN. In these situations, UE 115 may indicate to a serving PLMN (e.g. to the entity 180 in FIG. 8) that UE 115 will enter a power saving mode at some future or current time t1 and exit from the power saving mode at a later time t2. UE 115 may enter the power saving mode at time t1 and exit the power saving mode at the later time t2. While in the power saving mode, UE 115 may not attempt to receive any signaling from or send any signaling to the serving PLMN (e.g. gNB 106/202/307 or entity 180 in FIG. 8). For example, while UE 115 is in the power saving mode, the UE 115 may be in a NAS Idle state and with an AS layer deactivated.

To simplify support of satellite coverage and no coverage states, UE 115 may not perform the actions described above for process 800 for 820, 835 and 850 while in the power saving mode described above. Thus, for example, UE 115 may not determine times T1 and T2 for loss of satellite coverage and reacquisition of satellite coverage for 820, may not enter the no coverage state for 835 and may not re-enter the coverage state for 850. The UE 115 may later leave the power saving mode, e.g. at time t2. In certain scenarios, while UE is in a power saving mode, an application or other source within UE 180 may attempt to start an MO service (e.g. may request a NAS layer or other layer in UE 115 to send data, send a text message or to originate a voice call or data session). When such an MO request occurs, UE 115 may also leave the power saving mode which may now occur before time t2.

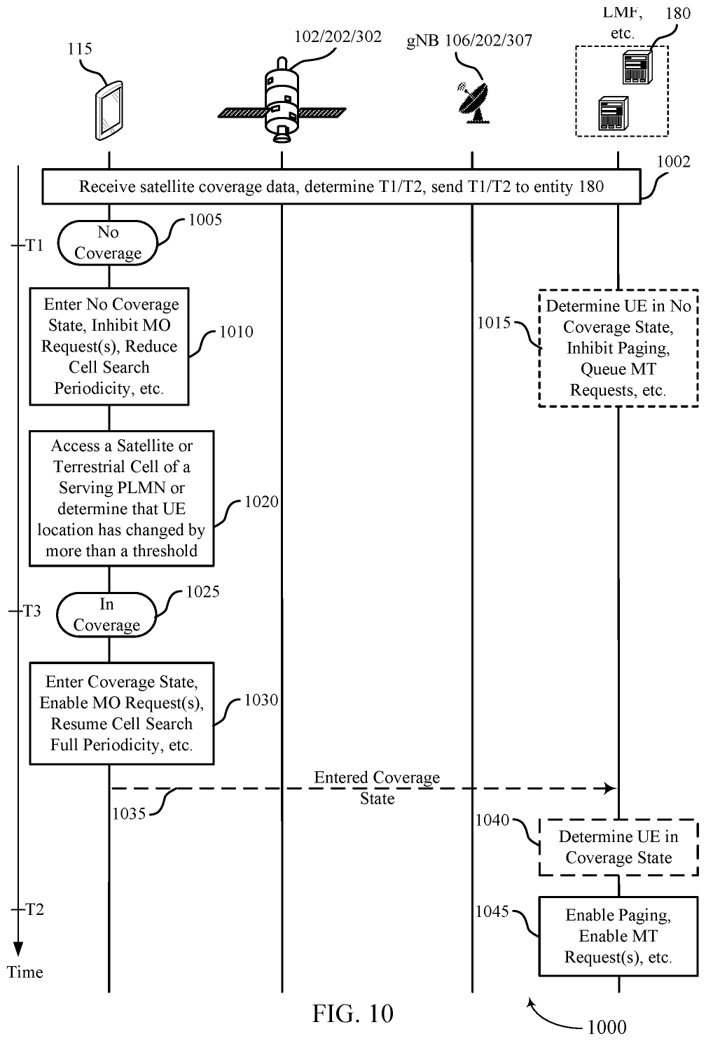

When UE 115 leaves the power saving mode (e.g. at time t2 or following an MO request in UE 115 as described above), UE 115 may normally (e.g. when there is satellite or TN coverage) find and access a satellite cell or TN cell, access the serving PLMN and possibly send an indication (e.g. a NAS message) to the serving PLMN to indicate that UE 115 is no longer in the power saving mode. However, different to this normal operation of a power saving mode, when UE 115 supports satellite coverage and no coverage states, when UE 115 leaves the power saving mode, UE 115 may instead determine whether UE 115 is in or is not in satellite coverage. This determination may be based on previous values for times T1 and T2 determined by UE 115 as at 820 before UE entered the power saving mode. For example, if a current time is earlier than time T1, then UE 115 may assume that satellite coverage is available, whereas if the current time is after time T1 and before time T2, UE 115 may assume that satellite coverage is not available and may enter the no coverage state, e.g. as described for 835. If UE 115 did not previously determine times T1 and T2, or if times T1 and T2 were determined by UE 115 but the current time is after time T2, or if a current location of UE 115 is or may be different than a current location of UE 115 when times T1 and T2 were determined, then UE 115 may determine whether UE 115 is in or not in satellite coverage based on any satellite coverage data available to UE 115 and a current location of UE 115 (e.g. obtained using GNSS). If UE 115 determines that UE 115 is in or may be in satellite coverage then UE 115 may perform the normal actions for leaving the power saving mode as described above (e.g. UE 115 may attempt to find and access a satellite cell or TN cell, access the serving PLMN and possibly send an indication to the serving PLMN to indicate that UE 115 is no longer in the power saving mode). Otherwise, if UE 115 determines that UE 115 is not in satellite coverage, then UE 115 may determine a time T2 when UE 115 will next regain satellite coverage (or may use a previously determined time T2) and may perform the actions described above for 835 to enter the no coverage state, deactivate the AS layer, reduce a frequency of cell searching, inhibit MO requests etc., until the time T2 occurs or until satellite or TN coverage is reobtained (e.g. as described later for FIG. 10). Since UE 115 would already have deactivated the AS later and inhibited MO requests when entering the power saving mode, the actions of UE 115 when determining no coverage after leaving the power saving mode may be less than described for 835, since the UE 115 may not need to again deactivate the AS layer or start to inhibit MO requests etc.

The entity 180 may perform similar actions to those described above for UE 115 when aware that UE 115 is in a power saving mode. For example, when UE 115 would normally be expected to leave a power saving mode at the time t2, the entity 180 may determine whether UE 115 is likely to be in or not in satellite coverage. If the UE 115 is likely to be in satellite coverage (e.g. based on a time T1 not yet having occurred or based on satellite coverage data for UE 115 indicating that, at a current time, there is satellite coverage at a last known location of UE 115), then entity 180 may follow normal procedures for power saving mode and either assume that UE 115 is no longer in the power saving mode or wait to receive an indication from UE 115 (e.g. a NAS message from UE 115) indicating that UE 115 is no longer in the power saving mode. If entity 180 determines that the UE 115 is likely to be not in satellite coverage (e.g. based on a time T1 having occurred but a time T2 not yet having occurred or based on satellite coverage data for UE 115 indicating that, at a current time, there is no satellite coverage at a last known location of UE 115), then entity 180 may perform the actions described for 840 to place UE 115 in a no coverage state, inhibit paging of UE 115 and queue MT requests—until a time T2 occurs or an indication is received from UE 115 indicating UE 115 now has coverage.

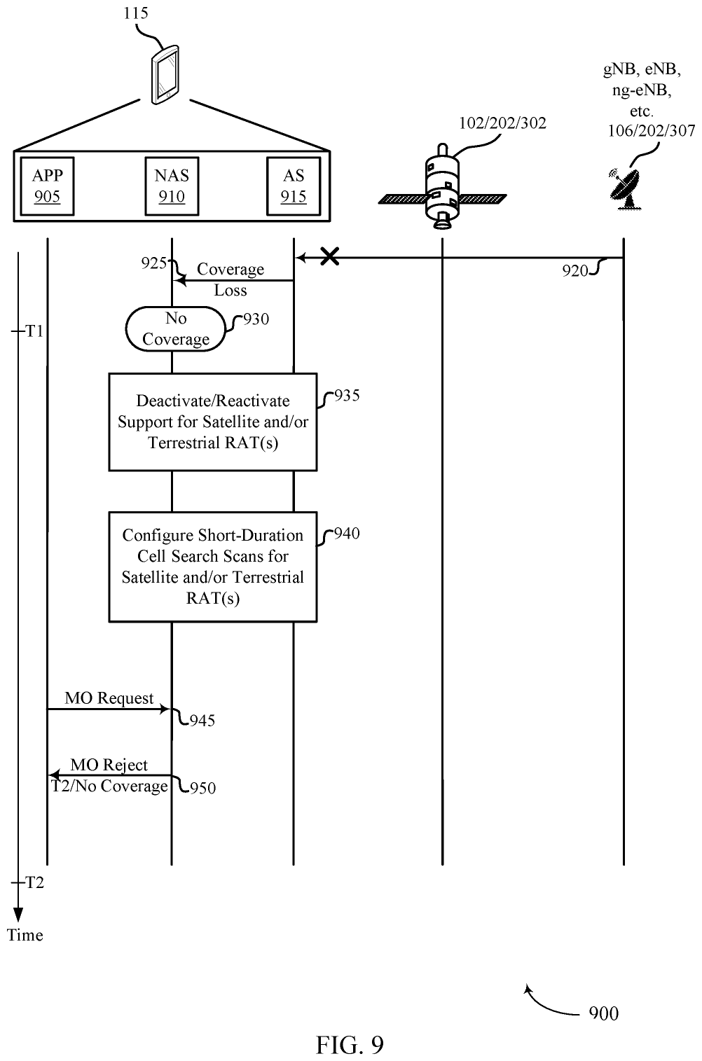

FIG. 9 illustrates an example of a process 900 that supports coverage gaps for satellite access in accordance with aspects of the present disclosure. Aspects of process 900 may be implemented by or implemented at communication systems 100, 200, 300, 400, 500, 600, and/or 700 and/or process 800. Aspects of process 900 may be implemented by or implemented at UE 115, SV 102/202/302, and/or gNB 106/202/307, which may be examples of the corresponding devices described herein. UE 115 may include an application layer 905, a NAS layer 910, and an AS layer 915, which may be examples of the corresponding layers described herein. Process 900 provides more details that can be applicable to process 800 described previously.

As discussed above, aspects described herein may include techniques for providing common support of no coverage areas of communication satellite(s) (such as SV 102/202/302). For example, UE 115 may generally access a serving PLMN via a communication satellite (e.g. SV 102/202/302) and receive satellite coverage data from an entity via the SV 102/202/302. This may include an O&M server (e.g., of the serving PLMN) pre-configuring and providing to the entity in the serving PLMN a map (e.g., satellite coverage data) showing times of NTN coverage and lack of coverage (e.g., times of no NTN coverage) at different locations. The map (e.g., the satellite coverage data) can be provided to an AMF 122, an MME, a gNB 106/202/307, an ng-eNB 114 or an eNB (which may be examples of the entity within the serving PLMN in this example). The entity (e.g. AMF 122, MME or gNB 106/202/307) may filter, reformat or otherwise modify the satellite coverage data for easier and faster access by a UE 115. For example, the entity may obtain the current location of the UE 115 and filter the satellite coverage data to apply just to the current location of the UE 115 or to the current UE 115 location and to locations nearby to the current location (e.g. locations within 100 kms of the current UE 115 location). The entity may then provide the NTN coverage data to the UE 115 (e.g. via broadcast from a gNB 106/202/307 or in a NAS message from an AMF 122 or MME). A gNB 106/202/307 may also broadcast in each cell satellite coverage data for just locations in that cell or for just one location in that cell.

Accordingly, the UE 115 may identify or otherwise determine times T1 and T2 based on a current location of UE 115 and enter a no coverage state at or following the time T1, as described above for process 800. This is illustrated at 920 in FIG. 9 where the AS layer 915 of UE 115 identifies or otherwise determines that UE 115 is no longer within coverage of SV 102/202/302. For example, the AS layer 915 may not receive signals from SV 102/202/302 for more than some threshold time period (e.g. 2 to 10 seconds) and may then declare a RLF event. At 925, the AS layer 915 may transmit or otherwise provide an indication of the coverage loss (e.g. an RLF event) to the NAS layer 910 of UE 115. This indication may indicate the time T1 and/or time T2 (e.g. if the AS layer 915 has determined the times T1 and T2), and/or may provide explicit and/or implicit information indicating that UE 115 is in or has entered a no coverage state following time T1.

In some examples, the AS layer 915 may determine periods of NTN unavailability at the UE 115 location based on satellite coverage data broadcast by gNB 106/202/305 and received by the AS layer 915. In some other examples, the AS layer 915 may determine periods of NTN unavailability at the UE 115 location based on satellite coverage data provided to the AS layer 915 by another layer (e.g. by the NAS layer 910). The AS layer 915 may then determine the times T1 and T2 based on the satellite coverage data and report no cell available and/or no coverage to the NAS layer 910 when signals from SV 102/202/302 are no longer received just before, at or just after the time T1. The AS layer 915 may also provide the times T1 and/or T2 to the NAS layer 910 if the times T1 and T2 are determined by the AS layer 915.

At 930, based on the indication received at 925 and/or based on detecting the occurrence of the time T1 (e.g. a timer expiration for time T1), the NAS layer 910 of UE 115 may enter or otherwise declare a no coverage state. For example, the NAS layer 910 may enter a NAS no cell available state (e.g., 5GMM-REGISTERED.NO-CELL-AVAILABLE) or a NAS no coverage state (e.g., 5GMM-REGISTERED.NO-COVERAGE).

At 935, the NAS layer 910 or AS layer 915 may cease or reduce a cell search (e.g., may reduce a frequency of satellite cell searching) during the no coverage period/state. For example, the NAS layer 910 may transmit or otherwise provide an indication to the AS layer 915 to deactivate support for (or reduce a frequency for) NTN and/or TN RAT cell searches. Alternatively, the AS layer 915 may itself (e.g., autonomously) determine to deactivate support for (or reduce a frequency of) NTN and/or TN RAT cell searches. This may prevent (or slow down) the AS layer 915 performing cell searches (e.g., monitoring) for NTN and/or TN RATs while the UE 115 is in the no coverage state, which may reduce processing and battery usage of UE 115. In some examples, at 940, the NAS layer 910 (or AS layer 915) can be optionally configured to search for an NTN and/or TN cell periodically (e.g. by the NAS layer 910 requesting an NTN and/or TN cell search by the AS layer 915 for periodic short periods) before the next NTN cell available time (e.g. the time T2) to allow for possible UE 115 movement to a new location.

At 945, the NAS layer 910 may receive or otherwise obtain an indication from the application layer 905 for an MO service. For example, the application layer 905 may provide the MO request to the NAS layer requesting the sending of data or a text message via the serving PLMN to some external entity (e.g. external client 140 in communication systems 100, 200 and 300). In response, at 950, the NAS layer 910 may transmit or otherwise provide an indication to the application layer 905 rejecting the MO request. For example, the NAS layer 910 may generally deny the MO request while operating in the no coverage state. In some examples, the MO reject indication may also carry or otherwise convey an indication that UE 115 is in a no coverage state, and may include an indication of the time T2 (e.g. the value of T2).

FIG. 10 illustrates an example of a process 1000 that supports coverage gaps for satellite access in accordance with aspects of the present disclosure. Aspects of process 1000 may be implemented by or implemented at communication systems 100, 200, 300, 400, 500, 600, and/or 700 and/or processes 800 and/or 900. Aspects of process 1000 may be implemented by or implemented at UE 115, SV 102/202/302, gNB 106/202/307, and/or entity 180, which may be examples of the corresponding devices described herein. For example, entity 180 may include one or more entities within a core network, such as an AMF 122 or an MME. Process 1000 is similar to process 800 as described previously, but includes scenarios where a UE 115 leaves a no coverage state before the time T2 when satellite coverage is expected to resume for the UE 115.

As discussed above, aspects described herein may include techniques for providing common support of no coverage areas of communication satellite(s) (such as an SV 102/202/302).

This may include an O&M server (e.g., of a PLMN) pre-configuring and signaling a map (e.g., satellite coverage data) showing times of NTN coverage and lack of coverage (e.g., times of no NTN coverage) at different locations. The map (e.g., the satellite coverage data) can be provided to an AMF 122, an MME, a gNB 106/202/307, an ng-eNB 114 or an eNB. The AMF 122, MME or gNB 106/202/307 may filter, reformat or otherwise modify the map for easier and faster access by a UE 115. The AMF 122, MME or gNB 106/202/307 may obtain or otherwise determine the current UE 115 location (e.g. based on a current fixed cell or fixed TA for the UE 115) and may provide the satellite coverage data to the UE 115 for the current UE 115 location and possibly for other locations nearby to this. A gNB 106/202/307 may also broadcast in each cell restricted NTN coverage data for a location or for multiple locations in that cell.

UE 115, at 1002, may access the serving PLMN as described for 810 in process 800, may receive satellite coverage data and/or the times T1 and T2 sent by entity 180 or gNB 106/202/307 as described for 815 in process 800, may identify or otherwise determine a first time T1 when satellite cell coverage will become unavailable for the current location of the UE 115 and a second time T2 when satellite cell coverage will become available again for the current location of the UE 115 as at 820 in process 800, and may optionally provide an indication of the determined T1/T2 values to the entity 180 as for 825 for process 800. 1002 may correspond to one or more of, or all of, 810, 815, 820 and 825 in process 800.

At 1005, which may occur at or near to the time T1, the UE 115 may cease to have satellite coverage for the serving PLMN as at 830 for process 800.

At 1010, the UE 115 enters a no coverage state, reduces power consumption based on satellite cell coverage being unavailable at the location of UE 115, inhibits MO requests and deactivates an AS layer, and/or reduces a frequency of cell searching for satellites RATs by an AS layer, as described for 835 in process 800. For example 1010 in process 1000 may correspond to 835 for process 800.

At 1015, the entity 180 in the serving PLMN (e.g., the AMF 122 or an MME) may determine that UE 115 has entered a no coverage state at or near to time T1 and may inhibit paging of UE 115 and queue MT requests for UE 115 as at 840 in process 800. For example 1015 in process 1000 may correspond to 840 for process 800.

As described previously, UE 115 may have reduced a frequency of cell searching for satellites RATs by an AS layer at 1010, but cell searching may continue at a lower frequency and/or periodically. In some scenarios, e.g. where UE 115 is moving and changes to a new location different to a location of UE 115 when times T1 and T2 were previously determined at 1002, UE 115 may, at 1020, enter coverage of a satellite cell or a TN cell for the serving PLMN before time T2. For example, a new location of UE 115 may be in coverage of a TN cell or an SV 102/202/302 prior to time T2. In that case, UE 115 may detect and subsequently access the satellite cell or TN cell at 1020 prior to the time T2 and may thereby determine to exit the no coverage state prior to the time T2. In some other scenarios, at 1020, UE 115 may detect that a location of UE 115 has changed (due to movement of UE 115) and that a previous location of the UE 115 (e.g. used to determine T1 and T2 previously at 1002) is no longer a valid approximation for a current location of the UE. For example, the UE 115 may use inertial sensors in UE 115 or other location measurements (e.g. GNSS measurements) to determine that UE 115 has moved by more than some threshold distance from a previous location of UE 115 (e.g. a previous location of UE 115 when the times T1 and T2 were determined). For example, the threshold distance may be in the range 20 to 300 kms. In this case, due to the change in location, UE 115 may expect to possibly acquire satellite or TN coverage before time T2 and may thereby determine to exit the no coverage state at 1020.

At 1025, and due to the determination of coverage by a satellite or TN cell for the serving PLMN or a change in UE 115 location at 1020, UE 115 may determine that an exit trigger with respect to the no coverage state has occurred. The exit trigger may correspond to UE 115 moving to a new location where a satellite and/or ground-based cell either is available or may be available for UE 115. The exit trigger may be determined at a time T3, where T3 occurs before (prior to) T2. The exit trigger may be based on access to (e.g. acquisition of) a satellite cell or TN coverage by an AS layer of UE 115 at 1020 or on a determination by UE 115 at 1020 that the UE 115 location has changed (e.g. by more than a threshold distance).

At 1030, which may occur at or following the time T3, and based on the exit trigger determined at 1025, UE 115 may implement an event (e.g. an AS or NAS layer event) where UE 115 leaves the no coverage state and enters the coverage state and resumes normal configuration based on satellite cell coverage being available or possibly available at the location of UE 115. The UE 115 may then take various actions at 1030 while in the coverage state to resume communications. For example, UE 115 may resume normal satellite and/or TN cell searching at a normal frequency and/or normal periodicity, and may enable MO request(s) in UE 115 while operating in the coverage state. In some examples, UE 115 may increase the frequency of satellite cell searching from a first frequency while in the no coverage state to a second (higher) frequency while in the coverage state. That is, the second frequency may include normal satellite cell searches performed (e.g. more often) by UE 115. The cell search scan may include a normal duration of cell scanning (e.g., cell scanning for longer periods of time) and/or with a shorter interval between successive cell scans (e.g., cell scanning more often) than when UE 115 is operating in the no coverage state. For example 1030 in process 1000 may correspond to 850 for process 800.

At 1035, and if UE 115 is able to access a satellite or TN cell at 1020 or 1030, UE 115 may optionally transmit or otherwise provide an indication to entity 180 that UE 115 is no longer operating in the no coverage state and/or that UE 115 is now operating in the coverage state. The indication may be provided in a NAS Registration Request (e.g., when entity 180 is an AMF 122) and/or in a NAS Attach Request or NAS Tracking Area Update Request (e.g., when entity 180 is a MME). For example 1035 in process 1000 may correspond to 855 for process 800.

In the example where entity 180 of the serving PLMN has entered a no coverage state for UE 115 at 1015, an exit trigger at entity 180 may correspond to the receipt of a NAS message from UE 115 (e.g. as sent at 1035) indicating that UE 115 is now in coverage. Based on the exit trigger at entity 180, and at 1040, the entity 180 may determine that UE 115 has entered the coverage state. Accordingly, at 1045, the entity 180 may re-enable paging for UE 115, and re-enable queued MT requests for UE 115, which may, for example, be sent to the UE 115 following receipt of the NAS message received at 1035. For example 1040 and 1045 in process 1000 may correspond to 860 for process 800.

The different types of satellite coverage data and their usage described above in association with FIGS. 7A to 10 can enable a UE 115 to determine at what times (e.g. times T1 and T2) the UE 115 will and will not be in coverage of a satellite cell enabling access to a serving PLMN. However, the satellite coverage data may not indicate whether and at what times and locations the UE 115 may be in coverage of a satellite cell not supporting the serving PLMN but instead supporting a PLMN different to the serving PLMN (e.g. a home PLMN for the UE 115). Additionally, the satellite coverage data may not indicate whether and at what locations (and possibly at what times) the UE 115 may be in coverage of a TN cell for the serving PLMN (or another PLMN such a home PLMN for the UE 115), e.g. a TN cell that supports 5G NR access to a terrestrial gNB or a TN cell that supports LTE access to an terrestrial ng-eNB or terrestrial gNB. Therefore, when a UE 115 determines that satellite coverage is not available for a serving PLMN (e.g. when UE 115 enters a no coverage state for a serving PLMN as at 835 in process 800), the UE 115 may not know whether to continue searching for a satellite cell for another PLMN (e.g. a home PLMN) and/or whether to search for a TN cell. Such lack of knowledge by UE 115 may lead to unnecessary power expenditure if UE 115 continues searching for a satellite cell for another PLMN and/or for a TN cell and finds none. Such lack of knowledge by UE 115 may also lead to unnecessary lack of PLMN access by UE 115 if UE 115 instead enters a dormant state during a no coverage state for the serving PLMN, in which UE 115 deactivates all satellite and TN cell searching, and if a satellite cell for another PLMN or a TN cell is, or later becomes, available to UE 115 during the no coverage state.

For a UE 115 that is only subscribed or configured to access, or only capable of accessing, satellite cells for the serving PLMN (e.g. where the serving PLMN is a home PLMN for UE 115 and UE 115 does not support TN access), this may not be a problem, and the UE 115 can then go into a total dormant state during a period of no satellite coverage for the serving PLMN as described and allowed for processes 800, 900 and 1000 described earlier. However, for a UE 115 that supports roaming to other PLMNs with satellite access and/or supports TN access, it may be advantageous if the UE 115 can know whether satellite access for other PLMNs and/or terrestrial wireless access is available when in a no coverage state for the serving PLMN.

Extensions of the techniques described above for providing satellite coverage data to a UE 115 can be used to provide the UE 115 with this extra information on satellite coverage availability for other PLMNs and TN coverage availability. In one such extension, extra coverage data (e.g. a coverage map, bit map or time sequence as described for FIGS. 7A and 7B) may be provided to UE 115 by the serving PLMN (e.g. by an AMF 112, MME or gNB 106/202/307) or by another entity (e.g. a web server accessed by UE 115 via the Internet such as a web server supported by a home PLMN or by a vendor or OEM for the UE 115) for one or more other PLMNs and in the same or a similar way as satellite coverage data is provided for the serving PLMN, e.g. as at 815 for process 800. The extra coverage data may be supported as described for FIGS. 7A and 7B, but, instead of indicating satellite availability and unavailability for different locations and/or different times for the serving PLMN, may instead indicate satellite availability and unavailability for different locations and/or different times for one or more other PLMNs. In another extension, extra coverage data may be provided for terrestrial wireless access and may indicate TN cell availability and TN cell unavailability for different locations and/or different times for the serving PLMN and/or for one or more other PLMNs. Since terrestrial cells do not typically move (though may sometimes be switched on and off), a coverage map for TN cells may comprise a string of bits or an array of bits where each bit in the string of bits or array of bits corresponds to a particular location in an array of locations (e.g. a rectangular grid point array of locations) and indicates whether TN cells are or are not available at that location and at any time and not just one particular time. Similar to a coverage map for satellite access, such a coverage map for TN cells may also be compressed when nearby locations tend to have the same coverage or non-coverage attribute and thus same bit value.

In one extension for providing extra coverage data for terrestrial access, binary values (e.g. 1 or 0) may be provided in a coverage map for each location to indicate coverage (e.g. binary “1”) versus no coverage (e.g. binary “0”). In another type of extension for providing extra coverage data for terrestrial access, ternary or quaternary values may be provided in a coverage map instead of binary values. For example, with ternary values, a value “0” may indicate TN coverage is not available, a value “1” may indicate TN coverage is available and a value “2” may indicate TN coverage may be available but is not guaranteed. The third value “2” may be useful to indicate a location where TN coverage can sometimes be available (e.g. depending on the exact location of a UE 115) but not always, which may be used at a location where TN coverage by a serving PLMN can be blocked by buildings, natural obstacles (e.g. hills, trees) but is normally available if a UE 115 has line of sight to a terrestrial base station or access point. With quaternary values, the values “0”. “1” and “2” may have the meaning just described and a fourth value “3” may be included to indicate a location where TN coverage can sometimes be available as for the value “2” but with a lower (or higher) probability than the value “2”.

In another type of extension, extra coverage data may be provided as a single coverage map which combines coverage indications for the serving PLMN and for other PLMNs and/or combines coverage indications for both satellite access and terrestrial access. The single coverage map may provide a string or array of binary, ternary, quaternary (or additional valued) parameters, where each parameter in the string or array indicates whether there is or is not satellite and/or TN cell coverage for the serving PLMN and possibly additional PLMNs at a particular location and/or particular time. For example, in a simplest example, a string or array of binary values may be provided using a bit map as described for FIGS. 7A and 7B. A bit that is set to a “0” may then indicate that no coverage is available either from a satellite cell or TN cell for a particular location and time, whereas a bit set to a “1” may indicate that coverage is available for that time and location from at least one of a satellite cell or TN cell. In another example using quaternary values, a quaternary value provided for a particular location and time may indicate no satellite and no TN coverage for a “0” value, satellite but no TN coverage for a “1” value, TN but not satellite coverage for a “2” value and both satellite and TN coverage for a “3’ value. A string or array of quaternary values can also be encoded as a bit string or array by using 2 bits to encode each quaternary value. Such a bit string or array may then also be compressed when values for nearby locations and/or times tend to be the same.

The extensions described above for providing extra (satellite and/or terrestrial) coverage data to a UE 115 for TN cells and/or other PLMNs can allow a UE 115 to modify support of coverage gaps and satellite coverage as described above for FIGS. 8 to 10 such that a UE 115 can access a satellite cell for another PLMN or a TN cell during a (satellite) coverage gap for the serving PLMN and without expending power searching for other satellite cells or TNs cells when none are available. The modifications may occur as follows. At 815 in process 800, the UE 115 may receive (e.g. request and obtain or receive via broadcast) extra coverage data for satellite access to multiple PLMNs to which UE 115 is allowed access and/or for TN access as described above. In some examples, the satellite coverage data sent at 815 may include this extra coverage data. At 820, UE 115 may determine times T1 and T2 that apply to satellite cell availability from the multiple PLMNs. For example, time T1 in process 800 may now correspond to an earliest time at or later than a current time at which there is or will be no satellite cell availability for any of the multiple PLMNs at a current location of UE 115. Similarly, time T2 in process 800 may now correspond to an earliest time subsequent to time T1 at which a satellite cell for at least one of the multiple PLMNs becomes available at the current location for UE 115. In one scenario, the UE 115 may refrain from entering the no coverage state at 835 when the extra coverage data indicates that one or more satellite cells are available for one or more other PLMN(s) at a time (e.g., time T1) when satellite cells for the serving PLMN become unavailable to UE 115. Conversely, the UE 115 may enter the no coverage state at time T1 when the extra coverage data indicates that satellite cells for the other PLMN(s) (as well as for the serving PLMN) are not available at time T1. At 835, when UE 115 enters the no coverage state at or just after time T1, UE 115 may deactivate all satellite RATs or reduce a frequency of satellite cell searching until the time T2 occurs, but may not deactivate TN RATs and may continue normal TN cell searching if the extra coverage data indicates that TN cells are still available at the time T1. On the other hand, if the extra coverage data indicates that TN cells are not available at the time T1, UE 115 may also deactivate TN RATs at or prior to time T1 or reduce a frequency of TN cell searching. In other words, UE 115 may search for or access a TN cell while in the no coverage state when the extra coverage data indicates that TN cells are available at time T1, or UE 115 may refrain from searching for TN cells while in the no coverage state when the extra coverage data indicates that TN cells are not available at time T1. In some embodiments, UE 115 may deactivate TN RATs at an earlier time in process 800 before time T1 (e.g. at 815 or 820) if the extra coverage data indicates that TN cells are not available at a current location of UE 115. Generally, the extra coverage data can be used by UE 115 to determine when satellite and TN cells are or may be available and to allow UE 115 to deactivate satellite RATs and TN RATs when satellite cells and TN cells, respectively, are indicated as not being available, e.g. at a current location for UE 115 and/or at a particular time.

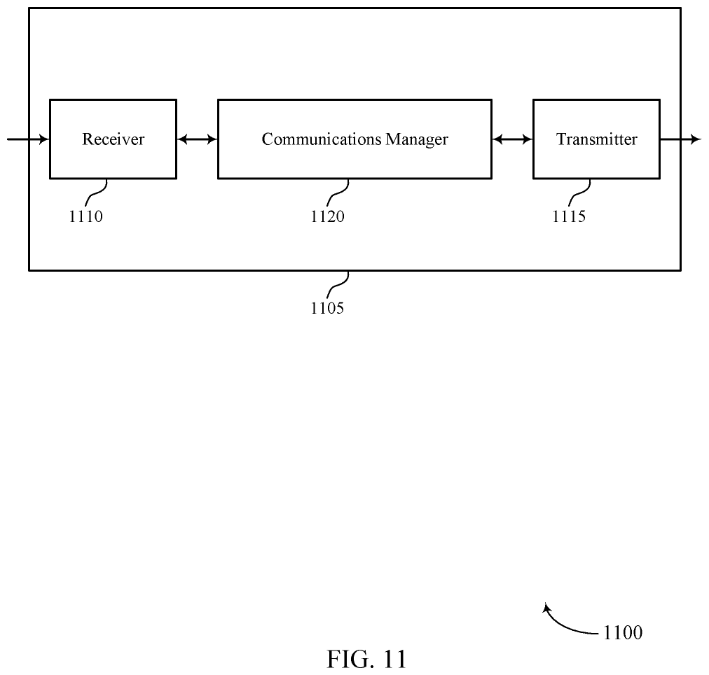

FIG. 11 shows a block diagram 1100 of a device 1105 that supports coverage gaps for satellite access in accordance with aspects of the present disclosure. The device 1105 may be an example of aspects of a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to support of coverage gaps for satellite access). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to support of coverage gaps for satellite access). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of support of coverage gaps for satellite access as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support satellite wireless access by a UE to a serving PLMN with discontinuous satellite coverage in accordance with examples as disclosed herein. For example, the communications manager 1120 may be configured as or otherwise support a means for accessing the serving PLMN via a communication satellite. The communications manager 1120 may be configured as or otherwise support a means for receiving or otherwise obtaining satellite coverage data from an entity in the serving PLMN via the communication satellite. The communications manager 1120 may be configured as or otherwise support a means for determining, based on the satellite coverage data, a first time of satellite unavailability for a location of the UE and a second time of satellite availability for the location of the UE. The communications manager 1120 may be configured as or otherwise support a means for entering a no coverage state following the first time. The communications manager 1120 may be configured as or otherwise support a means for inhibiting one or more MO requests in the UE while in the no coverage state. The communications manager 1120 may be configured as or otherwise support a means for reducing a frequency of satellite cell searching from a first frequency in a coverage state to a second frequency while in the no coverage state. The communications manager 1120 may be configured as or otherwise support a means for leaving the no coverage state at the second time.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for a UE to access a serving PLMN (e.g., core network and/or RAN entity) via a communication satellite that takes steps to reduce power consumption and conserve resources based on satellite coverage data from the entity in the serving PLMN via communication satellite.

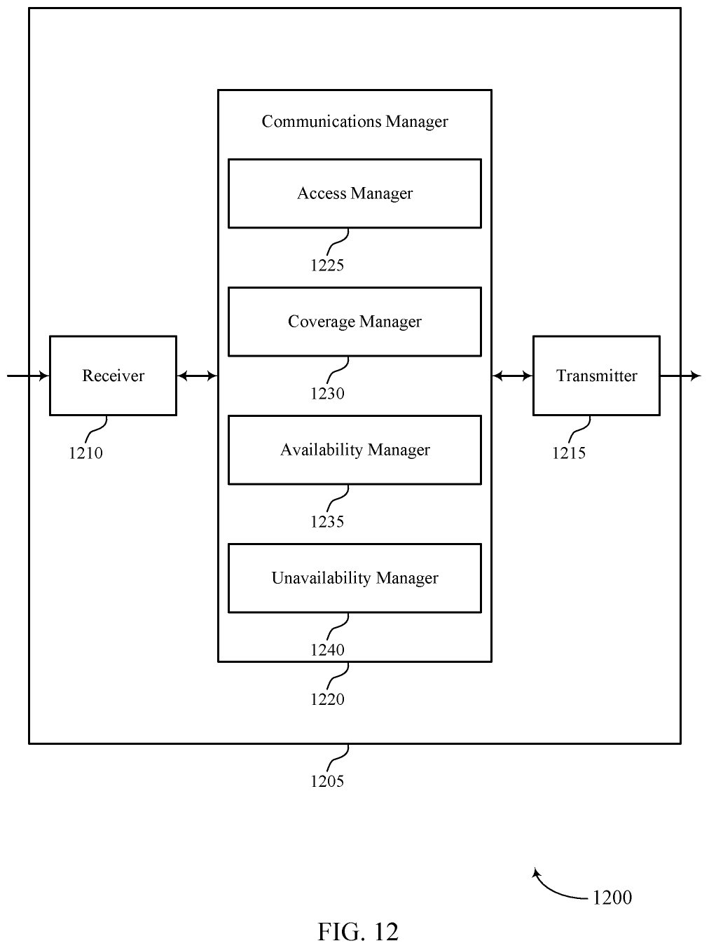

FIG. 12 shows a block diagram 1200 of a device 1205 that supports coverage gaps for satellite access in accordance with aspects of the present disclosure. The device 1205 may be an example of aspects of a device 1105 or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to support of coverage gaps for satellite access). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to support of coverage gaps for satellite access). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of support of coverage gaps for satellite access as described herein. For example, the communications manager 1220 may include an access manager 1225, a coverage manager 1230, an availability manager 1235, an unavailability manager 1240, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support satellite wireless access by a UE to a serving PLMN with discontinuous satellite coverage in accordance with examples as disclosed herein. The access manager 1225 may be configured as or otherwise support a means for accessing the serving PLMN via a communication satellite. The coverage manager 1230 may be configured as or otherwise support a means for receiving or otherwise obtaining satellite coverage data from an entity in the serving PLMN via the communication satellite. The availability manager 1235 may be configured as or otherwise support a means for determining, based on the satellite coverage data, a first time of satellite unavailability for a location of the UE and a second time of satellite availability for the location of the UE. The unavailability manager 1240 may be configured as or otherwise support a means for entering a no coverage state following the first time. The unavailability manager 1240 may be configured as or otherwise support a means for inhibiting one or more MO requests in the UE while in the no coverage state. The unavailability manager 1240 may be configured as or otherwise support a means for reducing a frequency of satellite cell searching from a first frequency in a coverage state to a second frequency while in the no coverage state. The availability manager 1235 may be configured as or otherwise support a means for leaving the no coverage state at the second time.

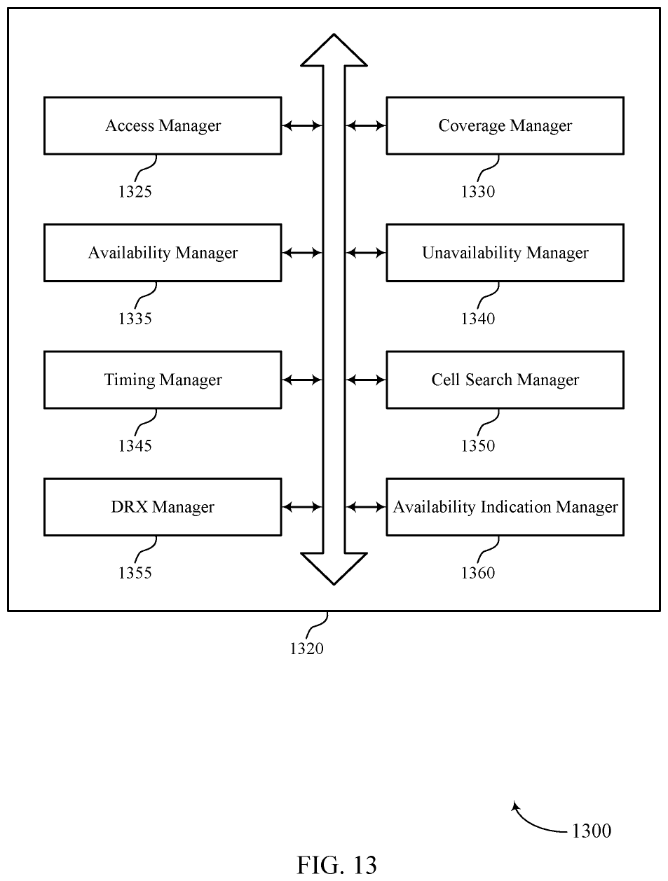

FIG. 13 shows a block diagram 1300 of a communications manager 1320 that supports coverage gaps for satellite access in accordance with aspects of the present disclosure. The communications manager 1320 may be an example of aspects of a communications manager 1120, a communications manager 1220, or both, as described herein and may, in some examples, be part of a UE 115. The communications manager 1320, or various components thereof, may be an example of means for performing various aspects of support of coverage gaps for satellite access as described herein. For example, the communications manager 1320 may include an access manager 1325, a coverage manager 1330, an availability manager 1335, an unavailability manager 1340, a timing manager 1345, a cell search manager 1350, a DRX manager 1355, an availability indication manager 1360, or any combination thereof. Each of these components may communicate, directly or indirectly, with one another (e.g., via one or more buses).

The communications manager 1320 may support satellite wireless access by a UE to a serving PLMN with discontinuous satellite coverage in accordance with examples as disclosed herein. The access manager 1325 may be configured as or otherwise support a means for accessing the serving PLMN via a communication satellite. The coverage manager 1330 may be configured as or otherwise support a means for receiving or otherwise obtaining satellite coverage data from an entity in the serving PLMN via the communication satellite. The availability manager 1335 may be configured as or otherwise support a means for determining, based on the satellite coverage data, a first time of satellite unavailability for a location of the UE and a second time of satellite availability for the location of the UE. The unavailability manager 1340 may be configured as or otherwise support a means for entering a no coverage state following the first time. In some examples, the unavailability manager 1340 may be configured as or otherwise support a means for inhibiting one or more MO requests in the UE while in the no coverage state. In some examples, the unavailability manager 1340 may be configured as or otherwise support a means for reducing a frequency of satellite cell searching from a first frequency in a coverage state to a second frequency while in the no coverage state. In some examples, the availability manager 1335 may be configured as or otherwise support a means for leaving the no coverage state at the second time.

In some examples, the first time includes an earliest time at or after a current time for the determining at which satellite coverage for the serving PLMN becomes unavailable at the location of the UE. In some examples, the second time includes an earliest time after the first time at which satellite coverage for the serving PLMN becomes available at the location of the UE.

In some examples, to support entering the no coverage state, the timing manager 1345 may be configured as or otherwise support a means for entering the no coverage state at the first time and/or entering the no coverage state based on satellite access being lost at or after the first time. In some examples, the entity is configured as an AMF or MME. In some examples, receiving the satellite coverage data includes receiving the satellite coverage data in a NAS message via the communication satellite. In some examples, the entity is configured as a base station (e.g., gNB, ng-eNB, or eNB). In some examples, receiving the satellite coverage data includes receiving the satellite coverage data in one or more SIBs broadcast by the entity via the communication satellite.

In some examples, the satellite coverage data includes the first time and the second time. In some examples, the satellite coverage data includes indications of satellite cell availability for a set of multiple times and for a current location of the UE. In some examples, the current location of the UE includes a current geodetic location of the UE, a current coverage area of a serving satellite cell for the UE, or an area of a current fixed cell for the UE. In some examples, the satellite coverage data includes indications of satellite cell availability for a set of multiple locations and a set of multiple times.

In some examples, the set of multiple locations correspond to locations in an array of grid points. In some examples, the indications of satellite cell availability for the set of multiple locations for each time in the set of multiple times are encoded as an array of Boolean values. In some examples, each Boolean value in the array of Boolean values corresponds to one grid point location in the array of grid points and indicates whether or not there is satellite cell availability at the grid point location and at each time. In some examples, each Boolean value of the Boolean values is encoded as one bit. In some examples, the number of bits in the satellite coverage data is reduced using a compression algorithm. In some examples, the second entity is an AMF or MME. In some examples, the first and the second times are sent in a NAS message.

In some examples, to support reducing the frequency of satellite cell searching, the cell search manager 1350 may be configured as or otherwise support a means for deactivating support for one or more satellite RATs by an AS layer in the UE. In some examples, to support reducing the frequency of satellite cell searching, the cell search manager 1350 may be configured as or otherwise support a means for deactivating support for all satellite RATs by the AS layer. In some examples, to support reducing the frequency of satellite cell searching, the cell search manager 1350 may be configured as or otherwise support a means for deactivating support for all terrestrial RATs by the AS layer. In some examples, to support reducing the frequency of satellite cell searching, the cell search manager 1350 may be configured as or otherwise support a means for configuring a cell search scan for one or more satellite RATs, one or more terrestrial RATs, or both, by the AS layer, where the cell search scan employs a shorter duration of cell scanning, a longer interval between successive cell scans, or both, than when the UE is not in the no coverage state. In some examples, to support reducing the frequency of satellite cell searching, the cell search manager 1350 may be configured as or otherwise support a means for periodically reactivating and later deactivating support for one or more satellite RATs, one or more terrestrial RATs, or both by the AS layer; or. In some examples, to support reducing the frequency of satellite cell searching, the cell search manager 1350 may be configured as or otherwise support a means for performing some combination of these.

In some examples, inhibiting MO requests in the UE while in the no coverage state includes rejecting requests by applications in the UE to send text, send data, or establish calls or sessions to entities outside the UE. In some examples, inhibiting MO requests in the UE while in the no coverage state further includes providing an indication of the no coverage state, the second time, or both to the applications.

In some examples, a second entity in the serving PLMN inhibits paging and queues MT text and data for the UE based on the UE being in an IDLE state following the first time. In some examples, the second entity continues to inhibit paging and queue MT text and data for the UE until at least one of an occurrence of the second time or obtaining an indication that the UE is no longer in the no coverage state.

In some examples, the availability indication manager 1360 may be configured as or otherwise support a means for outputting a message for transmission to the second entity after leaving the no coverage state, where the message includes the indication that the UE is no longer in the no coverage state. In some examples, the second entity is configured as an MME or AMF, where the message is a NAS Registration Request when the second entity is an AMF. In some examples, the message is a NAS Attach Request when the second entity is an MME.

In some examples, the availability indication manager 1360 may be configured as or otherwise support a means for leaving the no coverage state at a third time prior to the second time, where the message is sent at or after the third time. In some examples, the UE may determine that the location of the UE is no longer a valid approximation for a current location of the UE. In some examples, accessing a cell for the serving PLMN while in the no coverage state, where the cell is a terrestrial cell or a satellite cell, or both.

In some examples, the no coverage state includes a NAS state, an AS state, a running of a NAS timer, or a running of an AS timer. In some examples, the running of the NAS timer or the running of the AS timer starts at the first time and stops at the second time.

In some examples, the availability indication manager 1360 may be configured as or otherwise support a means for receiving extra coverage data, wherein the extra coverage data indicates at least one of satellite cell availability for other PLMNs, terrestrial network cell availability, or both.

In some examples, the availability indication manager 1360 may be configured as or otherwise support a means for refraining from entering the no coverage state at the first time when the extra coverage data indicates that satellite cells are available for the other PLMNs at the first time; and entering the no coverage state at the first time when the extra coverage data indicates that satellite cells are not available for the other PLMNs at the first time.

In some examples, the availability indication manager 1360 may be configured as or otherwise support a means for searching for or accessing a TN cell while in the no coverage state when the extra coverage data indicates that TN cells are available at the first time; and refraining from searching for TN cells while in the no coverage state when the extra coverage data indicates that TN cells are not available at the first time. In some examples, the satellite coverage data includes the extra coverage data.

In some examples, the DRX manager 1355 may be configured as or otherwise support a means for refraining from entering the no coverage state while the UE is in a power savings state. In some examples, the DRX manager 1355 may be configured as or otherwise support a means for entering the no coverage state after the UE leaves the power savings state when the UE leaves the power savings state after the first time and before the second time. In some examples, the satellite coverage data may be received via a transceiver.

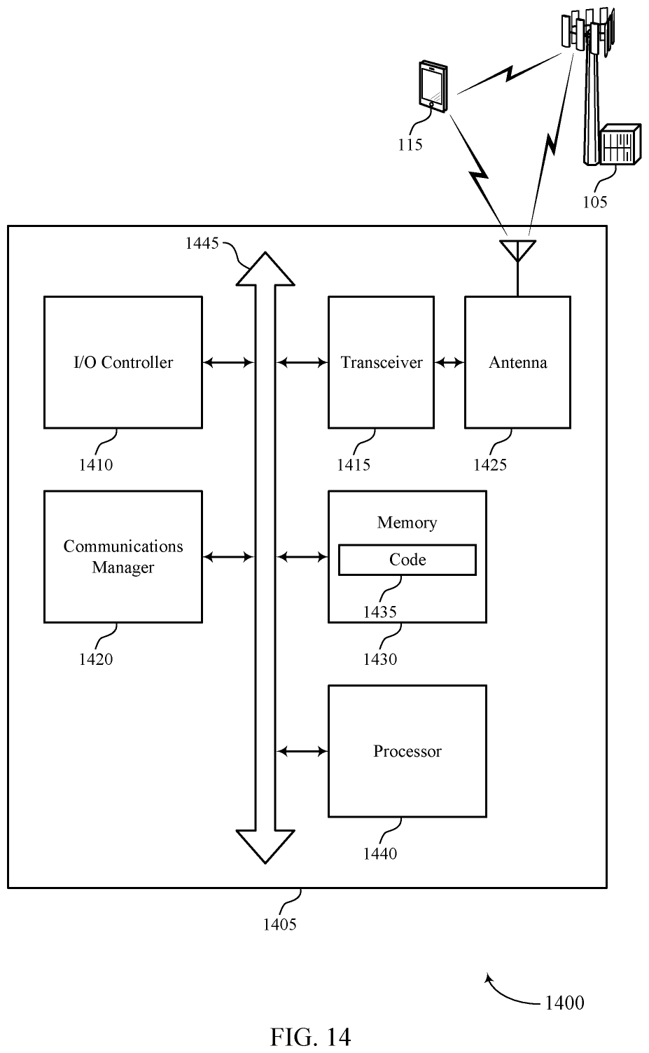

FIG. 14 shows a diagram of a system 1400 including a device 1405 that supports coverage gaps for satellite access in accordance with aspects of the present disclosure. The device 1405 may be an example of or include the components of a device 1105, a device 1205, or a UE 115 as described herein. The device 1405 may communicate wirelessly with one or more gNBs 106/202/307, UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting support of coverage gaps for satellite access). For example, the device 1405 or a component of the device 1405 may include a processor 1440 and memory 1430 coupled to the processor 1440, the processor 1440 and memory 1430 configured to perform various functions described herein.

The communications manager 1420 may support satellite wireless access by a UE (e.g. a UE 115) to a serving PLMN with discontinuous satellite coverage in accordance with examples as disclosed herein. For example, the communications manager 1420 may be configured as or otherwise support a means for accessing the serving PLMN via a communication satellite. The communications manager 1420 may be configured as or otherwise support a means for receiving or otherwise obtaining satellite coverage data from an entity in the serving PLMN via the communication satellite. The communications manager 1420 may be configured as or otherwise support a means for determining, based on the satellite coverage data, a first time of satellite unavailability for a location of the UE and a second time of satellite availability for the location of the UE. The communications manager 1420 may be configured as or otherwise support a means for entering a no coverage state following the first time. The communications manager 1420 may be configured as or otherwise support a means for inhibiting one or more mobile originating requests in the UE while in the no coverage state. The communications manager 1420 may be configured as or otherwise support a means for reducing a frequency of satellite cell searching from a first frequency in a coverage state to a second frequency while in the no coverage state. The communications manager 1420 may be configured as or otherwise support a means for leaving the no coverage state at the second time.

By including or configuring the communications manager 1420 in accordance with examples as described herein, the device 1405 may support techniques for reducing power consumption and/or improving resource utilization/conservation when the UE is operating in a no coverage state with respect to a communication satellite coverage pattern.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of support of coverage gaps for satellite access as described herein, or the processor 1440 and the memory 1430 may be otherwise configured to perform or support such operations.

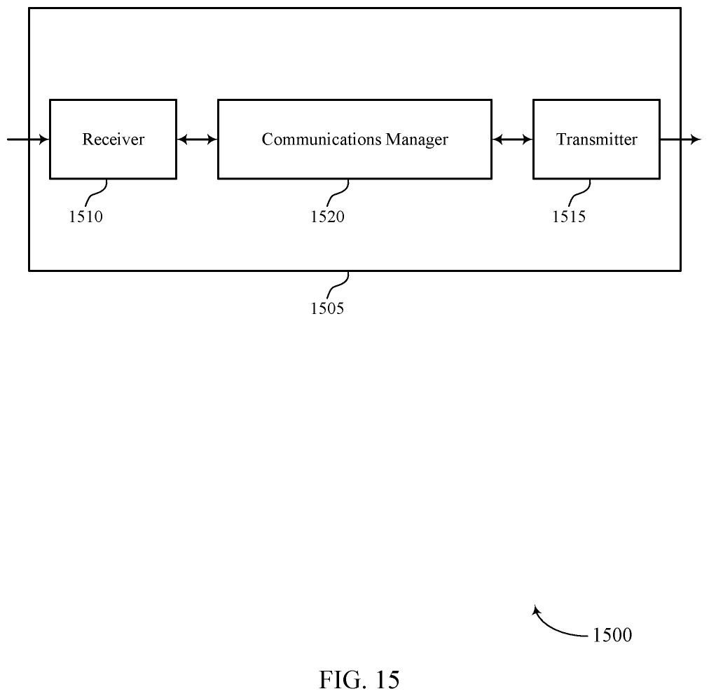

FIG. 15 shows a block diagram 1500 of a device 1505 that supports coverage gaps for satellite access in accordance with aspects of the present disclosure. The device 1505 may be an example of aspects of an entity (e.g., an entity 180, a component within a core network, such as AMF 122 and/or an MME, and/or a component within a RAN, such as a base station, gNB 106/202/307, ng-eNB 114, eNB, etc.) as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to support of coverage gaps for satellite access). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to support of coverage gaps for satellite access). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations thereof or various components thereof may be examples of means for performing various aspects of support of coverage gaps for satellite access as described herein. For example, the communications manager 1520, the receiver 1510, the transmitter 1515, or various combinations or components thereof may support a method for performing one or more of the functions described herein.

In some examples, the communications manager 1520, the receiver 1510, the transmitter 1515, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1520, the receiver 1510, the transmitter 1515, or various combinations or components thereof may be implemented in code (e.g., as communications management software or firmware) executed by a processor. If implemented in code executed by a processor, the functions of the communications manager 1520, the receiver 1510, the transmitter 1515, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1520 may be configured to perform various operations (e.g., receiving, monitoring, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to receive information, transmit information, or perform various other operations as described herein.

The communications manager 1520 may support satellite wireless access by a UE (e.g. a UE 115) to a serving PLMN with discontinuous satellite coverage in accordance with examples as disclosed herein. For example, the communications manager 1520 may be configured as or otherwise support a means for obtaining satellite coverage data for the UE. The communications manager 1520 may be configured as or otherwise support a means for sending the satellite coverage data to the UE via a communication satellite, where the satellite coverage data enables a determination of a first time of satellite cell unavailability for a location of the UE and a second time of satellite cell availability for the location of the UE, where the UE is not reachable by the serving PLMN following the first time and prior to the second time, where the satellite coverage data is configured to enable the UE to reduce power consumption between the first and the second time.

By including or configuring the communications manager 1520 in accordance with examples as described herein, the device 1505 (e.g., a processor controlling or otherwise coupled to the receiver 1510, the transmitter 1515, the communications manager 1520, or a combination thereof) may support techniques for reducing power consumption and/or improving resource utilization/conservation when the UE is operating in a no coverage state with respect to a communication satellite coverage pattern.

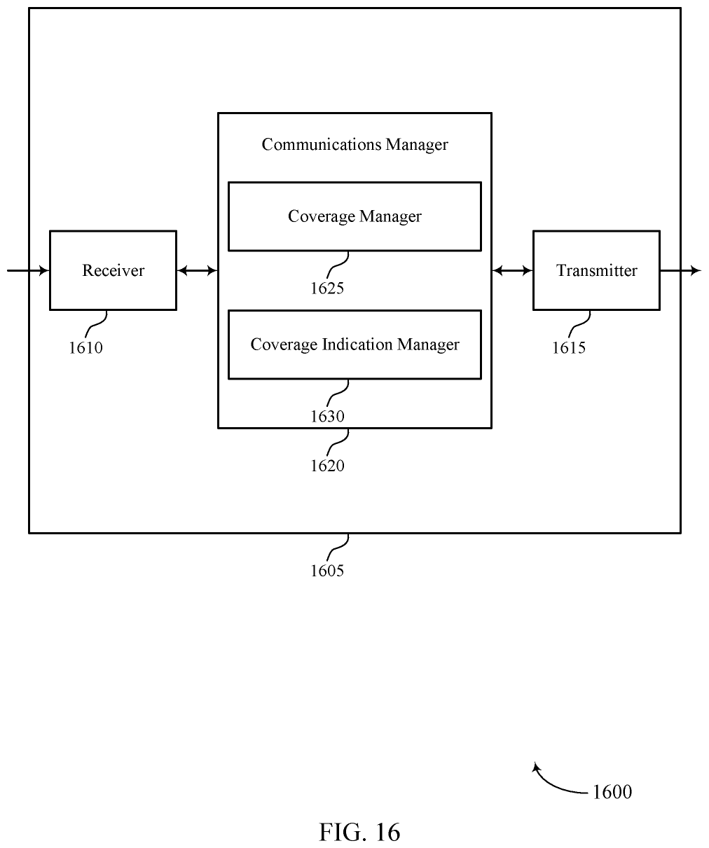

FIG. 16 shows a block diagram 1600 of a device 1605 that supports coverage gaps for satellite access in accordance with aspects of the present disclosure. The device 1605 may be an example of aspects of a device 1505 or an entity 180 (e.g. an AMF 122 or MME) as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to support of coverage gaps for satellite access). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to support of coverage gaps for satellite access). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of support of coverage gaps for satellite access as described herein. For example, the communications manager 1620 may include a coverage manager 1625 a coverage indication manager 1630, or any combination thereof. The communications manager 1620 may be an example of aspects of a communications manager 1520 as described herein. In some examples, the communications manager 1620, or various components thereof, may be configured to perform various operations (e.g., receiving, monitoring, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to receive information, transmit information, or perform various other operations as described herein.

The communications manager 1620 may support satellite wireless access by a UE (e.g. a UE 115) to a serving PLMN with discontinuous satellite coverage in accordance with examples as disclosed herein. The coverage manager 1625 may be configured as or otherwise support a means for obtaining satellite coverage data for the UE. The coverage indication manager 1630 may be configured as or otherwise support a means for sending the satellite coverage data to the UE via a communication satellite, where the satellite coverage data enables a determination of a first time of satellite cell unavailability for a location of the UE and a second time of satellite cell availability for the location of the UE, where the UE is not reachable by the serving PLMN following the first time and prior to the second time, where the satellite coverage data is configured to enable the UE to reduce power consumption between the first and the second time.

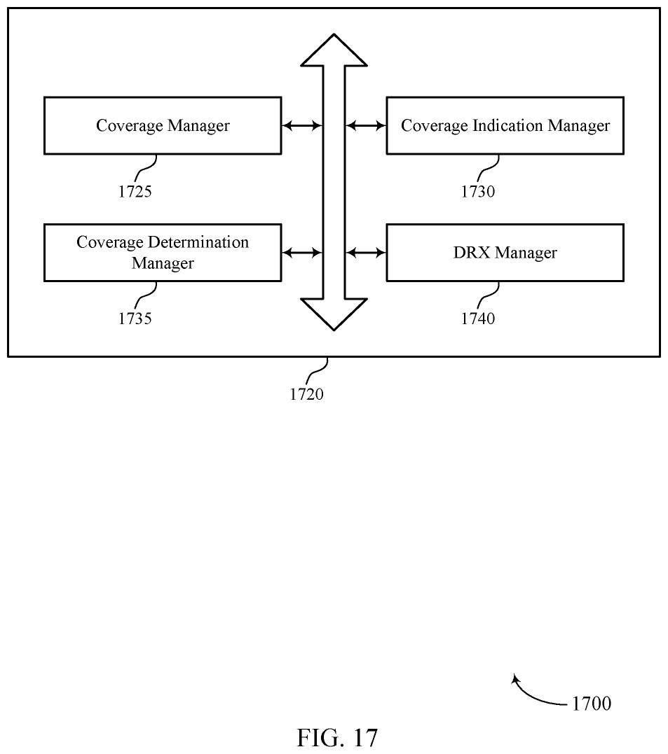

FIG. 17 shows a block diagram 1700 of a communications manager 1720 that supports coverage gaps for satellite access in accordance with aspects of the present disclosure. The communications manager 1720 may be an example of aspects of a communications manager 1520, a communications manager 1620, or both, as described herein. The communications manager 1720, or various components thereof, may be an example of means for performing various aspects of support of coverage gaps for satellite access as described herein. For example, the communications manager 1720 may include a coverage manager 1725, a coverage indication manager 1730, a coverage determination manager 1735, a DRX manager 1740, or any combination thereof. Each of these components may communicate, directly or indirectly, with one another (e.g., via one or more buses).

The communications manager 1720 may support satellite wireless access by a UE (e.g. a UE 115) to a serving PLMN with discontinuous satellite coverage in accordance with examples as disclosed herein. The coverage manager 1725 may be configured as or otherwise support a means for obtaining satellite coverage data for the UE. The coverage indication manager 1730 may be configured as or otherwise support a means for outputting the satellite coverage data for transmission to the UE via a communication satellite, where the satellite coverage data enables a determination of a first time of satellite cell unavailability for a location of the UE and a second time of satellite cell availability for the location of the UE, where the UE is not reachable by the serving PLMN following the first time and prior to the second time, where the satellite coverage data is configured to enable the UE to reduce power consumption between the first and the second time. In some examples, the satellite coverage data includes the first time and the second time. In some examples, the satellite coverage data includes indications of satellite cell availability for a set of multiple times and for a current location of the UE. In some examples, the current location of the UE includes a current geodetic location of the UE, a current coverage area of a serving satellite cell for the UE, or an area of a current fixed cell for the UE.

In some examples, the satellite coverage data includes indications of satellite cell availability for a set of multiple locations and a set of multiple times. In some examples, the set of multiple locations correspond to locations in an array of grid points. In some examples, the indications of satellite cell availability for the set of multiple locations for each time in the set of multiple times are encoded as an array of Boolean values. In some examples, each Boolean value in the array of Boolean values corresponds to one grid point location in the array of grid points and indicates whether or not there is satellite cell availability at the grid point location and at each time. In some examples, each Boolean value of the Boolean values is encoded as one bit. In some examples, the number of bits in the satellite coverage data is reduced using a compression algorithm.

In some examples, to support obtaining the satellite coverage data the coverage determination manager 1735 may be configured as or otherwise support a means for obtaining the satellite coverage data from an O&M server and/or a means for calculating the satellite coverage data based on the current location of the UE. In some examples, the communications manager 1720 is part of an AMF or MME. In some examples, sending or otherwise transmitting the satellite coverage data to the UE includes sending or otherwise transmitting the satellite coverage data in a NAS message via the communication satellite.

In some examples, the communications manager 1720 is part of a base station (e.g., gNB, ng-eNB or eNB). In some examples, sending or otherwise transmitting the satellite coverage data to the UE includes broadcasting the satellite coverage data in one or more SIBs via the communication satellite.

In some examples, the coverage indication manager 1730 may be configured as or otherwise support a means for receiving or otherwise obtaining from the UE, prior to the first time, the first time and the second time. In some examples, the communications manager 1720 is part of an AMF or MME. In some examples, the first and the second times are received in a NAS message.

In some examples, the DRX manager 1740 may be configured as or otherwise support a means for detecting that the UE is in an idle state at or following the first time. In some examples, the DRX manager 1740 may be configured as or otherwise support a means for inhibiting paging and queuing MT text and data for the UE. In some examples, the DRX manager 1740 may be configured as or otherwise support a means for ceasing to inhibit paging and ceasing to queue MT text and data for the UE in response to one of detecting an occurrence of the second time and/or receiving or otherwise obtaining an indication that the UE is reachable. In some examples, the indication is received or otherwise obtained from the UE.

In some examples, the communications manager 1720 is part of an AMF and the indication is received in a NAS Registration Request. In some examples, the communications manager 1720 is part of an MME and the indication is received in a NAS Attach Request or NAS Tracking Area Update Request. In some examples, the indication is received prior to the second time.

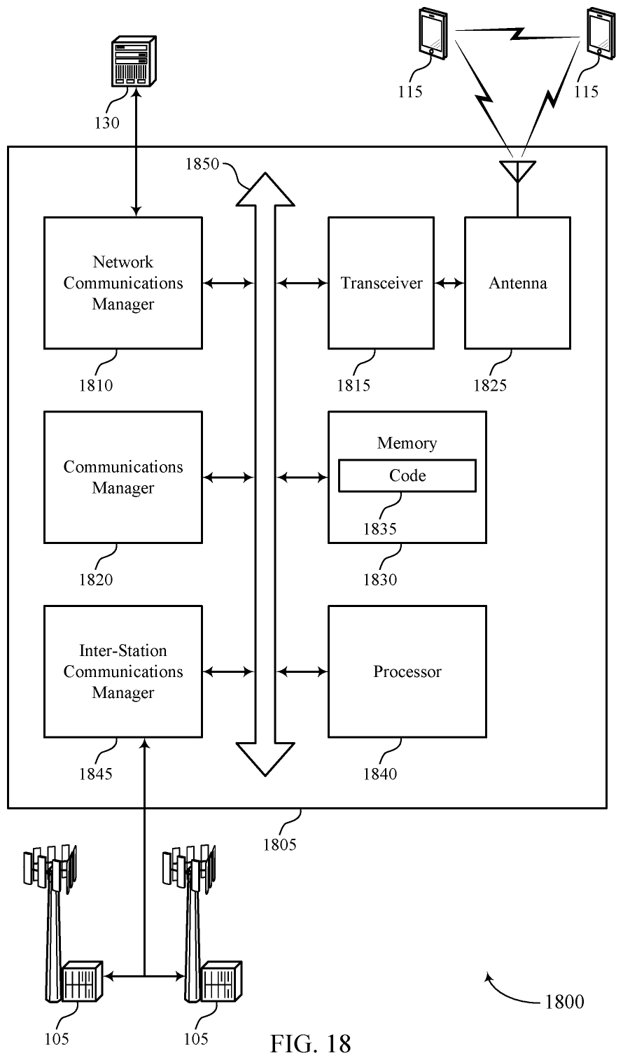

FIG. 18 shows a diagram of a system 1800 including a device 1805 that supports coverage gaps for satellite access in accordance with aspects of the present disclosure. The device 1805 may be an example of or include the components of a device 1505, a device 1605, or an entity 180 as described herein. The device 1805 may include components for bi-directional voice and data communications including components for transmitting and receiving communications, such as a communications manager 1820, a network communications manager 1810, a transceiver 1815, an antenna 1825, a memory 1830, code 1835, a processor 1840, and an inter-station communications manager 1845. These components may be in electronic communication or otherwise coupled (e.g., operatively, communicatively, functionally, electronically, electrically) via one or more buses (e.g., a bus 1850).

The network communications manager 1810 may manage communications with a core network (e.g., via one or more wired backhaul links). For example, the network communications manager 1810 may manage the transfer of data communications for client devices, such as one or more UEs 115.

In some cases, the device 1805 may include a single antenna 1825. However, in some other cases the device 1805 may have more than one antenna 1825, which may be capable of concurrently transmitting or receiving multiple wireless transmissions. The transceiver 1815 may communicate bi-directionally, via the one or more antennas 1825, wired, or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The memory 1830 may include RAM and ROM. The memory 1830 may store computer-readable, computer-executable code 1835 including instructions that, when executed by the processor 1840, cause the device 1805 to perform various functions described herein. The code 1835 may be stored in a non-transitory computer-readable medium such as system memory or another type of memory. In some cases, the code 1835 may not be directly executable by the processor 1840 but may cause a computer (e.g., when compiled and executed) to perform functions described herein. In some cases, the memory 1830 may contain, among other things, a BIOS which may control basic hardware or software operation such as the interaction with peripheral components or devices.

The processor 1840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1840 may be configured to operate a memory array using a memory controller. In some other cases, a memory controller may be integrated into the processor 1840. The processor 1840 may be configured to execute computer-readable instructions stored in a memory (e.g., the memory 1830) to cause the device 1805 to perform various functions (e.g., functions or tasks supporting support of coverage gaps for satellite access). For example, the device 1805 or a component of the device 1805 may include a processor 1840 and memory 1830 coupled to the processor 1840, the processor 1840 and memory 1830 configured to perform various functions described herein.

The inter-station communications manager 1845 may manage communications with gNBs 106/202/307, and may include a controller or scheduler for controlling communications with UEs 115 in cooperation with gNBs 106/202/307. For example, the inter-station communications manager 1845 may coordinate scheduling for transmissions to UEs 115 for various interference mitigation techniques such as beamforming or joint transmission. In some examples, the inter-station communications manager 1845 may provide an X2 interface within an LTE/LTE-A wireless communications network technology to provide communication between eNBs.

The communications manager 1820 may support satellite wireless access by a UE (e.g. a UE 115) to a serving PLMN with discontinuous satellite coverage in accordance with examples as disclosed herein. For example, the communications manager 1820 may be configured as or otherwise support a means for obtaining satellite coverage data for the UE. The communications manager 1820 may be configured as or otherwise support a means for sending the satellite coverage data to the UE via a communication satellite, where the satellite coverage data enables a determination of a first time of satellite cell unavailability for a location of the UE and a second time of satellite cell availability for the location of the UE, where the UE is not reachable by the serving PLMN following the first time and prior to the second time, where the satellite coverage data is configured to enable the UE to reduce power consumption between the first and the second time.

By including or configuring the communications manager 1820 in accordance with examples as described herein, the device 1805 may support techniques for providing satellite coverage data to a UE to enable reduced power consumption/resource conservation during periods of satellite cell unavailability at the UE.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the processor 1840, the memory 1830, the code 1835, or any combination thereof. For example, the code 1835 may include instructions executable by the processor 1840 to cause the device 1805 to perform various aspects of support of coverage gaps for satellite access as described herein, or the processor 1840 and the memory 1830 may be otherwise configured to perform or support such operations.

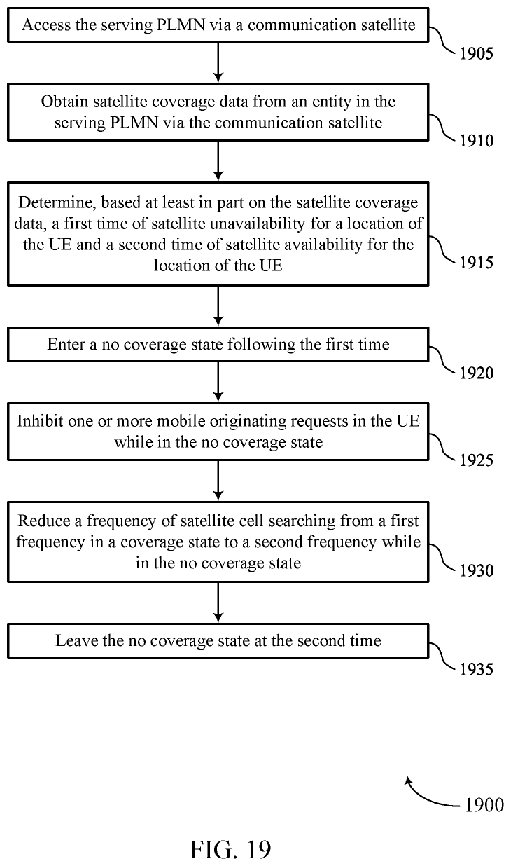

FIG. 19 shows a flowchart illustrating a method 1900 that supports satellite wireless access by a user equipment (e.g. a UE 115) to a serving public land mobile network (PLMN) (e.g. a 5GCN 110) with discontinuous satellite coverage in accordance with aspects of the present disclosure. The operations of the method 1900 may be implemented by the UE or its components as described herein. For example, the operations of the method 1900 may be performed by or at a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1905, the method may include accessing the serving PLMN via a communication satellite (e.g. an SV 102/202/302), e.g. as described for 810 in process 800. The operations of 1905 may be performed in accordance with examples as disclosed herein. In some examples, aspects of the operations of 1905 may be performed by an access manager 1325 as described with reference to FIG. 13.

At 1910, the method may include obtaining (e.g. receiving) satellite coverage data from an entity in the serving PLMN via the communication satellite, e.g. as described for 815 in process 800. The operations of 1910 may be performed in accordance with examples as disclosed herein. In some examples, aspects of the operations of 1910 may be performed by a coverage manager 1330 as described with reference to FIG. 13.

At 1915, the method may include determining, based at least in part on the satellite coverage data, a first time of satellite unavailability for a location of the UE (e.g. a current location of the UE) and a second time of satellite availability for the location of the UE, e.g. as described for 820 in process 800. For example, the first time may correspond to the time T1 and the second time may correspond to the time T2 described for process 800 and process 1000 in FIGS. 8 and 10. The operations of 1915 may be performed in accordance with examples as disclosed herein. In some examples, aspects of the operations of 1915 may be performed by an availability manager 1335 as described with reference to FIG. 13.

At 1920, the method may include entering a no coverage state at or following the first time, e.g. as described for 835 in process 800. The operations of 1920 may be performed in accordance with examples as disclosed herein. In some examples, aspects of the operations of 1920 may be performed by an unavailability manager 1340 as described with reference to FIG. 13.

At 1925, the method may include inhibiting one or more mobile originating requests in the UE while in the no coverage state, e.g. as described for 835 in process 800. The operations of 1925 may be performed in accordance with examples as disclosed herein. In some examples, aspects of the operations of 1925 may be performed by an unavailability manager 1340 as described with reference to FIG. 13.

At 1930, the method may include reducing a frequency of satellite cell searching from a first frequency in a coverage state to a second frequency while in the no coverage state, e.g. as described for 835 in process 800. The operations of 1930 may be performed in accordance with examples as disclosed herein. In some examples, aspects of the operations of 1930 may be performed by an unavailability manager 1340 as described with reference to FIG. 13.

At 1935, the method may include leaving the no coverage state at or following the second time, e.g. as described for 850 in process 800. The operations of 1935 may be performed in accordance with examples as disclosed herein. In some examples, aspects of the operations of 1935 may be performed by an availability manager 1335 as described with reference to FIG. 13.

In embodiments, the first time may comprise an earliest time at or after a current time at which satellite coverage for the serving PLMN becomes (or is expected to become) unavailable at the location of the UE, and the second time may comprise an earliest time after the first time at which satellite coverage for the serving PLMN becomes (or is expected to become) available at the location of the UE.

Entering the no coverage state following the first time at 1920 may comprise one of: entering the no coverage state at the first time; entering the no coverage state based at least in part on satellite access being lost at or after the first time; or both of these, e.g. as described for 835 in process 800.

In one embodiment, the entity may be an access and mobility management function (e.g. an AMF 122) or a mobility management entity (MME), and receiving the satellite coverage data at 1910 may comprise receiving the satellite coverage data in a non-access stratum (NAS) message via the communication satellite.

In another embodiment, the entity may comprise a gNB (e.g. a gNB 106/202/307), ng-eNB (e.g. an ng-eNB 114), or eNB, and receiving the satellite coverage data at 1910 may comprise receiving the satellite coverage data in one or more System Information Blocks (SIBs) broadcast by the entity via the communication satellite.

In one embodiment, the satellite coverage data may comprise the first time and the second time, e.g. as described for 815 in process 800.

In one embodiment, the satellite coverage data may comprise indications of satellite cell availability for a plurality of times (e.g. may comprise a time sequence) and for a current location of the UE, e.g. as described for FIGS. 7A and 7B.

In one embodiment, the location of the UE may comprise a current geodetic location of the UE, a current coverage area of a serving satellite cell for the UE, or an area of a current fixed cell for the UE, e.g. as described for 815 in process 800.

In one embodiment, the satellite coverage data may comprise indications of satellite cell availability for a plurality of locations and a plurality of times. In this embodiment, the plurality of locations may correspond to locations in an array of grid points or an array of locations, e.g. as described for FIGS. 7A and 7B. The indications of satellite cell availability for the plurality of locations for each time in the plurality of times may be encoded as an array of Boolean values, and each Boolean value in the array of Boolean values may correspond to one grid point location in the array of grid points and may indicate whether or not there is satellite cell availability at the grid point location and at each time, e.g. as described for FIGS. 7A and 7B. Each Boolean value of the Boolean values may be encoded as one bit, and a number of bits in the satellite coverage data may be reduced using a compression algorithm.

In an embodiment of the method 1900, the UE may send (e.g. prior to the first time) the first and the second times to a second entity in the serving PLMN, e.g. as described for 825 in process 800. The second entity may be an access and mobility management function (e.g. an AMF 122) or mobility management entity (MME) and the first and the second times may be sent in a non-access stratum (NAS) message.

In an embodiment, and as described for 835 in process 800 and 935 and 940 in process 900, reducing the frequency of satellite cell searching at 1930 may comprise one of: (i) deactivating support for one or more satellite radio access technologies (RATs) by an access stratum (AS) layer in the UE; (ii) deactivating support for all satellite RATs by the AS layer; (iii) deactivating support for all terrestrial RATs by the AS layer; (iv) configuring a cell search scan for one or more satellite RATs, one or more terrestrial RATs, or both, by the AS layer, where the cell search scan employs a shorter duration of cell scanning, a longer interval between successive cell scans, or both, than when the UE is not in the no coverage state; (v) periodically reactivating and later deactivating support for one or more satellite RATs, one or more terrestrial RATs, or both by the AS layer; or (iv) some combination of these.

In an embodiment, inhibiting mobile originating requests in the UE while in the no coverage state may comprise rejecting requests by applications in the UE to send text, send data, or establish calls or sessions to entities outside the UE, e.g. as described for 835 in process 800 and 945 and 950 for process 900. Inhibiting mobile originating requests in the UE while in the no coverage state may further comprise providing an indication of the no coverage state, the second time, or both to the applications, e.g. as described for 950 in process 900.

In some embodiments, a second entity in the serving PLMN may inhibit paging and may queue mobile terminating (MT) text and data for the UE based at least in part on the UE being in an Idle state following the first time, e.g. as described for 840 in process 800. The second entity may continue to inhibit paging and queue mobile terminating text and data for the UE until at least one of an occurrence of the second time or receiving an indication that the UE is no longer in the no coverage state, as described at 860 in process 800 and 1040 in process 1000. For example, the UE may send a message to the second entity after leaving the no coverage state, where the message includes the indication that the UE is no longer in the no coverage state, e.g. as described for 855 in process 800 and 1035 in process 1000. The second entity may be a mobility management entity (MME) or an access and mobility management function (e.g. an AMF 122), and the message may be a non-access stratum (NAS) Registration Request when the second entity is an AMF or a NAS Attach Request or NAS Tracking Area Update Request when the second entity is an MME. In some embodiments, the UE may leave the no coverage state at a third time (e.g. the time T3 described for process 1000) which may be prior to the second time, and the message may then be sent at or after the third time. Leaving the no coverage state at the third time may be in response to one of: determining that the location of the UE is no longer a valid approximation for a current location of the UE; accessing a cell for the serving PLMN while in the no coverage state, where the cell is a terrestrial cell or a satellite cell; or both of these, e.g. as described for 1020 and 1025 in process 1000.

In some embodiments, the no coverage state in the UE may comprise a non-access stratum (NAS) state, an access stratum (AS) state, a running of a NAS timer, or a running of an AS timer, e.g. as described for 820 and 835 in process 800. The running of the NAS timer or the running of the AS timer may start at the first time and stop at the second time, e.g. described for 820 in process 800.

In some embodiments, the UE may refrain from entering the no coverage state while the UE is in a power saving mode, e.g. as discussed for process 800 in FIG. 8. The UE may then enter the no coverage state after the UE leaves the power saving mode when the UE leaves the power saving mode after the first time and before the second time, e.g. as discussed for process 800 in FIG. 8.

In some embodiments, the UE may receive extra coverage data, where the extra coverage data indicates at least one of satellite cell availability for other PLMNs, terrestrial network (TN) cell availability, or both, e.g. as discussed following the description of FIG. 10. The UE may refrain from entering the no coverage state at the first time when the extra coverage data indicates that satellite cells are available for the other PLMNs at the first time, and may enter the no coverage state at the first time when the extra coverage data indicates that satellite cells are not available for the other PLMNs at the first time. The UE may search for or access a TN cell while in the no coverage state when the extra coverage data indicates that TN cells are available at the first time, and may refrain from searching for TN cells while in the no coverage state when the extra coverage data indicates that TN cells are not available at the first time. The satellite coverage data may include the extra coverage data in some embodiments.

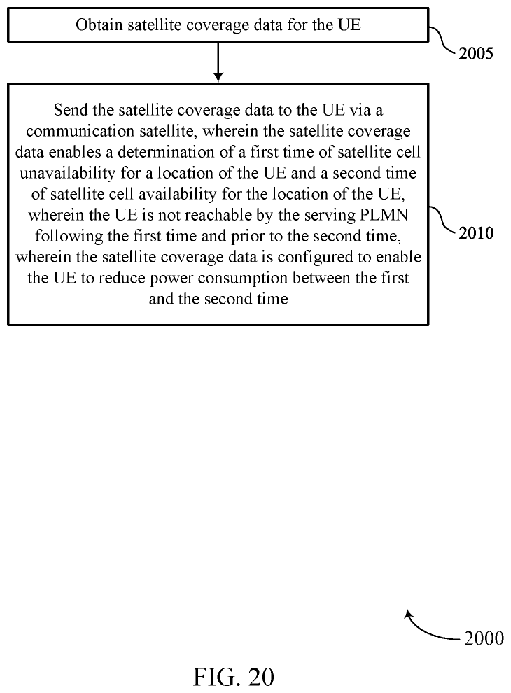

FIG. 20 shows a flowchart illustrating a method 2000 that supports satellite wireless access by a user equipment (e.g. a UE 115) to a serving public land mobile network (PLMN) (e.g. a 5GCN 110) with discontinuous satellite coverage. The method 2000 may be performed by or at an entity in the serving PLMN or its components as described herein. For example, the operations of the method 2000 may be performed by or at an entity as described with reference to FIGS. 1 through 10 and 15 through 18. In some examples, an entity may execute a set of instructions to control the functional elements of the entity to perform the described functions. Additionally, or alternatively, the entity may perform aspects of the described functions using special-purpose hardware.

At 2005, the method may include obtaining satellite coverage data for the UE, e.g. as described for FIGS. 7A and 7B. The operations of 2005 may be performed in accordance with examples as disclosed herein. In some examples, aspects of the operations of 2005 may be performed by a coverage manager 1725 as described with reference to FIG. 17.

At 2010, the method may include sending the satellite coverage data to the UE via a communication satellite (e.g. an SV 102/202/302), where the satellite coverage data enables a determination of a first time of satellite cell unavailability for a location of the UE (e.g. the time T1 described for process 800 and 1000) and a second time of satellite cell availability for the location of the UE (e.g. the time T2 described for process 800 and 1000), where the UE is not reachable by the serving PLMN following the first time and prior to the second time, and where the satellite coverage data is configured to enable the UE to reduce power consumption between the first and the second time (e.g. as described for processes 800. 900 and 1000 in FIGS. 8 to 10). The operations of 2010 may be performed in accordance with examples as disclosed herein. In some examples, aspects of the operations of 2010 may be performed by a coverage indication manager 1730 as described with reference to FIG. 17.

In some embodiments, the satellite coverage data may comprise the first time and the second time, e.g. as described for 815 and 820 in process 800.

The satellite coverage data may comprise indications of satellite cell availability for a plurality of times and for a current location of the UE, e.g. as described for FIGS. 7A and 7B.

The location of the UE may comprise a current geodetic location of the UE, a current coverage area of a serving satellite cell for the UE, or an area of a current fixed cell for the UE, e.g. as described for 815 in process 800.

The satellite coverage data may comprise indications of satellite cell availability for a plurality of locations and a plurality of times, e.g. as described for FIGS. 7A and 7B. The plurality of locations may correspond to locations in an array of grid points, where the indications of satellite cell availability for the plurality of locations for each time in the plurality of times are encoded as an array of Boolean values, e.g. as described for FIGS. 7A and 7B. Each Boolean value in the array of Boolean values may then correspond to one grid point location in the array of grid points and may indicate whether or not there is satellite cell availability at the grid point location and at each time. Each Boolean value of the Boolean values may be encoded as one bit, where a number of bits in the satellite coverage data is reduced using a compression algorithm.

In some embodiments, obtaining the satellite coverage data at 2005 may comprise one of: receiving the satellite coverage data from an Operations and Maintenance Server (e.g. as described for FIGS. 7A and 7B); or calculating the satellite coverage data based on the location of the UE (e.g. as described for 815 in process 800).

In some embodiments, the entity is an access and mobility management function (e.g. an AMF 122) or a mobility management entity (MME). Sending the satellite coverage data to the UE may then comprise sending the satellite coverage data in a non-access stratum (NAS) message via the communication satellite, e.g. as described for 815 in process 800.

In some other embodiments, the entity comprises a gNB (e.g. a gNB 106/202/307), a ng-eNB (e.g. a ng-eNB 114) or a eNB. Sending the satellite coverage data to the UE may then comprise broadcasting the satellite coverage data in one or more System Information Blocks via the communication satellite, e.g. as described for 815 in process 800.

In some embodiments, the entity may receive from the UE, and prior to the first time, an indication of the first time and the second time, e.g. as described for 825 in process 800. The entity may comprise an access and mobility management function (e.g. an AMF 122) or a mobility management entity (MME), in which case the first and the second times may be received in a NAS message.

In some embodiments, and as described for 840 in process 800, the entity may detect that the UE is in an idle state at or following the first time. The entity may then inhibit paging of the UE and may queue mobile terminating text and data for the UE. The entity may further cease to inhibit paging for the UE and cease to queue mobile terminating text and data for the UE in response to one of detecting an occurrence of the second time, receiving an indication that the UE is reachable, or both of these. The indication may be received from the UE. The entity may be an access and mobility management function (e.g. an AMF 122), in which case the indication may be received in a non-access stratum (NAS) Registration Request. The entity may instead be an MME, in which case the indication may be received in a NAS Attach Request or a NAS Tracking Area Update Request, e.g. as described for 825 in process 800. The indication may be received prior to the second time.

It should be noted that the methods described herein describe possible implementations, and that the operations and the steps may be rearranged or otherwise modified and that other implementations are possible. Further, aspects from two or more of the methods may be combined.

### Example Aspects

Aspect 1: A method for supporting satellite wireless access by a user equipment (UE) to a serving public land mobile network (PLMN) with discontinuous satellite coverage, the method performed at the UE, and the method comprising: accessing the serving PLMN via a communication satellite; obtaining satellite coverage data from an entity in the serving PLMN via the communication satellite; determining, based at least in part on the satellite coverage data, a first time of satellite unavailability for a location of the UE and a second time of satellite availability for the location of the UE; entering a no coverage state at or after the first time and at least one of inhibiting one or more mobile originating requests in the UE while in the no coverage state or reducing a frequency of satellite cell searching from a first frequency in a coverage state to a second frequency while in the no coverage state; and leaving the no coverage state at or after the second time.

Aspect 2: The method of aspect 1, wherein the first time comprises an earliest time at or after a current time for the determining at which satellite coverage for the serving PLMN becomes unavailable at the location of the UE, and the second time comprises an earliest time after the first time at which satellite coverage for the serving PLMN becomes available at the location of the UE.

Aspect 3: The method of any of aspect 1 or aspect 2, wherein entering the no coverage state following the first time comprises one of: determining, at or after the first time or before the second time, that satellite access is unavailable, or entering the no coverage state based at least in part on satellite access being unavailable.

Aspect 4: The method of any of aspects 1-3, wherein the entity is configured as an access and mobility management function (AMF) or mobility management entity (MME) configured to communicate via one or more NAS messages, and obtaining the satellite coverage data comprises receiving the satellite coverage data in a NAS message from the AMF or MME via the communication satellite.

Aspect 5: The method of any of aspects 1-3, wherein the entity is configured as a gNB, ng-eNB, or eNB, and further comprising receiving the satellite coverage data in one or more System Information Blocks broadcast by the entity via the communication satellite.

Aspect 6: The method of any of aspects 1-5, wherein the satellite coverage data comprises the first time and the second time.

Aspect 7: The method of any of aspects 1-6, wherein the satellite coverage data comprises indications of satellite cell availability for a plurality of times and for a current location of the UE.

Aspect 8: The method of any of aspects 1-7, wherein the location of the UE comprises a current geodetic location of the UE, a current coverage area of a serving satellite cell for the UE, or an area of a current fixed cell for the UE.

Aspect 9: The method of aspects 1-8, wherein the satellite coverage data comprises indications of satellite cell availability for a plurality of locations and a plurality of times.

Aspect 10: The method of aspect 9, wherein the plurality of locations correspond to locations in an array of grid points, the indications of satellite cell availability for the plurality of locations for each time in the plurality of times are encoded as an array of Boolean values, and each Boolean value in the array of Boolean values corresponds to one grid point location in the array of grid points and indicates whether or not there is satellite cell availability at the grid point location and at each time.

Aspect 11: The method of aspect 10, wherein each Boolean value of the Boolean values is encoded as one bit, and a number of bits in the satellite coverage data is reduced using a compression algorithm.

Aspect 12: The method of any of aspects 1-11, further comprising: outputting, prior to the first time, the first and the second times for transmission to a second entity in the serving PLMN.

Aspect 13: The method of aspect 12, wherein the second entity is configured as an access and mobility management function (AMF) or mobility management entity (MME) configured to communicate using one or more NAS messages, and the first and the second times are output for transmission to the AMF or MME in a non-access stratum (NAS) message.

Aspect 14: The method of any of aspects 1-13, wherein reducing the frequency of satellite cell searching comprises one of: deactivating support for one or more satellite radio access technologies (RATs) by an access stratum (AS) layer in the UE; deactivating support for all satellite RATs by the AS layer; deactivating support for all terrestrial RATs by the AS layer; configuring a cell search scan for one or more satellite RATs, one or more terrestrial RATs, or both, by the AS layer, wherein the cell search scan employs a shorter duration of cell scanning, a longer interval between successive cell scans, or both, than when the UE is not in the no coverage state; periodically reactivating and later deactivating support for one or more satellite RATs, one or more terrestrial RATs, or both by the AS layer; or any combination of these.

Aspect 15: The method of any of aspects 1-14, wherein inhibiting mobile originating requests in the UE while in the no coverage state comprises: rejecting requests by applications in the UE to send text, send data, or establish calls or sessions to entities outside the UE.

Aspect 16: The method of aspect 15, wherein inhibiting mobile originating requests in the UE while in the no coverage state further comprises: providing an indication of the no coverage state, the second time, or both to the applications.

Aspect 17: The method of any of aspects 1-16, wherein a second entity in the serving PLMN inhibits paging and queues mobile terminating text and data for the UE based at least in part on the UE being in an IDLE state following the first time, when the second entity continues to inhibit paging and queue mobile terminating text and data for the UE until at least one of an occurrence of the second time or obtaining an indication that the UE is no longer in the no coverage state.

Aspect 18: The method of aspect 17, further comprising: outputting a message for transmission to the second entity after leaving the no coverage state, wherein the message includes the indication that the UE is no longer in the no coverage state.

Aspect 19: The method of aspect 18, wherein the second entity is a mobility management entity (MME) or an access and mobility management function (AMF), where the message is a non-access stratum (NAS) Registration Request when the second entity is an AMF, wherein the message is a NAS Attach Request or a NAS Tracking Area Update Request when the second entity is an MME.

Aspect 20: The method of aspect 18, further comprising: leaving the no coverage state at a third time prior to the second time, wherein the message is sent at or after the third time.

Aspect 21: The method of aspect 20, wherein leaving the no coverage state at the third time is in response to one of: determining that the location of the UE is no longer a valid approximation for a current location of the UE; accessing a cell for the serving PLMN while in the no coverage state, wherein the cell is a terrestrial cell or a satellite cell or a terrestrial and satellite cell.

Aspect 22: The method of any of aspects 1-21, wherein the no coverage state comprises a non-access stratum (NAS) state, an access stratum (AS) state, a running of a NAS timer, or a running of an AS timer, and the running of the NAS timer or the running of the AS timer starts at the first time and stops at the second time.

Aspect 23: The method of any of aspects 1-22, further comprising: refraining from entering the no coverage state while the UE is in a power saving mode; and entering the no coverage state after the UE leaves the power saving mode, wherein the UE leaves the power saving mode after the first time and before the second time.

Aspect 24: The method of any of aspects 1-23, further comprising: obtaining extra coverage data, wherein the extra coverage data indicates at least one of satellite cell availability for other PLMNs or terrestrial network (TN) cell availability.

Aspect 25: The method of aspect 24, further comprising: refraining from entering the no coverage state at the first time when the extra coverage data indicates that satellite cells are available for the other PLMNs at the first time; and entering the no coverage state at the first time when the extra coverage data indicates that satellite cells are not available for the other PLMNs at the first time.

Aspect 26: The method of aspect 24, further comprising: searching for or accessing a TN cell while in the no coverage state when the extra coverage data indicates that TN cells are available at the first time; and refraining from searching for TN cells while in the no coverage state when the extra coverage data indicates that TN cells are not available at the first time.

Aspect 27: The method of aspect 24, wherein the satellite coverage data includes the extra coverage data.

Aspect 28: The method of any of aspects 1-27, further comprising: receiving the satellite coverage data via a transceiver.

Aspect 29: A method for supporting satellite wireless access by a user equipment (UE) to a serving public land mobile network (PLMN) with discontinuous satellite coverage, the method performed at an entity in the serving PLMN, and the method comprising: obtaining satellite coverage data for the UE; and outputting the satellite coverage data for transmission to the UE via a communication satellite, wherein the satellite coverage data enables a determination of a first time of satellite cell unavailability for a location of the UE and a second time of satellite cell availability for the location of the UE, wherein the UE is not reachable by the serving PLMN at or after the first time and prior to the second time, wherein the satellite coverage data is configured to enable the UE to reduce power consumption between the first time and the second time.

Aspect 30: The method of aspect 29, wherein the satellite coverage data comprises the first time and the second time.

Aspect 31: The method of aspect 29 or aspect 30, wherein the satellite coverage data comprises indications of satellite cell availability for a plurality of times and for a current location of the UE.

Aspect 32: The method of any of aspects 29-31, wherein the location of the UE comprises a current geodetic location of the UE, a current coverage area of a serving satellite cell for the UE, or an area of a current fixed cell for the UE.

Aspect 33: The method of any of aspects 29-32, wherein the satellite coverage data comprises indications of satellite cell availability for a plurality of locations and a plurality of times.

Aspect 34: The method of aspect 33, wherein the plurality of locations correspond to locations in an array of grid points, wherein the indications of satellite cell availability for the plurality of locations for each time in the plurality of times are encoded as an array of Boolean values, and wherein each Boolean value in the array of Boolean values corresponds to one grid point location in the array of grid points and indicates whether or not there is satellite cell availability at the grid point location and at each time.

Aspect 35: The method of aspect 34, further comprising: encoding each Boolean value of the Boolean values as one bit; and reducing a number of bits in the satellite coverage data using a compression algorithm.

Aspect 36: The method of any of aspects 29-36, wherein obtaining the satellite coverage data comprises one of: obtaining the satellite coverage data from an Operations and Maintenance Server; or calculating the satellite coverage data based on a location of the UE.

Aspect 37: The method of any of aspects 29-36, wherein the entity is configured as an access and mobility management function (AMF) or a mobility management entity (MME), and further comprising: transmitting the satellite coverage data in a non-access stratum (NAS) message via the communication satellite.

Aspect 38: The method of any of aspects 29-36, wherein the entity is configured as a gNB, ng-eNB or eNB, the method further comprising: broadcasting the satellite coverage data in one or more System Information Blocks via the communication satellite.

Aspect 39: The method of any of aspects 29-38, further comprising: obtaining from the UE, prior to the first time, an indication of the first time and the second time.

Aspect 40: The method of any of aspects 29-39, wherein the entity is configured as an access and mobility management function (AMF) or a mobility management entity (MME), and further comprising: receiving the first and the second times in a NAS message.

Aspect 41: The method of any of aspects 29-40, further comprising: detecting that the UE is in an idle state at or after the first time; inhibiting paging and queuing mobile terminating text and data for the UE; and ceasing to inhibit paging and ceasing to queue mobile terminating text and data for the UE in response to detecting an occurrence of the second time, or obtaining an indication that the UE is reachable, or both.

Aspect 42: The method of aspect 41, wherein the indication is obtained from the UE.

Aspect 43: The method of aspect 42, further comprising: receiving, when the entity is configured as an access and mobility function (AMF), the indication in a NAS Registration Request, or receiving, when the entity is configured as a mobility management entity (MME), the indication in a NAS Attach Request.

Aspect 44: The method of aspect 43, wherein the indication is received prior to the second time.

Aspect 45: The method of any of aspects 29-44, wherein the UE enters a no coverage state at or after the first time and further wherein the UE, while in the no coverage state, at least one of, inhibits one or more mobile originating requests in the UE or reduces a frequency of satellite cell searching from a first frequency in the coverage state to a second frequency while in the no coverage state.

Aspect 46: An apparatus for supporting satellite wireless access by a user equipment (UE) to a serving public land mobile network (PLMN) with discontinuous satellite coverage, comprising: a memory comprising instructions, and one or more processors configured to execute the instructions and cause the apparatus to perform a method in accordance with any of aspects 1-27.

Aspect 47: An apparatus for supporting satellite wireless access by a user equipment (UE) to a serving public land mobile network (PLMN) with discontinuous satellite coverage, comprising: a memory comprising instructions, and one or more processors configured to execute the instructions and cause the apparatus to perform a method in accordance with any of aspects 29-37 and 39-45.

Aspect 48: A user equipment (UE) comprising: at least one transceiver; a memory comprising instructions, and one or more processors configured to execute the instructions and cause the apparatus to perform a method in accordance with any of aspects 1-27, wherein the transceiver is configured to receive the satellite coverage data from the entity in the serving PLMN via the communication satellite.

Aspect 49: A network entity in a serving public land mobile network (PLMN) comprising: at least one transceiver; a memory comprising instructions, and one or more processors configured to execute the instructions and cause the apparatus to perform a method in accordance with any of aspects 29-45, wherein the transceiver is configured to transmit the satellite coverage data to the UE via the communication satellite.

Aspect 50: An apparatus for wireless communications, comprising means for performing a method in accordance with any one of Aspects 1-28.

Aspect 51: An apparatus for wireless communications, comprising means for performing a method in accordance with any one of Aspects 29-45.

Aspect 52: A non-transitory computer-readable medium comprising instructions that, when executed by an apparatus, cause the apparatus to perform a method in accordance with any one of Aspects 1-27.

Aspect 53: A non-transitory computer-readable medium comprising instructions that, when executed by an apparatus, cause the apparatus to perform a method in accordance with any one of Aspects 28-44.

### ADDITIONAL CONSIDERATIONS

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for supporting satellite wireless access by a user equipment (UE) to a serving public land mobile network (PLMN) with discontinuous satellite coverage, the method performed at the UE, and the method comprising:
accessing the serving PLMN via a communication satellite;
obtaining satellite coverage data from an entity in the serving PLMN via the communication satellite;
determining, based at least in part on the satellite coverage data, a first time of satellite unavailability for a location of the UE and a second time of satellite availability for the location of the UE;
entering a no coverage state following the first time;
inhibiting one or more mobile originating requests in the UE while in the no coverage state;
reducing a frequency of satellite cell searching from a first frequency in a coverage state to a second frequency while in the no coverage state; and
leaving the no coverage state at the second time.

2-44. (canceled)

45. An apparatus for supporting satellite wireless access by a user equipment (UE) to a serving public land mobile network (PLMN) with discontinuous satellite coverage, comprising:
a memory comprising instructions; and
one or more processors configured to execute the instructions to cause the apparatus to:
obtain signaling to access the serving PLMN via a communication satellite;
obtain satellite coverage data from an entity in the serving PLMN via the communication satellite;
determine, based at least in part on the satellite coverage data, a first time of satellite unavailability for a location of the UE and a second time of satellite availability for the location of the UE;
enter a no coverage state at or after the first time; and
at least one of:
inhibit one or more mobile originating requests in the UE while in the no coverage state or reduce a frequency of satellite cell searching from a first frequency in a coverage state to a second frequency while in the no coverage state; and
leave the no coverage state at or after the second time.

46. The apparatus of claim 45, wherein:
the first time comprises an earliest time at or after a current time for the determining at which satellite coverage for the serving PLMN becomes unavailable at the location of the UE, and
the second time comprises an earliest time after the first time at which satellite coverage for the serving PLMN becomes available at the location of the UE.

47. The apparatus of claim 45, wherein the one or more processors are further configured to cause the apparatus to:
determine, at or after the first time or before the second time, that satellite access is unavailable; and
enter the no coverage state based at least in part on satellite access being unavailable.

48. The apparatus of claim 45, wherein:
the entity is an access and mobility management function (AMF) or mobility management entity (MME) configured to communicate via one or more non-access stratum (NAS) messages, and
the one or more processors are further configured to cause the apparatus to obtain the satellite coverage data in a NAS message from the AMF or MME via the communication satellite.

49. The apparatus of claim 45, wherein:
the entity is a gNB, ng-eNB, or eNB, and
the one or more processors are further configured to cause the apparatus to obtain the satellite coverage data in one or more System Information Blocks broadcast by the entity via the communication satellite.

50. The apparatus of claim 45, wherein the satellite coverage data comprises the first time and the second time.

51. The apparatus of claim 45, wherein the satellite coverage data comprises indications of satellite cell availability for a plurality of times and for a current location of the UE.

52. The apparatus of claim 45, wherein the location of the UE comprises a current geodetic location of the UE, a current coverage area of a serving satellite cell for the UE, or an area of a current fixed cell for the UE.

53. The apparatus of claim 45, wherein the satellite coverage data comprises indications of satellite cell availability for a plurality of locations and a plurality of times.

54. The apparatus of claim 53, wherein:
the plurality of locations correspond to locations in an array of grid points,
the indications of satellite cell availability for the plurality of locations for each time in the plurality of times are encoded as an array of Boolean values, and
each Boolean value in the array of Boolean values corresponds to one grid point location in the array of grid points and indicates whether or not there is satellite cell availability at the grid point location and at each time.

55. The apparatus of claim 54, wherein:
each Boolean value of the Boolean values is encoded as one bit, and
a number of bits in the satellite coverage data is reduced using a compression algorithm.

56. The apparatus of claim 45, wherein the one or more processors are further configured to cause the apparatus to:
output, prior to the first time, the first and the second times for communication with a second entity in the serving PLMN.

57. The apparatus of claim 45, wherein:
the second entity is an access and mobility management function (AMF) or mobility management entity (MME) configured to communicate using a non-access stratum (NAS) message, and
the first and the second times are output to the AMF or MME in a NAS message.

58. The apparatus of claim 45, wherein the one or more processors are further configured to cause the apparatus to reduce the frequency of satellite cell searching by:
deactivating support for one or more satellite radio access technologies (RATs) by an access stratum (AS) layer in the UE;
deactivating support for all satellite RATs by the AS layer;
deactivating support for all terrestrial RATs by the AS layer;
configuring a cell search scan for one or more satellite RATs, one or more terrestrial RATs, or both by the AS layer, wherein the cell search scan employs a shorter duration of cell scanning, a longer interval between successive cell scans, or both than when the UE is not in the no coverage state;
periodically reactivating and later deactivating support for one or more satellite RATs, one or more terrestrial RATs, or both by the AS layer; or
any combination thereof.

59. The apparatus of claim 45, wherein the one or more processors are further configured to cause the apparatus to inhibit mobile originating requests in the UE while in the no coverage state by rejecting requests by applications in the UE to send text, send data, or establish calls or sessions to entities outside the UE.

60. The apparatus of claim 59, wherein the one or more processors are further configured to cause the apparatus to inhibit mobile originating requests in the UE while in the no coverage state by providing an indication of the no coverage state, the second time, or both to the applications.

61. The apparatus of claim 45, wherein the one or more processors are further configured to cause the apparatus to:
output a message for transmission to the second entity after leaving the no coverage state, wherein the message includes an indication that the UE is no longer in the no coverage state.

62. The apparatus of claim 61, wherein the one or more processors are further configured to cause the apparatus to:
leave the no coverage state at a third time prior to the second time, wherein the message is sent at or after the third time.

63. The apparatus of claim 62, wherein the one or more processors are further configured to leave the no coverage state at the third time in response to one of:
determining that the location of the UE is no longer a valid approximation for a current location of the UE;
accessing a cell for the serving PLMN while in the no coverage state, wherein the cell is a terrestrial cell or a satellite cell.

64. The apparatus of claim 45, wherein:
the no coverage state comprises a non-access stratum (NAS) state, an access stratum (AS) state, a running of a NAS timer, or a running of an AS timer, and
the running of the NAS timer or the running of the AS timer starts at the first time and stops at the second time.

65. The apparatus of claim 45, wherein the one or more processors are further configured to cause the apparatus to:
refrain from entering the no coverage state while the UE is in a power saving mode; and
enter the no coverage state after the UE leaves the power saving mode, wherein the UE leaves the power saving mode after the first time and before the second time.

66. The apparatus of claim 45, wherein the one or more processors are further configured to cause the apparatus to:
obtain signaling comprising extra coverage data, wherein the extra coverage data indicates at least one of satellite cell availability for other PLMNs or terrestrial network (TN) cell availability.

67. The apparatus of claim 66, wherein the one or more processors are further configured to cause the apparatus to:
refrain from entering the no coverage state at the first time when the extra coverage data indicates that satellite cells are available for the other PLMNs at the first time; and
enter the no coverage state at the first time when the extra coverage data indicates that satellite cells are not available for the other PLMNs at the first time.

68. The apparatus of claim 66, wherein the one or more processors are further configured to cause the apparatus to:
search for or access a TN cell while in the no coverage state when the extra coverage data indicates that TN cells are available at the first time; and
refrain from searching for TN cells while in the no coverage state when the extra coverage data indicates that TN cells are not available at the first time.

69. The apparatus of claim 45, wherein the apparatus is configured as the UE and further comprising a transceiver configured to receive the signaling to access the serving PLMN via a communication satellite and receive the satellite coverage data from the entity in the serving PLMN via the communication satellite.

70. An apparatus for supporting satellite wireless access by a user equipment (UE) to a serving public land mobile network (PLMN) with discontinuous satellite coverage, comprising:
a memory comprising instructions; and
one or more processors configured to execute the instructions and cause the apparatus to:
obtain satellite coverage data for the UE; and
output the satellite coverage data for transmission to the UE via a communication satellite, wherein the satellite coverage data enables a determination of a first time of satellite cell unavailability for a location of the UE and a second time of satellite cell availability for the location of the UE, wherein the UE is not reachable by the serving PLMN at or after the first time and prior to the second time, wherein the satellite coverage data is configured to enable the UE to reduce power consumption between the first time and the second time.

71. The apparatus of claim 70, wherein the satellite coverage data comprises the first time and the second time.

72. The apparatus of claim 70, wherein the satellite coverage data comprises indications of satellite cell availability for a plurality of times and for a current location of the UE.

73. The apparatus of claim 70, wherein the location of the UE comprises a current geodetic location of the UE, a current coverage area of a serving satellite cell for the UE, or an area of a current fixed cell for the UE.

74. The apparatus of claim 70, wherein the satellite coverage data comprises indications of satellite cell availability for a plurality of locations and a plurality of times.

75. The apparatus of claim 74, wherein:
the plurality of locations correspond to locations in an array of grid points,
the indications of satellite cell availability for the plurality of locations for each time in the plurality of times are encoded as an array of Boolean values, and
each Boolean value in the array of Boolean values corresponds to one grid point location in the array of grid points and indicates whether or not there is satellite cell availability at the grid point location and at each time.

76. The apparatus of claim 75, wherein the apparatus outputs the satellite coverage data by:
encoding each Boolean value of the Boolean values as one bit, and
reducing a number of bits in the satellite coverage data using a compression algorithm.

77. The apparatus of claim 70, wherein the apparatus obtains the satellite coverage data by:
obtaining the satellite coverage data from an Operations and Maintenance Server; or
calculating the satellite coverage data based on a location of the UE.

78. The apparatus of claim 70, further comprising a transceiver configured to:
transmit the satellite coverage data in a first non-access stratum (NAS) message via the communication satellite; and
receive indications of the first and the second times in a second NAS message, wherein the apparatus is configured as an access and mobility management function (AMF) or a mobility management entity (MME).

79. The apparatus of claim 70, further comprising a transceiver configured to:
broadcast the satellite coverage data in one or more System Information Blocks via the communication satellite, wherein the apparatus is configured as a gNB, ng-eNB or eNB.

80. The apparatus of claim 70, wherein the one or more processors are further configured to cause the apparatus to:
obtain signaling from the UE, prior to the first time, indicating the first time and the second time.

81. The apparatus of claim 70, wherein the one or more processors are further configured to cause the apparatus to:
detect that the UE is in an idle state at or after the first time;
inhibit paging and queuing mobile terminating text and data for the UE; and
cease to inhibit paging and ceasing to queue mobile terminating text and data for the UE in response to detecting an occurrence of the second time, or obtaining an indication that the UE is reachable, or both.

82. The apparatus of claim 81, wherein the indication is obtained via signaling from the UE.

83. The apparatus of claim 82, wherein the apparatus comprises a transceiver configured to:
obtain, when the apparatus is configured as an access and mobility function (AMF), the indication in a non-access stratum (NAS) Registration Request, or
obtain, when the apparatus is configured as a mobility management entity (MME), the indication in a NAS Attach Request.

84. The apparatus of claim 83, wherein the indication is obtained prior to the second time.

85. The apparatus of claim 70, wherein the one or more processors are further configured to cause the apparatus to:
enter a no coverage state at or after the first time and the UE, while in the no coverage state, at least one of inhibits one or more mobile originating requests in the UE or reduces a frequency of satellite cell searching from a first frequency in the coverage state to a second frequency while in the no coverage state.
